(19) United States
(12) Patent Application Publication
(10) Pub. No.: US 2019/0254426 A1
(43) Pub. Date: Aug. 22, 2019

(54) METHOD, DEVICE, STORAGE, AND SHOWCASE

(71) Applicant: PANASONIC INTELLECTUAL PROPERTY MANAGEMENT CO., LTD., Osaka (JP)

(72) Inventors: Shinichi AOKI, Osaka (JP); Yuuki NARUSE, Osaka (JP); Makoto YAMADA, Osaka (JP)

(73) Assignee: PANASONIC INTELLECTUAL PROPERTY MANAGEMENT CO., LTD., Osaka (JP)

(21) Appl. No.: 16/279,404

(22) Filed: Feb. 19, 2019

(30) Foreign Application Priority Data
Feb. 21, 2018 (JP) 2018-028420
Feb. 21, 2018 (JP) 2018-028421
Feb. 21, 2018 (JP) 2018-028422

(51) Int. Cl. A47B 71/00; H05B 33/08; A47F 3/00; A47F 11/10

(52) U.S. Cl. CPC A47B 71/00; A47F 11/10; A47F 3/001; H05B 33/0857

(57) ABSTRACT

A freshness keeping method is provided. The freshness keeping method irradiates, with irradiation light, crops after harvesting. The irradiation light includes a first peak wavelength within a wavelength range from 400 nm to 480 nm inclusive, a second peak wavelength within a wavelength range from 500 nm to 650 nm inclusive, and a third peak wavelength within a wavelength range from 700 nm to 750 nm inclusive. An intensity of the irradiation light at the third peak wavelength is 5% or more of an intensity of the irradiation light at the first peak wavelength.

### BACKGROUND

### 1. Technical Field

The present disclosure relates to a freshness keeping method, a freshness keeping device, a storage compartment, and a showcase for keeping freshness of vegetables, fruits and the like by irradiating light.

### 2. Description of the Related Art

Conventionally, there has been known a method for keeping freshness of crops by irradiating the crops such as vegetables and fruits after harvesting with red light or the like. For example, PTL 1 discloses a freshness keeping method where red light and far-infrared light are simultaneously or alternately emitted to strawberries or the like.

### CITATION LIST

### Patent Literature

PTL 1: Unexamined Japanese Patent Publication No. 2016-26484

### SUMMARY

However, in the freshness keeping method described in PTL 1, the case where white light exists is not studied. Accordingly, it is indefinite whether or not the substantially same freshness keeping effect can be obtained under the presence of white light.

Further, as in the case of the freshness keeping method described in PTL 1, in the case where only red light and far-infrared light are emitted, irradiated crops appear tinted with red color and hence, visibility of the crops is lowered. Accordingly, there is a concern that working efficiency of a worker who works on such crops is lowered. Further, in the case where such lights are incorporated in a showcase for perishable foods in a supermarket or the like, the perishable foods do not appear with natural hues and hence, there is a concern that purchase intent of a user in a supermarket or the like is lowered. The preset disclosure has been made in view of such drawbacks. It is an object of the present invention to provide a freshness keeping method, a freshness keeping device, a storage compartment, and a showcase which can properly keep freshness of crops after harvesting and can enhance visibility of crops.

To overcome the above-mentioned drawbacks, a freshness keeping method according to the present disclosure is a method, comprising: irradiating, with irradiation light, a crop after harvesting, wherein the irradiation light includes a first peak wavelength within a wavelength range from 400 nm to 480 nm inclusive, a second peak wavelength within a wavelength range from 500 nm to 650 nm inclusive, and a third peak wavelength within a wavelength range from 700 nm to 750 nm inclusive, and an intensity of the irradiation light at the third peak wavelength is 5% or more of an intensity of the irradiation light at the first peak wavelength.

With the use of the freshness keeping method, the freshness keeping device, the storage compartment, and the showcase according to the present disclosure, freshness of crops after harvesting can be properly kept, and visibility of crops can be enhanced.

### BRIEF DESCRIPTION OF THE DRAWINGS

FIG. 1 is a schematic perspective view of an external appearance of a storage compartment according to first, third, and fifth exemplary embodiments;

FIG. 2 is a block diagram showing one example of a functional constitution of a freshness keeping device which the storage compartment according to the first, third, and fifth exemplary embodiments includes;

FIG. 3 is a schematic perspective view of an external appearance of a showcase according to second, fourth, and sixth exemplary embodiments;

FIG. 4 is a schematic cross-sectional view of the showcase according to the second, fourth, and sixth exemplary embodiment in a side view;

FIG. 5 is a block diagram showing one example of a functional constitution of a freshness keeping device which the showcase according to the second, fourth, and sixth exemplary embodiments includes;

FIG. 6 is a schematic perspective view showing a configuration of one example of a light emitting module according to the second, fourth, and sixth exemplary embodiments; and

FIG. 7 is a flowchart showing one example of an operation of the freshness keeping device which the storage compartment according to the fifth exemplary embodiment includes.

### DETAILED DESCRIPTION

Hereinafter, the description is made in detail with respect to a freshness keeping method, a freshness keeping device, a storage compartment, and a showcase according to exemplary embodiments with reference to drawings. The exemplary embodiments described below illustrate examples of the present disclosure only. Numeric values, raw materials, shapes, constituent elements, operations and the like are also examples only, and are not intended to limit the present disclosure.

The drawings are schematically illustrated and thus are not strictly accurate. In the drawings, substantially identical configurations are denoted by identical reference numerals, and overlapped descriptions may be omitted or simplified.

### First Exemplary Embodiment

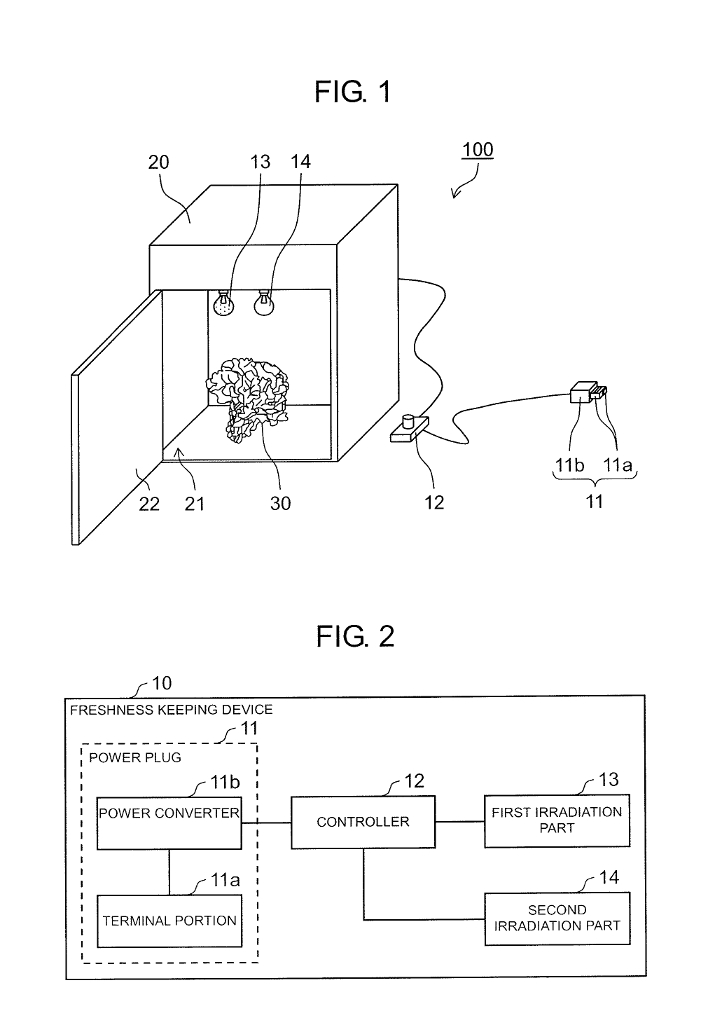

Hereinafter, the description is made with respect to freshness keeping device 10 and storage compartment 100 according to a first exemplary embodiment with reference to FIG. 1 and FIG. 2. FIG. 1 is a schematic perspective view of an external appearance of storage compartment 100 according to the first exemplary embodiment. FIG. 2 is a block diagram showing one example of a functional constitution of freshness keeping device 10 which storage compartment 100 according to the first exemplary embodiment includes.

### [Configuration]

Storage compartment 100 shown in FIG. 1 is a storage compartment for storing (preserving) crops 30 after being accommodated and, for example, is installed on a backyard of a store which sells crops 30. Storage compartment 100 includes casing 20, door 22, and freshness keeping device 10 (FIG. 2).

Casing 20 is an approximately rectangular parallelepiped outer shape, and crops 30 are put into and taken out from storage part 21 (storing space) having a rectangular parallelepiped shape which forms an internal space of casing 20 from a front side. Casing 20 is made of metal such as aluminum, but may be made of a resin. A shape of casing 20, a material of casing 20 and the like are merely examples, and are not particularly limited.

Openable door 22 (cover) is disposed on a front side of storage part 21. When door 22 is closed and first light emitter 13 and second light emitter 14 are turned off, the inside of storage part 21 becomes a darkroom (an environment of 0 lux).

Freshness keeping device 10 is a device for keeping freshness of harvested crops 30. As shown in FIG. 1 and FIG. 2, freshness keeping device 10 includes power plug 11, controller 12, first light emitter 13, and second light emitter 14.

Power plug 11 is one example of a power receiving portion, and includes terminal portion 11a, and power converter 11b. Power plug 11 is a so-called AC adapter.

Terminal portion 11a is a metal-made terminal inserted into an electric outlet. A shape, a material, and the like of terminal portion 11a are not particularly limited.

Power converter 11b converts AC power which terminal portion 11a receives into DC power, and supplies DC power to controller 12, first light emitter 13, and second light emitter 14. Specifically, power converter 11b is an AC-DC converter circuit. In storage compartment 100, although power converter 11b is disposed outside casing 20, power converter 11b may be incorporated in casing 20.

First light emitter 13 is an irradiation device which is disposed above storage part 21, and irradiates crops 30 stored in storage part 21 with far-infrared light based on control by controller 12. Here, the far-infrared light is light having a wavelength peak (third peak wavelength) within a wavelength range from 700 nm to 750 nm inclusive. As the far-infrared light, light may be used where the light has a wavelength peak within a wavelength range from 700 nm to 750 nm inclusive, and an emission spectrum of the light falls within a range from 400 nm to 1000 nm inclusive as a whole, for example.

Specifically, first light emitter 13 is a light emitting module which includes a printed circuit board, and a plurality of far-infrared light emitting diodes (LEDs) mounted on the printed circuit board. However, first light emitter 13 may have any configuration provided that first light emitter 13 can emit far-infrared light. For example, a configuration may be adopted where only far-infrared light is emitted by using a light emitting element which emits light having a light emitting peak other than far-infrared light and a spectral filter in combination.

In FIG. 1, although a bulb-type first light emitter 13 is shown, such bulb-type first light emitter 13 is merely shown schematically, and a shape of first light emitter 13 is not limited to such a bulb-type light emitter. For example, first light emitter 13 may be configured to make surface emission using a light guide plate or the like. Alternatively, first light emitter 13 may have a shape of a pendant light or a shape of a down light.

Here, it is preferable that first light emitter 13 uniformly irradiate crops 30 with far-infrared light. Since it is considerable that the far-infrared light mainly influences keeping of freshness, by uniformly irradiating crop 30 with far-infrared light, it is possible to keep freshness of crop 30 efficiently. Examples of a method of uniformly irradiating crop 30 with far-infrared light include a method which uses a surface emission using a light guide plate, a milky white plate or the like, a method where light sources of first light emitter 13 are arranged in a matrix array, and the like. As the milky white plate, a plate, or the like, obtained by combining a reflection sheet, an acrylic plate, and a diffusion plate can be used.

Here, a far-infrared light which first light emitter 13 emits (emission spectrum of far-infrared light) typically has one peak. However, the far-infrared light may have two or more peaks which differ from each other in wavelength. For example, in the first exemplary embodiment, first light emitter 13 emits far-infrared light having a peak wavelength of 720 nm, far-infrared light having a peak wavelength of 735 nm, or the like. However, first light emitter 13 may be configured to emit far-infrared light having peaks on both a wavelength 720 nm and a wavelength 735 nm. In this case, for example, first light emitter 13 can be configured such that an LED which emits far-infrared light having a peak wavelength of 720 nm and an LED which emits far-infrared light having a peak wavelength of 735 nm are mounted on a printed circuit board.

Second light emitter 14 is disposed above storage part 21, and irradiates crop 30 stored in storage part 21 with mixed color light based on control by controller 12. Here, the mixed color light means light having a wavelength peak (first peak wavelength) within a wavelength range from 400 nm to 480 nm inclusive and having a wavelength peak (second peak wavelength) within a wavelength range from 500 nm to 650 nm inclusive. As the mixed color light, light may be used where the light has wavelength peaks within a wavelength range from 400 nm to 480 nm inclusive and within a wavelength range from 500 nm to 650 nm inclusive, and an emission spectrum of the light falls within a range from 380 nm to 800 nm inclusive as a whole, for example.

Second light emitter 14 is a light emitting module having the chip-on-board (COB) structure constituted of a printed circuit board, a plurality of blue LEDs directly mounted on the printed circuit board, and a sealing member containing yellow phosphor particles. The sealing member seals the blue LEDs. As the yellow phosphor particles, for example, an yttrium-aluminum-garnet (YAG)-based phosphor can be used. Second light emitter 14 may be a surface-mount-device (SMD) type light emitting module or may be a remote-phosphor-type light emitting module.

Second light emitter 14 may have any configuration provided that second light emitter 14 emits light having a wavelength peak within a wavelength range from 400 nm to 480 nm inclusive and a wavelength peak within a wavelength range from 500 nm to 650 nm inclusive. For example, second light emitter 14 may be configured by combining a light emitting element which emits blue light such as a blue LED and a light emitting element such as a green LED which emits green light or a yellow LED which emits yellow light together. Alternatively, second light emitter 14 may be configured to emit light having a wavelength peak within a wavelength range from 400 nm to 480 nm inclusive and a wavelength peak within a wavelength range from 500 nm to 650 nm inclusive by combining a white light source and a spectral filter together.

In FIG. 1, although bulb-type second light emitter 14 is shown, such bulb-type second light emitter 14 is merely shown schematically, and a shape of second light emitter 14 is not limited to such a bulb-type light emitter. For example, second light emitter 14 may be configured to make surface emission using a light guide plate or the like. Alternatively, second light emitter 14 may have a shape of a pendant light or a shape of a down light.

Further, second light emitter 14 is not limited to a light emitter which has one wavelength peak within a wavelength range from 400 nm to 480 nm inclusive and one wavelength peak within a wavelength range of 500 nm to 650 nm inclusive. For example, second light emitter 14 may be configured to have three or more wavelength peaks in total within a wavelength range from 400 nm to 480 nm inclusive and a wavelength range from 500 nm to 650 nm inclusive by combining a light emitting element which emits blue light, green phosphor particles, and yellow phosphor particles together.

Here, first light emitter 13 and second light emitter 14 may be configured as one light emitter. For example, when such a light emitter is configured by the COB structure, the light emitter can be configured such that a far-infrared light LED and a blue LED mounted on a printed circuit board are sealed by a sealing member containing yellow phosphor particles and green phosphor particles. Alternatively, the light emitter may be configured by combining a far-infrared light LED, a blue LED, and a yellow LED or a green LED together.

Further, it is more preferable that mixed color light which second light emitter 14 emits have a second peak wavelength within a wavelength range from 500 nm to 550 nm inclusive and have a wavelength peak (fourth peak wavelength) within a wavelength range more than or equal to 600 nm and less than 700 nm. Due to the above-mentioned configuration, the color rendering of irradiation light obtained by mixing light emitted from first light emitter 13 and light emitted from second light emitter 14 is enhanced thus enhancing visibility of crops 30.

When second light emitter 14 is configured by the COB structure, light emitter 14 can be configured such that a blue LED and a red LED mounted on a printed circuit board are sealed by a sealing member containing green phosphor particles. Alternatively, second light emitter 14 may be configured to emit light having a wavelength peak within a wavelength range from 400 nm to 480 nm inclusive, a wavelength peak within a wavelength range from 500 nm to 550 nm inclusive, and a wavelength peak with a wavelength range from more than or equal to 600 nm to less than 700 nm respectively by combining a white light source and a spectral filter together.

Also in this case, first light emitter 13 and second light emitter 14 may be configured as one light emitter. When such a light emitter is configured by the COB structure, the light emitter can be configured such that a far-infrared light LED, a blue LED and a red LED mounted on a printed circuit board are sealed by a sealing member containing green phosphor particles, for example.

Alternatively, the above-mentioned light emitter may be configured by combining a far-infrared light LED, a blue LED, a red LED, and a green LED together.

Here, mounting positions of first light emitter 13 and second light emitter 14 are not limited to positions above storage part 21. For example, a configuration may be adopted where first light emitter 13 and second light emitter 14 are mounted on a side surface or a bottom surface of storage part 21. Further, first light emitter 13 may be mounted on a ceiling surface of storage part 21, and second light emitter 14 may be mounted on a side surface of storage part 21. Alternatively, first light emitter 13 and second light emitter 14 may be mounted at different positions such that first light emitter 13 is mounted on a side surface of storage part 21, and second light emitter 14 is mounted on a ceiling surface of storage part 21.

Controller 12 is one example of the control part, and is a controller which controls first light emitter 13 and second light emitter 14 based on an operation by a user. Controller 12 controls intensity of the far-infrared light which first light emitter 13 emits, and an irradiation time of the far-infrared light which first light emitter 13 emits. Controller 12 controls turning on and off of irradiation of light from first light emitter 13 and turning on and off of irradiation of light from second light emitter 14. Controller 12 may be configured to control intensity of mixed color light which second light emitter 14 emits.

Specifically, controller 12 is constituted of a pulse width modulation (PWM) control circuit for controlling illuminance of first light emitter 13 (light control circuit), a timer circuit which controls an irradiation time of first light emitter 13, and the like. Controller 12 may be constituted with a processor, a microcomputer, or the like. In storage compartment 100, although controller 12 is disposed outside casing 20, controller 12 may be partially or entirely incorporated in casing 20.

Although it is not always necessary for freshness keeping device 10 to include controller 12, it is preferable that freshness keeping device 10 include controller 12. Further, a controller for controlling intensity of far-infrared light and a controller for controlling an irradiation time of the far-infrared light may be provided separately. Controller 12 may be integrally formed with first light emitter 13 and second light emitter 14. A specific configuration of controller 12 is not particularly limited, and a conventionally known controller may be used as controller 12, for example.

Storage compartment 100 may include a cooling device for cooling the inside of storage part 21. As a matter of course, the cooling device is not essential.

In a case where storage compartment 100 includes large storage part 21, storage compartment 100 may include a belt conveyor for moving crops 30. In this case, due to the movement of the belt conveyor, crops 30 which move to an area below first light emitter 13 are sequentially irradiated by far-infrared light.

### [Operation of Freshness Keeping Device]

Next, an operation of freshness keeping device 10 (freshness keeping method) is described.

Freshness keeping device 10 irradiates harvested crop 30 with irradiation light based on the control of controller 12. Here, irradiation light is light having a first peak wavelength within a wavelength range from 400 nm to 480 nm inclusive, a second peak wavelength within a wavelength range from 500 nm to 650 nm inclusive, and a third peak wavelength within a wavelength range from 700 nm to 750 nm inclusive. In the irradiation light, intensity of the third peak wavelength is more than or equal to 5% of intensity of the first peak wavelength.

In the first exemplary embodiment, the irradiation light is light obtained by mixing far-infrared light emitted from first light emitter 13 and mixed light emitted from second light emitter 14. Irradiation light emitted from freshness keeping device 10 is white light.

As described above, irradiation light may be light having a second peak wavelength within a wavelength range from 500 nm to 550 nm inclusive and having a fourth peak wavelength within a wavelength range more than or equal to 600 nm and less than 700 nm. With such a configuration, color rendering of irradiation light is enhanced, and visibility of crops 30 irradiated by the irradiation light is enhanced.

It is preferable that freshness keeping device 10 can control intensity and an irradiation time of light having a third wavelength peak separately from intensity and an irradiation time of light having another wavelength peak. Favorable reason is that proper freshness keeping can be achieved corresponding to usage and a mounting place of freshness keeping device 10 by separately controlling far-infrared light which mainly contributes to freshness keeping of crops 30 and mixed light necessary for enhancing visibility of crops 30 although contribution to freshness keeping of crops 30 is small.

Here, when a color temperature of the irradiation light referred to as daylight is high color temperature of 5600 K or more and 7000 K or less, from a viewpoint of freshness keeping of crops 30, it is preferable that intensity of a third peak wavelength of irradiation light be more than or equal to 5% of intensity of a first peak wavelength.

On the other hand, when a color temperature of irradiation light referred to as daylight is a color temperature more than or equal to 4000 K and less than 5600 K, from a viewpoint of freshness keeping of crops 30, it is preferable that intensity of a third peak wavelength of irradiation light be more than or equal to 8% of intensity of a first peak wavelength.

When a color temperature of irradiation light referred to as warm white light or electric bulb color light is a low color temperature more than or equal to 2000 K and less than 4000 K, from a viewpoint of freshness keeping of crops 30, it is preferable that intensity of a third peak wavelength of irradiation light be more than or equal to 10% of intensity of a first peak wavelength.

It is preferable that freshness keeping device 10 emit light having a third peak wavelength for five minutes or more in a day. By emitting far-infrared light for five minutes or more in a day, it is possible to enhance freshness keeping effect as described later.

From a viewpoint of freshness keeping of crops 30, it is preferable that freshness keeping device 10 emit light having a third peak wavelength plural times repeatedly and, further, it is more preferable that an irradiation interval time of light having a third peak wavelength be longer than an irradiation time of light having a third peak wavelength.

Further, from a viewpoint of freshness keeping of crops 30, it is preferable to set a light integrated amount of irradiation light within a range from 700 nm to 750 nm inclusive to 30 J/m² or more in a day. The above-mentioned irradiation condition is described in detail in items in examples.

It is preferable that far-infrared light which is light having a third peak wavelength be emitted to a portion of crops 30 having a large number of pores. The portion having the large number of pores is a leaf part and the like of vegetables for example, and particularly, a back side of a leaf and the like. It is estimated that the irradiation of far-infrared light moves in a direction that pores are closed so that evaporation of moisture from the inside of crop 30 is suppressed. Accordingly, by irradiating the portion of crops 30 having the large number of pores with the far-infrared light as described above, it is possible to keep freshness of crops 30 efficiently.

### [Effects and Other Benefits]

Here, essential points of freshness keeping device 10 and storage compartment 100 according to the first exemplary embodiment are described again. Further, the present disclosure also has an aspect of a freshness keeping method and hence, the freshness keeping method according to the exemplary embodiment is also described hereinafter.

The freshness keeping method according to the exemplary embodiment is a freshness keeping method for irradiating harvested crops with irradiation light. The irradiation light has a first peak wavelength within a wavelength range from 400 nm to 480 nm inclusive, a second peak wavelength within a wavelength range from 500 nm to 650 nm inclusive, and a third peak wavelength within a wavelength range from 700 nm to 750 nm inclusive. Intensity of the irradiation light at the third peak wavelength is more than or equal to 5% of intensity of the irradiation light at the first peak wavelength.

By using the freshness keeping method having the above-mentioned configuration, it is possible to keep freshness of harvested crops 30 properly, and visibility of crops 30 can be enhanced.

Further, in the freshness keeping method according to the exemplary embodiment, it is preferable that a second peak wavelength exist within a wavelength range from 500 nm to 550 nm inclusive, and further, irradiation light have a fourth peak wavelength within a wavelength range more than or equal to 600 nm and less than 700 nm.

Due to the above-mentioned configuration, color rendering of irradiation light can be enhanced, and hence, visibility of crops 30 irradiated by the irradiation light can be enhanced.

Further, in the freshness keeping method according to the exemplary embodiment, it is preferable that a color temperature of irradiation light be 5600 K or more and 7000 K or less. Alternatively, in the freshness keeping method according to the exemplary embodiment, it is also preferable that a color temperature of irradiation light be 4000 K or more and less than 5600 K, and intensity of the irradiation light at the third peak wavelength be set to be more than or equal to 8% of intensity of the irradiation light at the first peak wavelength. Alternatively, in the freshness keeping method according to the exemplary embodiment, it is also preferable that a color temperature of the irradiation light be 2000 K or more and less than 4000 K, and intensity of the irradiation light at the third peak wavelength be set to be more than or equal to 10% of intensity of the irradiation light at the first peak wavelength.

Due to the above-mentioned configuration, it is possible to keep freshness of harvested crops 30 properly, and at the same time, visibility of crops 30 can be particularly enhanced.

Further, in the freshness keeping method according to the exemplary embodiment, it is preferable that with respect to the irradiation light, light having a third peak wavelength be emitted for five minutes or more in a day.

Due to the above-mentioned configuration, visibility of crops 30 can be particularly enhanced, and at the same time, it is possible to keep freshness of harvested crops 30 more efficiently.

Further, in the freshness keeping method according to the exemplary embodiment, it is preferable that with respect to the irradiation light, light having a third peak wavelength be emitted plural times repeatedly.

Due to the above-mentioned configuration, visibility of crops 30 can be particularly enhanced, and at the same time, it is possible to keep freshness of harvested crops 30 more efficiently.

Further, in the freshness keeping method according to the exemplary embodiment, it is preferable that, with respect to the irradiation light, an irradiation interval time of light having a third peak wavelength be longer than an irradiation time of the light having the third peak wavelength.

Due to the above-mentioned configuration, visibility of crops 30 can be particularly enhanced, and at the same time, it is possible to keep freshness of harvested crops 30 more efficiently.

Further, in the freshness keeping method according to the exemplary embodiment, it is preferable to set a light integrated amount of the irradiation light within a range from 700 nm to 750 nm inclusive to 30 J/m² or more in a day.

Due to the above-mentioned configuration, visibility of crops 30 can be particularly enhanced, and at the same time, it is possible to keep freshness of harvested crops 30 more efficiently.

Freshness keeping device 10 according to the first exemplary embodiment is a freshness keeping device for irradiating a harvested crop with irradiation light. Further, freshness keeping device 10 includes a light emitter which emits irradiation light having a first peak wavelength within a wavelength range from 400 nm to 480 nm inclusive, a second peak wavelength within a wavelength range from 500 nm to 650 nm inclusive, and a third peak wavelength within a wavelength range from 700 nm to 750 nm inclusive. Intensity of the irradiation light at the third peak wavelength is more than or equal to 5% of intensity of the irradiation light at the first peak wavelength.

By using freshness keeping device 10 having the above-mentioned configuration, it is possible to keep freshness of harvested crops 30 properly, and visibility of crops 30 can be enhanced.

Further, in freshness keeping device 10 according to the first exemplary embodiment, it is preferable that a second peak wavelength exist within a wavelength range from 500 nm to 550 nm inclusive, and further, irradiation light have a fourth peak wavelength within a wavelength range more than or equal to 600 nm and less than 700 nm.

Due to the above-mentioned configuration, color rendering of irradiation light can be enhanced, and hence, visibility of crops 30 irradiated by the irradiation light can be enhanced.

Storage compartment 100 according to the first exemplary embodiment includes freshness keeping device 10, and casing 20 which accommodates crops 30.

By using storage compartment 100 having the above-mentioned configuration, it is possible to keep freshness of crops 30 properly while accommodating harvested crop 30, and visibility of crops 30 can be enhanced.

### Second Exemplary Embodiment

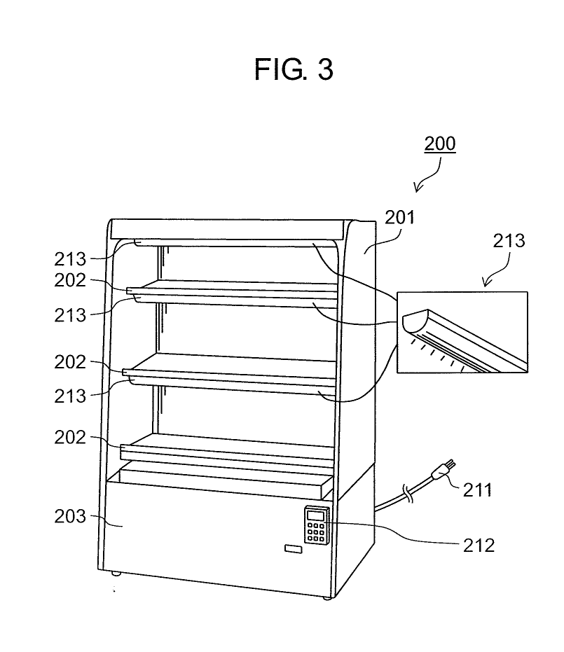

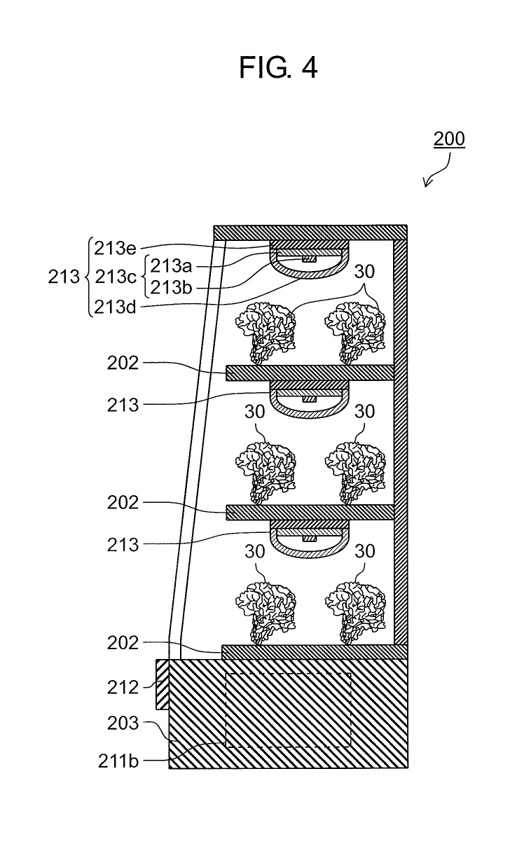

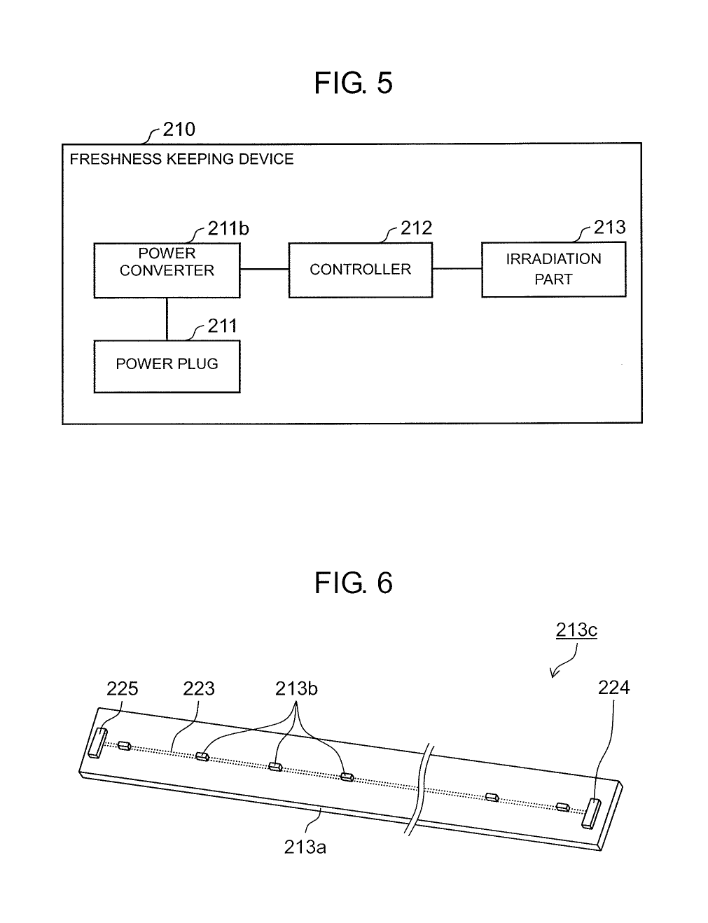

Hereinafter, with reference to FIGS. 3 to 6, showcase 200 according to a second exemplary embodiment of the present disclosure is described. FIG. 3 is a schematic perspective view of an external appearance of showcase 200 according to the second exemplary embodiment. FIG. 4 is a schematic cross-sectional view of showcase 200 according to the second exemplary embodiment in a side view. FIG. 5 is a block diagram showing one example of a functional constitution of freshness keeping device 210 which showcase 200 according to the second exemplary embodiment includes. FIG. 6 is a schematic perspective view showing a configuration of one example of a light emitting module.

In the description made hereinafter, the description of a portion overlapping with the description of the first exemplary embodiment is omitted or simplified. Further, constitutional elements substantially equal to the corresponding constitutional elements of the first exemplary embodiment are described by giving the same symbols.

### [Configuration]

Showcase 200 is a showcase having a plurality of shelves 202 on which harvested crops 30 are displayed (placed), and for example, is installed in a salesroom of a store which sells crops 30. Showcase 200 includes body portion 201, shelves 202, base portion 203, and freshness keeping device 210.

Body portion 201 forms a space for accommodating crops 30. Body portion 201 is formed of side plates, a ceiling plate, a back plate, and frames for holding the side plates, the ceiling plate, and the back plate, and a front side of body portion 201 is opened. Specifically, body portion 201 is made of metal such as aluminum or iron, or a resin.

Shelves 202 are plate-like members for partitioning a space defined by body portion 201 in a vertical direction, and harvested crops 30 are displayed on upper surfaces of shelves 202. Body portion 201 may include three shelves 202, or may include not more than two or not less than four shelves 202. Specifically, shelves 202 are made of metal such as aluminum or iron, however, shelves 202 may be made of a resin.

Base portion 203 is a portion forming a base of showcase 200, and controller 212 which freshness keeping device 210 described later includes is mounted on base portion 203. Power converter 211b which freshness keeping device 210 includes is accommodated in the inside of base portion 203.

Freshness keeping device 210 includes power plug 211, power converter 211b, controller 212, and light emitter 213.

Power plug 211 as one example of a power receiving portion has a metal-made terminal which is inserted into an electric outlet, and receives AC power from the terminal.

Power converter 211b converts AC power which power plug 211 receives into DC power, and supplies DC power to controller 212 and light emitter 213. Specifically, power converter 211b is an AC-DC converter circuit. In showcase 200, power converter 211b is incorporated in base portion 203.

Controller 212 is one example of the control part, and controls light emitter 213 based on an operation by a user. Controller 212 is constituted with, for example, a timer circuit which controls intensity of far-infrared light which light emitter 213 emits, and an irradiation time of far-infrared light which light emitter 213 emits. Controller 212 may be constituted with a processor, a microcomputer, or the like.

Controller 212 controls, for example, turning on and off of irradiation of the far-infrared light from light emitter 213 and turning on and off of irradiation of mixed light from light emitter 213. Controller 212 may be configured to control intensity of the mixed light which light emitter 213 emits.

Light emitter 213 is disposed above each of shelves 202, and irradiates crops 30 displayed on shelves 202 with irradiation light based on control by controller 212. As shown in FIG. 4, light emitter 213 includes base 213e, light emitting module 213c which is a printed circuit board 213a on which LEDs 213b are mounted, and diffusion cover 213d.

Base 213e is a mounting base and a heat sink for light emitting module 213c, and also functions as a member for mounting light emitter 213 on shelves 202. Base 213e is made of metal such as aluminum die-cast, for example.

Diffusion cover 213d diffuses irradiation light emitted from light emitting module 213c and allows the irradiation light to pass therethrough, and irradiates crops 30 with the irradiation light.

Light emitting module 213c is printed circuit board 213a on which LEDs 213b are mounted. Hereinafter, the structure of light emitting module 213c is described in detail with reference to FIG. 6.

As shown in FIG. 6, to be more specific, light emitting module 213c includes printed circuit board 213a, a plurality of LEDs 213b which are mounted on printed circuit board 213a in a row, wiring 223, connector 224, and connector 225.

Printed circuit board 213a is a printed circuit board having an elongated rectangular shape. Printed circuit board 213a is a CEM-3 (Composite Epoxy Material-3) printed circuit board using a resin as a base material. However, printed circuit board 213a may be another resin-made printed circuit board, and may be a metal-base printed circuit board or a ceramic printed circuit board. As the other resin-made printed circuit board, an FR-4 (Flame Retardant-4) printed circuit board can be exemplified. As the ceramic printed circuit board, an alumina printed circuit board made of aluminum oxide (alumina), an aluminum nitride printed circuit board made of aluminum nitride, and the like can be exemplified. As the metal base printed circuit board, an aluminum alloy printed circuit board, an iron alloy printed circuit board, a copper alloy printed circuit board, and the like can be exemplified.

LED 213b is one example of a light emitting element, and is a bare chip which emits mono-color visible light. As LED 213b, LEDs such as a far-infrared light LED, a blue LED, a yellow LED, and a green LED are used. LEDs 213b are each mounted on printed circuit board 213a by die bonding using a die attach material (die bonding material), for example.

Light emitter 213 may be configured to include a far-infrared light LED for emitting far-infrared light as LED 213b, and a blue LED, a green LED, and a red LED for emitting mixed light as LEDs 213b, for example. Alternatively, light emitter 213 may be configured to include a far-infrared light LED for emitting far-infrared light as LED 213b, and further include a blue LED as LED 213b thus emitting mixed light by combining the blue LED and yellow phosphor particles together.

It is preferable that these LEDs 213b including the far-infrared light LED, the blue LED, the yellow LED, and the green LED be disposed on printed circuit board 213a such that LEDs 213b of the same kind are not disposed adjacent to each other. With such a configuration, deviation in color depending on an irradiation place of irradiation light can be reduced thus acquiring uniform irradiation light.

Wiring 223 is a metal wiring made of tungsten (W), copper (Cu), or the like. Wiring 223 is formed into a predetermined shape by patterning such that the plurality of LEDs 213b are electrically connected to each other, and at the same time, LEDs 213b, connector 224, and connector 225 are electrically connected to each other.

In FIG. 6, wiring 223 connects LEDs 213b arranged in a row in series. However, the configuration of wiring 223 is not limited to such a configuration. For example, wiring 223 may be configured such that LED element arrays each of which includes a predetermined number of LEDs 213b aligned in row are connected in parallel.

Further, with respect to wiring 223, it is preferable that the LED element arrays formed by connecting LEDs 213b of the same kind out of the far-infrared light LEDs, the blue LEDs, the yellow LEDs, and the green LEDs in series are provided, and the LED element arrays be connected in parallel.

With such a configuration, light emitting intensity of LEDs 213b of the respective kinds can be individually controlled, and from viewpoints of freshness keeping and visibility of crops 30, light emitted from LEDs 213b can be adjusted to be proper irradiation light.

Alternatively, wiring 223 may be configured to connect the far-infrared light LEDs which mainly contribute to freshness keeping of crops 30 and other kinds of LEDs in parallel. With such a configuration, intensity and an irradiation time of far-infrared light which mainly contributes to freshness keeping of crops 30 can be adjusted so that it is possible to keep freshness of crops 30 more properly.

Connector 224 and connector 225 are connectors for supplying power to light emitting module 213c. DC power is supplied to connector 224 or connector 225 from controller 212. Due to the supply of DC power, light emitting module 213c emits light.

### [Effects and Other Benefits]

Here, essential points of showcase 200 according to the second exemplary embodiment are described again.

Showcase 200 according to the second exemplary embodiment includes freshness keeping device 210, and shelves 202 on which crops 30 are displayed.

By using showcase 200 having the above-mentioned configuration, it is possible to keep freshness of crops 30 properly in a state where harvested crops 30 are displayed on shelves 202, and visibility of crops 30 can be enhanced.

### Supplemental Description of Exemplary Embodiment

First, the crops are supplementarily described. In the above-mentioned exemplary embodiment, “crops” means all crops capable of being harvested by an agricultural technique. Although crops are not particularly limited, crops include vegetables, fruits, and flowers and ornamental plants in the usually-performed classification corresponding to usage part (referred to as horticultural classification or artificial classification), for example.

Vegetables include fruits vegetables, leaves and stems, root vegetables, mushrooms, and the like.

Here, fruit vegetables include: grains such as corn; and beans such as azuki bean, common bean, pea, green soybean, cowpea, winged bean, broad bean, soybean, sword bean, peanut, lentil, and sesame, besides eggplant, pepino, tomato, mini tomato, tamarillo, gamblea innovans, hot pepper, sweet green pepper, Habanero chilli, green pepper, bell pepper, colored bell pepper, pumpkin, zucchini, cucumber, horned melon, melon cucumber, bitter melon, winter melon, chayote, luffa, bottle gourd, okra, garden strawberry, water melon, melon, and Korean melon.

Further, leaves and stems include: leaf vegetables such as ice plant, angelica keiskei, mustard greens, cabbage, watercress, kale, Japanese mustard spinach, salad lettuce, red leaf lettuce, Asiasari radix, Sang-chu lettuce, non-heading Chinese cabbage “santosai”, perilla, crown daisy, water shield, water shield, water dropwort, celery, tatsoi, Japanese radish leaf, leaf mustard, lettuce, Green bok choy, Brassica campestris, rape blossoms, Nozawana, heading Chinese cabbage, parsley, spinach mustard, Swiss chard, spinach, Lamium amplexicaule, leaf green “mizuna”, greater chickweed, common chickweed, giant chickweed, leaf green “mibuna”, Japanese hornwort, Brussels sprouts, Nalta jute, green leaf lettuce, rocket salad, lettuce, wasabi greens; stem vegetables such as Welsh onion, green onion, chive, Chinese chive, asparagus, Japanese spikenard, kohlrabi, zha cai, bamboo shoot, garlic, water convolvulus, green onion “wakegi”, onion; flower vegetables such as globe artichoke, broccoli, cauliflower, chrysanthemum, Brassica flower, butterbur scape, Japanese ginger; and sprout vegetables such as sprout, bean sprout, and radish sprout.

Further, root vegetables include potatoes such as sweet potato, taro, potato, Chinese yam, Japanese yam, in addition to turnip, Japanese radish, Western little radish, wasabi, horseradish, edible burdock, Chinese artichoke, ginger, carrot, Japanese scallion, and lotus root.

Further, mushrooms include: winter mushroom, king oyster mushroom, Jew's ear, Dictyophora indusiata, “shiitake” mushroom, “shimeji” mushroom, white jelly fungus, golden oyster mushroom, Lactarius volemus, Pholiota microspora, Armillaria mellea, Lyophyllum decastes, oyster mushroom, beech mushroom, bunapi, porcini, Lyophyllum shimeji, Tricholoma flavovirens, Grifola frondosa, Agaricus campestris, Tricholoma matsutake, bearded tooth mushroom, Rhizopogon, truffle, and the like.

Further, fruits include: various kinds of citrus fruits including orange, apple, peach, sand pear, European pear, banana, grape, cherry, oleaster, blueberry, raspberry, black berry, mulberry, loquat, fig, Japanese persimmon, akebi, mango, avocado, jujube, pomgranate, passion fruit, pineapple, papaya, apricot, Prunus mume, plum, kiwifruit, Chinese quince, myrica, chestnut, miracle fruit, guava, star fruit, acerola, and the like.

Further, as flowers, for example, hollyhock, bouvardia, godetia, evening primrose, garden stock, Brassica oleracea, lunaria, acidanthera, iris, gladiolus, California poppy, peperomia, calceolaria, snapdragon, torenia, primrose, cyclamen, Lampranthus spectabilis, anthurium, calla lily, caladium, calamus, symgonium, peace lily, dieffenbachia, philodendron, cactuses, Ajuga, false dragonhead, scarlet sage, begonia, curcuma, water lily, portulaca, violet, Queen Anne's lace, Setcreasea, boatlily, spiderwort, Impatiens balsamina, Solanum mammosum, petunia, Japanese lantern plant, carnation, pink, China pink, gypsophila, Gypsophila paniculata, catchfly, Guzmania, bird of paradise flower, moss pink, phlox, garden phlox, Filipendula purpurea, Amacrinum, amaryllis, chrysanthemum, marguerite, Kaffir lily, Ifafa lily, narcissus, snowflake, Zephyranthes candida, nerine, crinum, Amazon lily, licorice, agave, cockscomb, globe amaranth, morning glory, Evolvulus, cleome, geranium, kalanchoe, pincushion flower, sweet pea, lupine, Lurigio, forget-me-not, astilbe, saxifrage, agapanthus, Solomon's seal, aloe, star-of-Bethlehem, Japanese rhodea, Chlorophytum comosum, plantain lily, Fritillaria camtschatcensis, gloriosa, colchicum, sansevieria, Sandersonia, Ophiopogon japonicus, tulip, society garlic, lily of the valley, dracaena, triteleia, Polygonatum falcatum, New Zealand flax, fritillary, hyacinth, Japanese toad lily, Hemerocallis fulva ‘kwanso’, liriope, lily, alstroemeria, Ruscus, Large-flowered Cypripedium, Calanthe, oncidium, cattleya, Colmanara, urn orchid, cymbidium, coelogyne, dendrobium, Doritaenopsis, Phalaenopsis japonica, Paphiopedilum, vanda, birusutekera, Phalaenopsis, braunau, miltonia, Exacum, Texas bluebell, Japanese gentian, lantana, rose, cherry tree, African daisy, and the like can be named, and further, Japanese cleyera, cycad, fern, dracaena, aspidistra, Monstera, pothos, Compacta, Polyscias, anthurium crassinervium, Stemona japonica, Indian basket grass, Pittosporum, and the like for appreciating leaves are included.

Although some crops are exemplified heretofore, the freshness keeping method according to the above-mentioned exemplary embodiments is also applicable to crops other than the exemplified crops.

Next, the description is made supplementarily with respect to freshness keeping. In the above-mentioned exemplary embodiments, “freshness keeping” means to keep freshness of crops as long as possible. Freshness keeping effect necessary for a crop differs depending on a kind, a merchandise value, and the like of the crop.

For example, with respect to vegetables (leaf vegetables) where a leaf part or a stem part is mainly utilized such as lettuce and spinach, prevention of wilting (suppression of lowering of a moisture retention rate), prevention of discoloration (yellowing, browning, and the like), prevention of softening, prevention of generation of mold, and the like are important. Further, with respect to vegetables (fruit vegetables) where a pulp is mainly utilized such as strawberries and tomatoes or fruit trees such as apples, prevention of discoloration (yellowing, browning, and the like), prevention of softening, prevention of generation of mold, and the like are important. Further, with respect to flowers and ornamental plants, prevention of wilting (suppression of lowering of a moisture retention rate), prevention of discoloration (yellowing, browning, and the like), prevention of generation of mold, and the like are important.

Next, a situation where the freshness keeping method of the above-mentioned exemplary embodiments is utilized is described supplementarily. In the above-mentioned exemplary embodiments, in a case where crops on a backyard of a store is preserved or in a case where crops are displayed in a salesroom of the store, the freshness keeping method is utilized. However, the freshness keeping method may be utilized in other cases.

Harvested crops are transported to the city by a refrigerator truck through a farm, an agricultural cooperative, a dedicated facility where precooling of crops is performed, for example. Further, harvested crops are bought by the supplier in the market, are then preserved in the backyard of the supermarket and the like, and are displayed in the salesroom.

In the above-mentioned path, the freshness keeping method can be utilized in the dedicated facility, the refrigerator truck, the backyard and the saleroom of the supermarket and the like, and other places.

Further, harvested crops are transported to a second home delivery business office by a deliver car through the farm and a first home delivery business office, for example. Thereafter, there may be a case where harvested crops are transported to the purchaser (personal house) by a delivery car.

In the above-mentioned path, the freshness keeping method can be utilized in the first home delivery business office, the delivery car, the refrigerator truck, the second home delivery business office, and the like.

Further, for example, the freshness keeping method of the above-mentioned exemplary embodiments may be utilized for crops before harvested other than in harvested crops.

Further, far-infrared light passes through a general material (for example, polyethylene and the like) which is used as a storage container of crops. Accordingly, the freshness keeping method of the above-mentioned exemplary embodiments can be used for both crops in a usual boxed state and crops in a packed state.

Further, there exists a possibility that the far-infrared light passes through the crops, and hence the freshness keeping method of the above-mentioned exemplary embodiments can be utilized for crops overlapped on other crops.

The freshness keeping method of the above-mentioned exemplary embodiments may be utilized in a dark environment (darkness environment) or may be utilized under an environment which is artificially irradiated by white LEDs and the like. The freshness keeping method of the above-mentioned exemplary embodiments may be utilized under a sunlight environment.

Further, crops after being irradiated by the far-infrared light may be preserved under a completely dark environment (darkness environment), may be preserved under an environment which is artificially irradiated by white LEDs and the like, and may be preserved under a sunlight environment.

### Other Exemplary Embodiments

The freshness keeping method, the freshness keeping device, the storage compartment, and the showcase according to the present disclosure have been described with reference to the first and second exemplary embodiments heretofore. However, the present disclosure is not limited to the freshness keeping method, the freshness keeping device, the storage compartment, and the showcase according to the first and second exemplary embodiments.

For example, in the first and second exemplary embodiments, the description is made with respect to a case where the LEDs are used as the light source. However, the light emitting element is not limited only to the LED. Examples of the light source include a fluorescent tube, a metal hydride lamp, a sodium lamp, a halogen lamp, a xenon lamp, a neon tube, an inorganic electroluminescence, an organic electroluminescence, a chemiluminescence (chemical light emitting), and a laser.

In a case where, as the light source, a light source which can emit light also in a wavelength range other than the necessary wavelength range such as a fluorescent tube is used, the light source can be utilized as light having only the necessary wavelength range by combining the light source with a spectrum filter and the like.

An emission mode of the far-infrared light is not particularly limited. For example, the far-infrared light may be emitted instantaneously with an extremely large light amount such as stroboscopic light emission. Alternatively, the far-infrared light may be emitted for a long period at a low light amount. Alternatively, the far-infrared light may be emitted continuously or may be emitted intermittently.

Further, the freshness keeping device, the storage compartment, and the showcase according to the present disclosure may include an illuminance sensor. By using the illuminance sensor, the freshness keeping device, the storage compartment, and the showcase according to the present disclosure can adjust irradiation illuminance of the far-infrared light and the mixed light corresponding to the surrounding environment and the like.

In the above-mentioned exemplary embodiments, all of or a part of the respective constitutional elements (for example, controller) may be constituted with dedicated hardware, or may be implemented by executing a software program suitable for the respective constitutional elements. The respective constitutional elements may be implemented such that a program executing part such as a central processing unit (CPU) or a processor reads out a software program stored in a storage medium such as a hard disc or a semiconductor memory and executes the software program.

The exemplary embodiments described above are given simply for the purpose of illustration of the exemplary embodiments of the present disclosure, and numeric values, raw materials, shapes, constituent elements, operations, and the like are also given only for illustrating preferable modes. Therefore, the present disclosure is not limited only to these exemplary embodiments. Further, out of the constitutional elements in the above-mentioned exemplary embodiments, the constitutional elements which are not described in independent claims describing an uppermost concept are described as arbitrary constitutional elements. The configuration may be modified as appropriate without departing from a range of a technical thought of the present disclosure.

### EXAMPLES

Hereinafter, the present exemplary embodiment is described in more detail with reference to examples and comparison examples.

In the description made hereinafter, “a number of peaks is three” means that irradiation light has one peak within a wavelength range from 400 nm to 480 nm inclusive, one peak within a wavelength range from 500 nm to 650 nm inclusive, and one peak within a wavelength range from 700 nm to 750 nm inclusive. In the respective Tables shown hereinafter, when there is no description of numerical values to the far-infrared light wavelength, “the number of peaks is three” means that the far-infrared light has one peak within a wavelength range from 400 nm to 480 nm inclusive, and one peak within a wavelength range from 500 nm to 650 nm inclusive.

Further, “the number of peaks is four” means that the irradiation light has one peak within a wavelength range from 400 nm to 480 nm inclusive, one peak within a wavelength range from 500 nm to 550 nm inclusive, one peak within a wavelength range not less than 600 nm and less than 700 nm, and one peak within a wavelength range from 700 nm to 750 nm inclusive. In the respective Tables shown hereinafter, when there is no description of numerical values to the far-infrared light wavelength, “the number of peaks is four” means that the far-infrared light has one peak within a wavelength range from 400 nm to 480 nm inclusive, one peak within a wavelength range from 500 nm to 550 nm inclusive, and one peak within a wavelength range not less than 600 nm and less than 700 nm.

Further, “peak ratio” means a value of (P2/P1)×100 when peak intensity within a wavelength range from 400 nm to 480 nm inclusive is assumed as P1, and peak intensity within a wavelength range from 700 nm to 750 nm inclusive is assumed as P2.

Further, “irradiation time” means a time during which light having a peak wavelength within a wavelength range from 700 nm to 750 nm inclusive is irradiated to the crops in one time irradiation.

Further, “a number of times of irradiation” means the number of times that a light having a peak wavelength within a wavelength range from 700 nm to 750 nm inclusive is irradiated to the crops.

Further, “interval time” means a time from finishing of emission of light having a peak wavelength within a wavelength range from 700 nm to 750 nm inclusive to next emission of light having a peak wavelength within a wavelength range from 700 nm to 750 nm inclusive.

Further, “light integrated amount” means an integrated amount of a light within a wavelength range from 700 nm to 750 nm inclusive per day, and the unit of light integrated amount is J/m².

Further, “color temperature” means a color temperature of irradiation light irradiated to crops in the test.

In the respective Tables shown hereinafter, “freshness keeping” means a numerical value indicating how many times a time at which a moisture amount of a crop becomes 95% or less of an initial moisture amount of the crop is longer than the time in a case where there is no irradiation of light within a wavelength range from 700 nm to 750 nm inclusive to the crop under respective conditions. Here, a moisture amount of a crop is calculated while assuming a change amount of the crop from an initial value of a weight of the crop as a weight of moisture evaporated from the crop.

The following results are results showing an average of similar tests using five samples.

### (Test 1)

In a thermostatic bath, a freshness keeping test was performed in a state where a bundle of spinach which is a vegetable belonging to leaves and stems is put into a test box having a cubic shape where a length of one side is 300 mm. In all of the examples and comparison examples, the spinach is irradiated with light such that the light becomes 2000 lx to 2500 lx. Further, the spinach is irradiated with light once per day. The test is performed under a condition where a temperature in the inside of the thermostatic bath is set to 5° C. or 20° C., and humidity in the thermostatic bath is set to 80% to 90%. Tests were performed under the above-mentioned conditions while assuming parameters of the color temperature, the number of peaks, the peak ratio, the irradiation time, and the temperature as numerical values of examples 1 to 12 and comparison examples 1 to 8 shown in Table 1.

TABLE 1

| | | FAR- | | | | |
|---|---|---|---|---|---|---|
| | | INFRARED | | | | |
| | COLOR | LIGHT | NUMBER | PEAK | | |
| | TEMPERATURE | WAVELENGTH | OF | RATIO | IRRADIATION | TEMPERATURE |
| | (K) | (nm) | PEAKS | (%) | TIME (min) | (degree) |
| EXAMPLE 1 | 6500 | 735 | 3 | 80 | 60 | 5 |
| EXAMPLE 2 | 6500 | 735 | 3 | 20 | 60 | 5 |
| EXAMPLE 3 | 6500 | 735 | 4 | 80 | 60 | 5 |
| EXAMPLE 4 | 6500 | 735 | 3 | 5 | 60 | 5 |
| EXAMPLE 5 | 5000 | 735 | 3 | 50 | 60 | 5 |
| EXAMPLE 6 | 5000 | 735 | 3 | 20 | 60 | 5 |
| EXAMPLE 7 | 5000 | 735 | 3 | 50 | 5 | 5 |
| EXAMPLE 8 | 5000 | 735 | 3 | 8 | 60 | 5 |
| EXAMPLE 9 | 3500 | 735 | 3 | 40 | 60 | 5 |
| EXAMPLE 10 | 3500 | 735 | 3 | 15 | 60 | 5 |
| EXAMPLE 11 | 3500 | 735 | 3 | 10 | 60 | 5 |
| EXAMPLE 12 | 5000 | 735 | 3 | 50 | 60 | 20 |
| COMPARISON | 6500 | — | 3 | — | — | 5 |
| EXAMPLE 1 | 6500 | 735 | 3 | 4 | 60 | 5 |
| COMPARISON | | | | | | |
| EXAMPLE 2 | 6500 | — | 4 | — | — | 5 |
| COMPARISON | | | | | | |
| EXAMPLE 3 | 5000 | — | 3 | — | — | 5 |
| COMPARISON | | | | | | |
| EXAMPLE 4 | 5000 | 735 | 3 | 4 | 60 | 5 |
| COMPARISON | | | | | | |
| EXAMPLE 5 | 5000 | 735 | 3 | 50 | 4 | 5 |
| COMPARISON | | | | | | |
| EXAMPLE 6 | | | | | | |
| COMPARISON | 3500 | — | 3 | — | — | 5 |
| EXAMPLE 7 | | | | | | |
| COMPARISON | 3500 | 735 | 3 | 4 | 60 | 5 |
| EXAMPLE 8 | | | | | | |

### [About Influence of Peak Ratio]

In the examples and the comparison examples under a condition where a color temperature is set to 6500 K, results in freshness keeping of examples 1, 2 and 4 which differ from each other only in a numerical value of the peak ratio, and a result in freshness keeping of comparison example 2 are shown in Table 2. Here, comparison example 1 is a test where there is no irradiation of light within a wavelength range from 700 nm to 750 nm inclusive, and respective numerical values in freshness keeping in Table 2 indicate how many times a time at which a moisture amount of a crop becomes 95% or less of an initial moisture amount of the crop is longer than the time in comparison example 1.

TABLE 2

| | PEAK RATIO | FRESHNESS |
|---|---|---|
| | (%) | KEEPING |
| EXAMPLE 1 | 80 | 1.3 |
| EXAMPLE 2 | 20 | 1.18 |
| EXAMPLE 4 | 5 | 1.12 |
| COMPARISON | 4 | 1.03 |
| EXAMPLE 2 | | |

As shown in Table 2, in examples 1, 2 and 4 where the peak ratio is 5% or more, a value of freshness keeping is 1.1 times or more as large as a value in comparison example 2. On the other hand, in comparison example 2 where the peak ratio is less than 5%, a value of freshness keeping is 1.03, and freshness of a crop can be kept only substantially equal to the freshness keeping in comparison example 1 with no peak of far-infrared light. Accordingly, in a case where a color temperature is 6500 K, it is preferable that peak intensity within a wavelength range from 700 nm to 750 nm inclusive be 5% or more of peak intensity within a wavelength range from 400 nm to 480 nm inclusive.

As in the case of example 1, when a peak ratio is 80%, a value of freshness keeping takes a high numerical value, that is, 1.3. Accordingly, the freshness keeping method may be performed while setting an upper limit of the peak ratio to 80%. That is, in a case where a color temperature is 6500 K, the freshness keeping method may be performed by controlling peak intensity within a wavelength range from 700 nm to 750 nm inclusive such that the peak intensity becomes 5% or more and 80% or less of peak intensity within a wavelength range from 400 nm to 480 nm inclusive. As a matter of course, the freshness keeping method can be also performed under a condition where the peak ratio is 80% or more.

In the examples and the comparison examples under a condition where a color temperature is set to 5000 K, results in freshness keeping of examples 5, 6 and 8 which differ from each other only in a numerical value of the peak ratio, and a result in freshness keeping of comparison example 5 are shown in Table 3. Here, comparison example 4 is a test where there is no irradiation of light within a wavelength range from 700 nm to 750 nm inclusive, and respective numerical values in freshness keeping in Table 3 indicate how many times a time at which a moisture amount of a crop becomes 95% or less of an initial moisture amount of the crop is longer than the time in comparison example 4.

TABLE 3

| | PEAK RATIO | FRESHNESS |
|---|---|---|
| | (%) | KEEPING |
| EXAMPLE 5 | 50 | 1.3 |
| EXAMPLE 6 | 20 | 1.2 |
| EXAMPLE 8 | 8 | 1.14 |
| COMPARISON | 4 | 1.03 |
| EXAMPLE 5 | | |

As shown in Table 3, in examples 5, 6 and 8 where the peak ratio is 8% or more, a value of freshness keeping is 1.1 times or more as large as a value in comparison example 5. On the other hand, in comparison example 5 where the peak ratio is less than 8%, a value of freshness keeping is 1.03, and freshness of a crop can be kept only substantially equal to the freshness keeping in comparison example 5 with no peak of far-infrared light. Accordingly, in a case where a color temperature is 5000 K, it is preferable that peak intensity within a wavelength range from 700 nm to 750 nm inclusive be 8% or more of peak intensity within a wavelength range from 400 nm to 480 nm inclusive.

As in the case of example 5 where a peak ratio is 50%, a value of freshness keeping takes a high numerical value, that is, 1.3. Accordingly, the freshness keeping method may be performed while setting an upper limit of the peak ratio to 50%. That is, in a case where a color temperature is 5000 K, the freshness keeping method may be performed by controlling peak intensity within a wavelength range from 700 nm to 750 nm inclusive such that the peak intensity becomes 8% or more and 50% or less of peak intensity within a wavelength range from 400 nm to 480 nm inclusive. As a matter of course, the freshness keeping method can be also performed under a condition where the peak ratio is 50% or more.

In the examples and the comparison examples under a condition where a color temperature is set to 3500 K, results in freshness keeping of examples 9, 10 and 11 which differ from each other only in a numerical value of the peak ratio, and a result in freshness keeping of comparison example 8 are shown in Table 4. Here, comparison example 7 is a test where there is no irradiation of light within a wavelength range from 700 nm to 750 nm inclusive, and respective numerical values in freshness keeping in Table 4 indicate how many times a time at which a moisture amount of a crop becomes 95% or less of an initial moisture amount of the crop is longer than the time in comparison example 7.

TABLE 4

| | PEAK RATIO | FRESHNESS |
|---|---|---|
| | (%) | KEEPING |
| EXAMPLE 9 | 40 | 1.3 |
| EXAMPLE 10 | 15 | 1.25 |
| EXAMPLE 11 | 10 | 1.11 |
| COMPARISON | 4 | 1.04 |
| EXAMPLE 8 | | |

As shown in Table 4, in examples 9, 10 and 11 where the peak ratio is 10% or more, a value of freshness keeping is 1.1 times as large as a value in comparison example 8. On the other hand, in comparison example 8 where the peak ratio is less than 10%, a value of freshness keeping is 1.04, and freshness of a crop can be kept only substantially equal to the freshness keeping in comparison example 7 with no peak of a far-infrared light. Accordingly, in a case where a color temperature is 3500 K, it is preferable that peak intensity within a wavelength range from 700 nm to 750 nm inclusive be 10% or more of a peak intensity within a wavelength range from 400 nm to 480 nm inclusive.

As in the case of example 9 where a peak ratio is 40%, a value of freshness keeping takes a high numerical value, that is, 1.3. Accordingly, the freshness keeping method may be performed while setting an upper limit of the peak ratio to 40%. That is, in a case where a color temperature is 3500 K, the freshness keeping method may be performed by controlling peak intensity within a wavelength range from 700 nm to 750 nm inclusive such that the peak intensity becomes 10% or more and 40% or less of peak intensity within a wavelength range from 400 nm to 480 nm inclusive. As a matter of course, the freshness keeping method can be also performed under a condition where the peak ratio is 40% or more.

### [About Influence of Irradiation Time]

Results of examples 5 and 7 which differ from each other only in a numerical value of an irradiation time, and a result of comparison example 6 are shown in Table 5. Here, comparison example 4 is a test where there is no irradiation of light within a wavelength range from 700 nm to 750 nm inclusive, and respective numerical values in freshness keeping in Table 5 indicate how many times a time at which a moisture amount of a crop becomes 95% or less of an initial moisture amount of the crop is longer than the time in comparison example 4.

TABLE 5

| | IRRADIATION TIME | FRESHNESS |
|---|---|---|
| | (min) | KEEPING |
| EXAMPLE 5 | 60 | 1.3 |
| EXAMPLE 7 | 5 | 1.2 |
| COMPARISON | 4 | 1.03 |
| EXAMPLE 6 | | |

As shown in Table 5, in examples 5 and 7 where an irradiation time is five minutes or more, a value of freshness keeping is 1.2 times or more as large as a value in comparison example 4. On the other hand, in comparison example 6 where the irradiation time is less than five minutes, a value of freshness keeping is 1.03, and freshness of a crop can be kept only substantially equal to the freshness keeping in comparison example 4 with no peak of a far-infrared light. Accordingly, it is preferable that a crop be irradiated with light within a wavelength range from 700 nm to 750 nm inclusive for five minutes or more in a day.

### [About Influence of Temperature]

Results of examples 5 and 12 which differ from each other only in a numerical value of a temperature are shown in Table 6. Here, comparison example 4 is a test where there is no irradiation of light within a wavelength range from 700 nm to 750 nm inclusive, and respective numerical values in freshness keeping in Table 6 indicate how many times a time at which a moisture amount of a crop becomes 95% or less of an initial moisture amount of the crop is longer than the time in comparison example 4. Further, a temperature means a temperature of the thermostatic bath.

TABLE 6

| | TEMPERATURE | FRESHNESS |
|---|---|---|
| | (degree) | KEEPING |
| EXAMPLE 5 | 5 | 1.3 |
| EXAMPLE 12 | 20 | 1.28 |

As shown in Table 6, in example 5 where a temperature is 5° C. and example 12 where a temperature is 20° C., values of freshness keeping take 1.3 and 1.28 respectively, and freshness of a crop can be kept in substantially the same level. Accordingly, the freshness keeping method according to the present disclosure can be utilized in both of a place having a cooling facility (5° C.) and an ordinary temperature place (20° C.).

### [About Influence of the Number of Peaks]

Results of examples 1 and 3 which differ from each other only in a numerical value of the number of peaks are shown in Table 7. Here, comparison example 1 is a test where there is no irradiation of light within a wavelength range from 700 nm to 750 nm inclusive, and a numerical value in freshness keeping of example 1 in Table 7 indicates how many times a time at which a moisture amount of a crop becomes 95% or less of an initial moisture amount of the crop is longer than the time in comparison example 1. Here, comparison example 3 is a test where there is no irradiation of light within a wavelength range from 700 nm to 750 nm inclusive, and a numerical value in freshness keeping of example 3 in Table 7 indicates how many times a time at which a moisture amount of a crop becomes 95% or less of an initial moisture amount of the crop is longer than the time in comparison example 3.

TABLE 7

| | NUMBER OF | FRESHNESS |
|---|---|---|
| | PEAKS | KEEPING |
| EXAMPLE 1 | 3 | 1.3 |
| EXAMPLE 3 | 4 | 1.33 |

As shown in Table 7, in example 1 where the number of peaks is three and example 3 where the number of peaks is four, values of freshness keeping take 1.3 and 1.33 respectively, and freshness of a crop can be kept in substantially the same level. On the other hand, example 3 where the number of peaks within a red range is larger than that of example 1 is excellent in a viewpoint of visibility of a crop compared to example 1 since a reddish portion of the crop can be visually recognized clearly compared to example 1.

### (Test 2)

In a thermostatic bath, a freshness keeping test was performed in a state where a bundle of spinach which is a vegetable belonging to leaves and stems is put into a test box having a cubic shape where a length of one side is 300 mm. In all of the examples and comparison examples, the spinach is irradiated with light such that the light becomes 2000 lx to 2500 lx. Further, the spinach is irradiated light to set to once per day. The test was performed under a condition where a temperature in the inside of the thermostatic bath is set to 5° C., and humidity in the thermostatic bath is set to 80% to 90%. Under a condition that a numerical value of the number of peaks is three, a peak ratio is 8%, a far-infrared light wavelength is 735 nm, and a color temperature is 6500 K, tests were performed under respective conditions using numerical values of examples 13 and 14 and comparison example 9 shown in Table 8 as parameters of a light integrated amount.

Further, as comparison example 10, a test was performed also under a condition where there is no irradiation of light within a wavelength range from 700 nm to 750 nm inclusive. Table 8 shows also results of freshness keeping under the respective conditions. Here, comparison example 10 is a test where there is no irradiation of light within a wavelength range from 700 nm to 750 nm inclusive, and respective numerical values in freshness keeping in Table 8 indicate how many times a time at which a moisture amount of a crop becomes 95% or less of an initial moisture amount of the crop is longer than the time in comparison example 10.

TABLE 8

| | LIGHT | |
|---|---|---|
| | INTEGRATED AMOUNT | FRESHNESS |
| | (J/m²) | KEEPING |
| EXAMPLE 13 | 180 | 1.28 |
| EXAMPLE 14 | 30 | 1.14 |
| COMPARISON | 18 | 1.01 |
| EXAMPLE 9 | | |
| COMPARISON | — | 1 |
| EXAMPLE 10 | | |

### [About Influence of Light Integrated Amount]

As shown in Table 8, in examples 13 and 14 where a light integrated amount is 30 J/m² or more, a value of freshness keeping is 1.1 times or more as large as a value in comparison example 10. On the other hand, in comparison example 9 where an integrated light amount is less than 30 J/m², a value of freshness keeping is 1.01, and freshness of a crop can be kept only substantially equal to the freshness keeping in comparison example 10 with no peak of far-infrared light. Accordingly, it is preferable that a light integrated amount in a day be 30 J/m² or more.

### (Test 3)

In a thermostatic bath, a freshness keeping test was performed in a state where a bundle of spinach which is a vegetable belonging to leaves and stems is put into a test box having a cubic shape where a length of one side is 300 mm. In all of the examples and comparison examples, the spinach is irradiated with light such that the light becomes 2000 lx to 2500 lx. The test was performed under a condition where a temperature in the inside of the thermostatic bath is set to 5° C., and humidity in the thermostatic bath is set to 80% to 90%. Under a condition that the number of peaks is four, a peak ratio is 120%, a far-infrared light wavelength is 735 nm, an irradiation time is 60 minutes, a color temperature is 3500 K, and an interval time is 180 minutes, tests were performed using numerical values of example 15 and comparison example 11 shown in Table 9 as the number of times of irradiation.

Further, as comparison example 12, a test was performed also under a condition where there is no irradiation of light within a wavelength range from 700 nm to 750 nm inclusive. Table 9 shows also results of freshness keeping under the respective conditions. Here, comparison example 12 is a test where there is no irradiation of light within a wavelength range from 700 nm to 750 nm inclusive, and respective numerical values in freshness keeping in Table 9 indicate how many times a time at which a moisture amount of a crop becomes 95% or less of an initial moisture amount of the crop is longer than the time in comparison example 12.

TABLE 9

| | NUMBER OF | |
|---|---|---|
| | TIMES OF | FRESHNESS |
| | IRRADIATION | KEEPING |
| EXAMPLE 15 | 4 | 1.42 |
| COMPARISON | 1 | 1.06 |
| EXAMPLE 11 | | |
| COMPARISON | — | 1 |
| EXAMPLE 12 | | |

### [About Influence of the Number of Times of Irradiation]

As shown in Table 9, freshness keeping in example 15 where the number of times of irradiation is four takes a value of 1.42, and hence the value of freshness keeping of the example 15 is larger than a value of freshness keeping of comparison example 11 where the number of times of irradiation is one, that is, 1.06. That is, it is preferable that a crop be irradiated with light within a wavelength range from 700 nm to 750 nm inclusive plural times.

### (Test 4)

In a thermostatic bath, a freshness keeping test was performed in a state where a bundle of spinach which is a vegetable belonging to leaves and stems is put into a test box having a cubic shape where a length of one side is 300 mm. In all of the examples and comparison examples, the spinach is irradiated with light such that the light becomes 2000 lx to 2500 lx. The test was performed under a condition where a temperature in the inside of the thermostatic bath is set to 5° C., and humidity in the thermostatic bath is set to 80% to 90%. Under a condition that the number of peaks is three, a peak ratio is 120%, a far-infrared light wavelength is 735 nm, an irradiation time is 60 minutes, and a color temperature is 3500 K, tests were performed using numerical values of examples 16, 17 and 18 and comparison example 13 shown in Table 10 as the interval time.

Further, as comparison example 14, a test was performed also under a condition where there is no irradiation of light within a wavelength range from 700 nm to 750 nm inclusive. Table 10 shows also results of freshness keeping under the respective conditions. Here, comparison example 14 is a test where there is no irradiation of light within a wavelength range from 700 nm to 750 nm inclusive, and respective numerical values in freshness keeping in Table 10 indicate how many times a time at which a moisture amount of a crop becomes 95% or less of an initial moisture amount of the crop is longer than the time in comparison example 14.

TABLE 10

| | INTERVAL TIME | FRESHNESS |
|---|---|---|
| | (min) | KEEPING |
| EXAMPLE 16 | 66 | 1.09 |
| EXAMPLE 17 | 240 | 1.25 |
| EXAMPLE 18 | 480 | 1.48 |
| COMPARISON | 30 | 1.02 |
| EXAMPLE 13 | | |
| COMPARISON | — | 1 |
| EXAMPLE 14 | | |

### [About Influence of Interval Time]

As shown in Table 10, in examples 16, 17 and 18 where an interval time is longer than an irradiation time (60 minutes), a value of freshness keeping is approximately 1.1 or more. On the other hand, in comparison example 13 where an interval time is shorter than an irradiation time, a value of freshness keeping is 1.02, and freshness of a crop can be kept only substantially equal to the freshness keeping in comparison example 14 with no peak of far-infrared light. Accordingly, it is preferable that an interval time be longer than an irradiation time.

### (Test 5)

In a thermostatic bath, a freshness keeping test was performed in a state where a bundle of spinach which is a vegetable belonging to leaves and stems is put into a test box having a cubic shape where a length of one side is 300 mm. In all of the examples and comparison examples, the spinach is irradiated with light such that the light becomes 2000 lx to 2500 lx. The test was performed under a condition where a temperature in the inside of the thermostatic bath is set to 5° C., and humidity in the thermostatic bath is set to 80% to 90%. Under a condition that the number of peaks is three, a color temperature is 5000 K, and irradiation of far-infrared light is once per day, respective tests were performed using numerical values of examples 19, 20 and 21 shown in Table 11.

Table 11 shows also results of freshness keeping under the respective conditions. Further, comparison example 4 is a test where there is no irradiation of light within a wavelength range from 700 nm to 750 nm inclusive, and respective numerical values in freshness keeping in Table 11 indicate how many times a time at which a moisture amount of a crop becomes 95% or less of an initial moisture amount of the crop is longer than the time in comparison example 4.

TABLE 11

| | | FAR- | | |
|---|---|---|---|---|
| | | INFRARED | IRRADI- | |
| | | LIGHT | ATION | FRESH- |
| | PEAK | WAVELENGTH | TIME | NESS |
| | RATIO | (nm) | (min) | KEEPING |
| EXAMPLE 19 | 8 | 720 | 480 | 1.32 |
| EXAMPLE 20 | 50 | 735 | 5 | 1.19 |
| EXAMPLE 21 | 20 | 740 | 3 | 1.25 |
| COMPARISON | — | — | — | 1 |
| EXAMPLE 4 | | | | |

As shown in Table 11, in cases where a far-infrared light wavelength takes values of 720 nm, 735 nm, and 740 nm, a value of freshness keeping is 1.1 or more. Accordingly, provided that light within a wavelength range from 700 nm to 750 nm inclusive is emitted, it is possible to keep freshness of a crop as long as possible.

### (Test 6)

In a thermostatic bath, a freshness keeping test was performed in a state where a bundle of spinach which is a vegetable belonging to leaves and stems is put into a test box having a cubic shape where a length of one side is 300 mm. In all of the examples and comparison examples, the spinach is irradiated with light such that the light becomes 2000 lx to 2500 lx. The test was performed under a condition where a temperature in the inside of the thermostatic bath is set to 5° C., and humidity in the thermostatic bath is set to 80% to 90%. Under a condition that the number of peaks is three, a peak ratio is 120%, a far-infrared light wavelength is 735 nm, an irradiation time is 60 minutes, and an interval time is 480 minutes, tests were performed with respect to a portion to be irradiated under conditions of examples 22 and 23 shown in Table 12 Further, the tests were performed by providing screen for interrupting irradiation light between a leaf part and a stem part of the spinach.

Table 12 shows also results of freshness keeping under the respective conditions. Further, comparison example 1 is a test where there is no irradiation of light within a wavelength range from 700 nm to 750 nm inclusive, and respective numerical values in freshness keeping in Table 12 indicate how many times a time at which a moisture amount of a crop becomes 95% or less of an initial moisture amount of the crop is longer than the time in comparison example 1.

TABLE 12

| | PORTION | |
|---|---|---|
| | TO BE | FRESHNESS |
| | IRRADIATED | KEEPING |
| EXAMPLE 22 | LEAF PART | 1.38 |
| EXAMPLE 23 | STEM PART | 1.1 |

As shown in Table 12, in examples 22 and 23, a value of freshness keeping is 1.1 times or more than that of comparison example 1, and both examples 22, 23 show favorable freshness keeping effect. That is, in both cases where far-infrared light is irradiated to the leaf part or the stem part, it is possible to acquire the freshness keeping effect.

Here, a value of freshness keeping of example 22 where irradiation light is irradiated to the leaf part, that is, 1.38 is larger than a value of freshness keeping of example 23 where irradiation light is irradiated to the stem part, that is, 1.1. That is, in a case where the leaf part having the larger number of pores than the stem part is irradiated with far-infrared light, it is possible to acquire the more favorable freshness keeping effect.

### (Test 7)

In a thermostatic bath, freshness keeping test was performed in a state where a head of broccoli which is a vegetable belonging to leaves and stems or a peach belonging to fruits is put into a test box having a cubic shape where a length of one side is 300 mm. In all of the examples and comparison examples, irradiation of light is performed such that the light becomes 2000 lx to 2500 lx. The test was performed under a condition where a temperature in the inside of the thermostatic bath is set to 5° C., and humidity in the thermostatic bath is set to 80% to 90%. Under a condition that the number of peaks is three, a peak ratio is 80%, a far-infrared light wavelength is 735 nm, an irradiation time is 60 minutes, an interval time is 420 minutes, and a color temperature is 5000 K, tests were performed under conditions of examples 24 and 25 and comparison examples 15 and 16 shown in Table 13.

Comparison examples 15 and 16 are tests where there is no irradiation of light within a wavelength range from 700 nm to 750 nm inclusive in examples 24 and 25. Accordingly, respective numerical values in freshness keeping of examples 24 and 25 in Table 13 indicate how many times a time at which a moisture amount of a crop becomes 95% or less of an initial moisture amount of the crop is longer than the time in comparison examples 15 and 16.

TABLE 13

| | | | CHANGE IN |
|---|---|---|---|
| | | FRESHNESS | EXTERNAL |
| | CROP | KEEPING | APPEARANCE |
| EXAMPLE 24 | PEACH | 1.23 | NO REMARKABLE |
| | | | CHANGE |
| EXAMPLE 25 | BROCCOLI | 1.11 | NO REMARKABLE |
| | | | CHANGE |
| COMPARISON | PEACH | 1 | WRINKLES |
| EXAMPLE 15 | | | GENERATED |
| | | | ON SURFACE |
| COMPARISON | BROCCOLI | 1 | FLOWER BUDS |
| EXAMPLE 16 | | | SEPARATED |

As shown in Table 13, in examples 24 and 25, values of freshness keeping are 1.23 and 1.11 respectively, and both examples 24 and 25 show favorable freshness keeping effect. Further, in a change in external appearance, in a case where far-infrared light is not irradiated, a change occurs such that wrinkles are generated on a surface in the peach, and flower buds are separated in the broccoli. On the other hand, when far-infrared light is irradiated, in both the peach and the broccoli, there is no remarkable change in external appearance. In this manner, the freshness keeping method according to the present disclosure is applicable to various kinds of crops.

Although the content of the exemplary embodiments of the present disclosure is described with reference to examples, the present exemplary embodiments are not limited to the above-mentioned configurations, and it is apparent for those who are skilled in the art that various modifications and improvements are conceivable.

### Third Exemplary Embodiment

In the following description, a wavelength range of far-infrared light is a range of from 700 nm to 800 nm inclusive. Further, a wavelength range of white light is a range of from 380 nm to 700 nm inclusive. Further, a wavelength range of blue light is a range of from 380 nm to 500 nm inclusive. Further, a wavelength range of green light is a range of from 500 nm to 600 nm inclusive. Hereinafter, the description is made with respect to freshness keeping device 10 and storage compartment 100 according to a third exemplary embodiment with reference to FIG. 1 and FIG. 2. FIG. 1 is a schematic perspective view of an external appearance of storage compartment 100 according to the third exemplary embodiment. FIG. 2 is a block diagram showing one example of a functional constitution of freshness keeping device 10 which storage compartment 100 according to the third exemplary embodiment includes.

### [Configuration]

Storage compartment 100 shown in FIG. 1 is a storage compartment for storing (preserving) crops 30 after being accommodated and, for example, is installed on a backyard of a store which sells crops 30. Storage compartment 100 includes casing 20, door 22, and freshness keeping device 10.

Casing 20 is an approximately rectangular parallelepiped outer shape, and crops 30 are put into and taken out from storage part 21 (storing space) having a rectangular parallelepiped shape which forms an internal space of casing 20 from a front side. Casing 20 is made of metal such as aluminum, but may be made of a resin. A shape of casing 20, a material of casing 20 and the like are merely examples, and are not particularly limited.

Openable door 22 (cover) is disposed on a front side of storage part 21. When door 22 is closed and first light emitter 13 and second light emitter 14 are turned off, the inside of storage part 21 becomes a darkroom (an environment of 0 lux).

Freshness keeping device 10 is a device for keeping freshness of harvested crops 30. As shown in FIG. 1 and FIG. 2, freshness keeping device 10 includes power plug 11, controller 12, first light emitter 13, and second light emitter 14.

Power plug 11 is one example of a power receiving portion, and includes terminal portion 11a, and power converter 11b. Power plug 11 is a so-called AC adapter.

Terminal portion 11a is a metal-made terminal inserted into an electric outlet. A shape, a material, and the like of terminal portion 11a are not particularly limited.

Power converter 11b converts AC power which terminal portion 11a receives into DC power, and supplies DC power to controller 12, first light emitter 13, and second light emitter 14. Specifically, power converter 11b is an AC-DC converter circuit. In storage compartment 100, although power converter 11b is disposed outside casing 20, power conversion portion 11b may be incorporated in casing 20.

First light emitter 13 is an irradiation device which is disposed above storage part 21, and irradiates crops 30 stored in storage part 21 with far-infrared light based on a control by controller 12. As the far-infrared light, light may be used where the light has a main peak within a wavelength range (700 nm to 800 nm inclusive) of far-infrared light, and an emission spectrum of the far-infrared light falls within a range from 400 nm to 1000 nm inclusive as a whole, for example.

Specifically, first light emitter 13 is a light emitting module which includes a printed circuit board, and a plurality of far-infrared LEDs mounted on the printed circuit board. However, first light emitter 13 may have any configuration provided that first light emitter 13 can irradiate far-infrared light. For example, a configuration may be adopted where only far-infrared light is emitted by using a light emitting element which emits light having a light emitting peak other than far-infrared light and a spectral filter in combination.

In FIG. 1, although a bulb-type first light emitter 13 is shown, such bulb-type first light emitter 13 is merely shown schematically, and a shape of first light emitter 13 is not limited to such a bulb-type light emitter. For example, first light emitter 13 may be configured to make surface emission using a light guide plate or the like. Alternatively, first light emitter 13 may have a shape of a pendant light or a shape of a down light.

Here, it is preferable that first light emitter 13 uniformly irradiate crops 30 with far-infrared light. Since it is considerable that the far-infrared light mainly influences keeping of freshness, by uniformly irradiating crop 30 with far-infrared light, it is possible to keep freshness of crop 30 efficiently. Examples of a method of uniformly irradiating crop 30 with far-infrared light include a method which uses a surface emission using a light guide plate, a milky white plate or the like, a method where light sources of first light emitter 13 are arranged in a matrix array, and the like. As the milky white plate, a plate, or the like, obtained by combining a reflection sheet, an acrylic plate, and a diffusion plate can be used.

Here, far-infrared light which first light emitter 13 emits (emission spectrum of far-infrared light) typically has one peak. However, the far-infrared light may have two or more peaks which differ from each other in wavelength. For example, in the third exemplary embodiment, first light emitter 13 emits far-infrared light having a peak wavelength of 720 nm, far-infrared light having a peak wavelength of 735 nm, or the like. However, first light emitter 13 may be configured to emit far-infrared light having peaks on both a wavelength 720 nm and a wavelength 735 nm. In this case, for example, first light emitter 13 can be configured such that an LED which emits far-infrared light having a peak wavelength of 720 nm and an LED which emits far-infrared light having a peak wavelength of 735 nm are mounted on a printed circuit board.

Second irradiation part 14 is disposed above storage part 21, and irradiates crop 30 stored in storage part 21 with white light based on control by controller 12. As the white light, it is sufficient to use light which is visually recognized as white light by human eyes, and for example, not only light where an emission spectrum falls within a wavelength range (380 nm and 700 nm inclusive) of the white light but also light where entire emission spectrum is included in a range from 350 nm and 750 nm inclusive and the like may be used.

Second light emitter 14 is a light emitting module having the COB structure constituted of a printed circuit board, a plurality of blue LEDs directly mounted on the printed circuit board, and a sealing member containing yellow phosphor particles. The sealing member seals the blue LEDs. As the yellow phosphor particles, for example, an yttrium-aluminum-garnet (YAG)-based phosphor can be used. Second light emitter 14 may be an SMD type light emitting module or may be a remote-phosphor-type light emitting module.

Further, second light emitter 14 may be configured to emit white light by combining a blue LED, a green LED, and a red LED together. Alternatively, second light emitter 14 may be configured to emit white light by combining an ultraviolet light LED, a blue phosphor, a green phosphor, and a red phosphor together.

In FIG. 1, although bulb-type second light emitter 14 is shown, such bulb-type second light emitter 14 is merely shown schematically, and a shape of second light emitter 14 is not limited to such a bulb-type light emitter. For example, second light emitter 14 may be configured to make surface emission using a light guide plate or the like. Alternatively, second light emitter 14 may have a shape of a pendant light or a shape of a down light.

Here, first light emitter 13 and second light emitter 14 may be configured as one light emitter. For example, when such a light emitter is configured by the COB structure, the light emitter can be configured such that a far-infrared light LED and a blue LED mounted on a printed circuit board are sealed by a sealing member containing yellow phosphor particles. Alternatively, the light emitter may be configured by combining a far-infrared light LED, a blue LED, and a yellow LED or a green LED together.

Here, mounting positions of first light emitter 13 and second light emitter 14 are not limited to positions above storage part 21. For example, a configuration may be adopted where first light emitter 13 and second light emitter 14 are mounted on a side surface or a bottom surface of storage part 21. Further, first light emitter 13 may be mounted on a ceiling surface of storage part 21, and second light emitter 14 may be mounted on a side surface of storage part 21. Alternatively, first light emitter 13 and second light emitter 14 may be mounted at different positions such that first light emitter 13 is mounted on a side surface of storage part 21, and second light emitter 14 is mounted on a ceiling surface of storage part 21.

Controller 12 is one example of the control part, and is a controller which controls first light emitter 13 and second light emitter 14 based on an operation by a user. Controller 12 controls intensity of the far-infrared light which first light emitter 13 emits, and an irradiation time of the far-infrared light which first light emitter 13 emits. Controller 12 controls turning on and off of irradiation of light from first light emitter 13 and turning on and off of irradiation of light from second light emitter 14. Controller 12 may be configured to control intensity of white light which second light emitter 14 emits.

Specifically, controller 12 is constituted of a PWM control circuit (light control circuit) for controlling illuminance of first light emitter 13, a timer circuit which controls a irradiation time of first light emitter 13, and the like. Controller 12 may be constituted with a processor, a microcomputer, or the like. In storage compartment 100, although controller 12 is disposed outside casing 20, controller 12 may be partially or entirely incorporated in casing 20.

Although it is not always necessary for freshness keeping device 10 to include controller 12, it is preferable that freshness keeping device 10 include controller 12. Further, a controller for controlling intensity of far-infrared light and a controller for controlling an irradiation time of far-infrared light may be provided separately. Controller 12 may be integrally formed with first light emitter 13 and second light emitter 14. Specific configuration of controller 12 is not particularly limited, and a conventionally known controller may be used as controller 12, for example.

Storage compartment 100 may include a cooling device for cooling the inside of storage part 21. As a matter of course, the cooling device is not essential.

In a case where storage compartment 100 includes large storage part 21, storage compartment 100 may include a belt conveyor for moving crops 30. In this case, due to the movement of the belt conveyor, crops 30 which move to an area below first light emitter 13 are sequentially irradiated by far-infrared light.

### [Operation of Freshness Keeping Device]

Next, an operation of freshness keeping device 10 (freshness keeping method) is described.

Freshness keeping device 10 irradiates harvested crop 30 with far-infrared light and white light based on the control of controller 12. Irradiation illuminance of the far-infrared light is 0.02 times or more and 0.2 times or less as large as irradiation illuminance of the white light.

In freshness keeping device 10, it is preferable that first light emitter 13 which emits far-infrared light and second light emitter 14 which emits white light be configured such that irradiation illuminance and irradiation time of first light emitter 13 and second light emitter 14 can be controlled separately. Favorable reason is that proper freshness keeping can be achieved corresponding to usage and a mounting place of freshness keeping device 10 by separately controlling far-infrared light which mainly contributes to freshness keeping of crop 30 and white light necessary for enhancing visibility of crop 30 although contribution to freshness keeping of crop 30 is small.

In freshness keeping device 10, it is preferable that total irradiation illuminance of the far-infrared light and the white light be 0.4 W/m² or more and 48 W/m² or less. Due to such a configuration, it is possible to enhance freshness keeping effect as described later.

From a viewpoint of freshness keeping of crop 30, it is preferable that freshness keeping device 10 be configured such that an integrated light amount of far-infrared light in a day is 0.001 times or more as large as an integrated light amount of white light in a day.

Further, from a viewpoint of freshness keeping of crop 30, in freshness keeping device 10, it is preferable that a total integrated light amount of the far-infrared light and the white light in a day be 2058 kJ/m² or less. The above-mentioned irradiation condition is described in detail in items in examples.

Further, from a viewpoint of freshness keeping of crop 30, it is preferable that irradiation illuminance of the far-infrared light be set to 0.09 times or more and 1.6 times or less as large as irradiation illuminance of a blue light component contained in the white light. It is more preferable that a total irradiation illuminance of the far-infrared light and the blue light component be 0.4 W/m² or more and 11 W/m² or less. It is more preferable that an integrated light amount of the far-infrared light in a day be set to 0.003 times or more and 1.6 times or less of an integrated light amount of the blue light component in a day. It is more preferable that a total integrated light amount of the far-infrared light and the blue light component in a day be 930 kJ/m² or less.

Further, from a viewpoint of freshness keeping of crop 30, it is preferable that irradiation illuminance of the far-infrared light be set to 0.04 times or more and 1.1 times or less as large as irradiation illuminance of a green light component contained in the white light. It is more preferable that a total irradiation illuminance of the far-infrared light and the green light component be 0.4 W/m² or more and 22 W/m² or less. It is more preferable that an integrated light amount of the far-infrared light in a day be set to 0.002 times or more and 1.1 times or less of an integrated light amount of the green light component in a day. It is more preferable that a total integrated light amount of the far-infrared light and the green light component in a day be 1900 kJ/m² or less.

Here, the blue light component means a component within a wavelength range of the blue light (from 380 nm to 500 nm inclusive) in the white light. Here, the green light component means a component within a wavelength range of the green light (from 500 nm to 600 nm inclusive) in the white light.

Further, it is preferable that the far-infrared light be emitted to a portion of crop 30 having a large number of pores. The portion having the large number of pores is a leaf part and the like of vegetables, and particularly, a back side of a leaf and the like. It is estimated that when the pores are moved in a closing direction due to irradiation of the far-infrared light and evaporation of moisture from the inside of crop 30 is suppressed, and hence, by emitting the far-infrared light to the portion of crop 30 having the large number of pores as described above, it is possible to keep freshness of crop 30 efficiently.

### [Effects and Other Benefits]

Here, essential points of freshness keeping device 10 and storage compartment 100 according to the third exemplary embodiment are described again. Further, the present disclosure also has an aspect of a freshness keeping method and hence, the freshness keeping method according to the exemplary embodiment is also described hereinafter.

The freshness keeping method according to the exemplary embodiment is a freshness keeping method for irradiating harvested crop 30 with light, wherein far-infrared light and white light are emitted. Further, irradiation illuminance of the far-infrared light is 0.02 times or more and 0.2 times or less as large as irradiation illuminance of the white light.

By using the freshness keeping method having the above-mentioned configuration, it is possible to keep freshness of harvested crop 30 properly, and visibility of crop 30 can be enhanced.

In the freshness keeping method according to the exemplary embodiments, it is preferable that a total irradiation illuminance of the far-infrared light and the white light be 0.4 W/m² or more and 48 W/m² or less.

Due to the above-mentioned configuration, visibility of crops 30 can be particularly enhanced, and at the same time, it is possible to keep freshness of harvested crops 30 more efficiently.

In the freshness keeping method according to the exemplary embodiment, it is preferable that an integrated light amount of the far-infrared light in a day be 0.001 times or more as large as an integrated light amount of the white light in a day.

Due to the above-mentioned configuration, visibility of crops 30 can be particularly enhanced, and at the same time, it is possible to keep freshness of harvested crops 30 more efficiently.

In the freshness keeping method according to the exemplary embodiment, it is preferable that a total integrated light amount of the far-infrared light and the white light in a day be 2058 kJ/m² or less.

Due to the above-mentioned configuration, visibility of crops 30 can be particularly enhanced, and at the same time, it is possible to keep freshness of harvested crops 30 more efficiently.

Further, in the freshness keeping method according to the exemplary embodiment, it is preferable that irradiation illuminance of the far-infrared light be set to 0.09 times or more and 1.6 times or less as large as irradiation illuminance of a blue light component contained in the white light.

Due to the above-mentioned configuration, visibility of crops 30 can be particularly enhanced, and at the same time, it is possible to keep freshness of harvested crops 30 more efficiently.

In the freshness keeping method according to the exemplary embodiment, it is preferable that a total irradiation illuminance of the far-infrared light and the blue light component be 0.4 W/m² or more and 11 W/m² or less.

Due to the above-mentioned configuration, visibility of crops 30 can be particularly enhanced, and at the same time, it is possible to keep freshness of harvested crops 30 more efficiently.

In the freshness keeping method according to the exemplary embodiment, it is preferable that an integrated light amount of the far-infrared light in a day be 0.003 times or more and 1.6 times or less as large as an integrated light amount of the blue light component in a day.

Due to the above-mentioned configuration, visibility of crops 30 can be particularly enhanced, and at the same time, it is possible to keep freshness of harvested crops 30 more efficiently.

In the freshness keeping method according to the exemplary embodiment, it is preferable that a total integrated light amount of the far-infrared light and the blue light component in a day be 930 kJ/m² or less.

Due to the above-mentioned configuration, visibility of crops 30 can be particularly enhanced, and at the same time, it is possible to keep freshness of harvested crops 30 more efficiently.

Further, in the freshness keeping method according to the exemplary embodiment, it is preferable that irradiation illuminance of the far-infrared light be set to 0.04 times or more and 1.1 times or less as large as irradiation illuminance of a green light component contained in the white light.

Due to the above-mentioned configuration, visibility of crops 30 can be particularly enhanced, and at the same time, it is possible to keep freshness of harvested crops 30 more efficiently.

In the freshness keeping method according to the exemplary embodiment, it is preferable that a total irradiation illuminance of the far-infrared light and the green light component be 0.4 W/m² or more and 22 W/m² or less.

Due to the above-mentioned configuration, visibility of crops 30 can be particularly enhanced, and at the same time, it is possible to keep freshness of harvested crops 30 more efficiently.

In the freshness keeping method according to the exemplary embodiment, it is preferable that an integrated light amount of the far-infrared light in a day be 0.002 times or more and 1.1 times or less as large as an integrated light amount of the green light component in a day.

Due to the above-mentioned configuration, visibility of crops 30 can be particularly enhanced, and at the same time, it is possible to keep freshness of harvested crops 30 more efficiently.

In the freshness keeping method according to the exemplary embodiment, it is preferable that a total integrated light amount of the far-infrared light and the green light component in a day be 1900 kJ/m² or less.

Due to the above-mentioned configuration, visibility of crops 30 can be particularly enhanced, and at the same time, it is possible to keep freshness of harvested crops 30 more efficiently.

Freshness keeping device 10 according to the third exemplary embodiment is a freshness keeping device which irradiates harvested crop 30 with light, wherein freshness keeping device 10 includes: first light emitter 13 which emits far-infrared light; and second light emitter 14 which emits white light. Further, irradiation illuminance of the far-infrared light which first light emitter 13 emits is set to 0.02 times or more and 0.2 times or less as large as irradiation illuminance of the white light which second light emitter 14 emits.

By using freshness keeping device 10 having the above-mentioned configuration, it is possible to keep freshness of harvested crop 30 properly, and visibility of crop 30 can be enhanced.

In freshness keeping device 10 according to the third exemplary embodiment, it is preferable that a total irradiation illuminance of the far-infrared light which first light emitter 13 emits and the white light which second light emitter 14 emits be 0.4 W/m² or more and 48 W/m² or less.

Due to the above-mentioned configuration, visibility of crops 30 can be particularly enhanced, and at the same time, it is possible to keep freshness of harvested crops 30 more efficiently.

Storage compartment 100 according to the third exemplary embodiment includes freshness keeping device 10, and casing 20 which accommodates crop 30.

By using storage compartment 100 having the above-mentioned configuration, it is possible to keep freshness of crop 30 properly while accommodating harvested crop 30, and visibility of crop 30 can be enhanced.

### Fourth Exemplary Embodiment

Hereinafter, with reference to FIGS. 3 to 6, showcase 200 according to the fourth exemplary embodiment of the present disclosure is described. FIG. 3 is a schematic perspective view of an external appearance of showcase 200 according to the fourth exemplary embodiment. FIG. 4 is a schematic cross-sectional view of showcase 200 according to the fourth exemplary embodiment in a side view. FIG. 5 is a block diagram showing one example of a functional constitution of freshness keeping device 210 which showcase 200 according to the fourth exemplary embodiment includes. FIG. 6 is a schematic perspective view showing a configuration of one example of a light emitting module.

In the description made hereinafter, the description of a portion overlapping with the description of the third exemplary embodiment is omitted or simplified. Further, constitutional elements substantially equal to the corresponding constitutional elements of the third exemplary embodiment are described by giving the same symbols.

### [Configuration]

Showcase 200 is a showcase having a plurality of shelves 202 on which harvested crops 30 are displayed (placed), and for example, is installed in a salesroom of a store which sells crops 30. Showcase 200 includes body portion 201, shelves 202, base portion 203, and freshness keeping device 210.

Body portion 201 forms a space for accommodating crops 30. Body portion 201 is formed of side plates, a ceiling plate, a back plate, and frames for holding the side plates, the ceiling plate, and the back plate, and a front side of body portion 201 is opened. Specifically, body portion 201 is made of metal such as aluminum or iron, or a resin.

Shelves 202 are plate-like members for partitioning a space defined by body portion 201 in a vertical direction, and harvested crops 30 are displayed on upper surfaces of shelves 202. Body portion 201 may include three shelves 202, or may include not more than two or not less than four shelves 202. Specifically, shelves 202 are made of metal such as aluminum or iron, however, shelves 202 may be made of a resin.

Base portion 203 is a portion forming a base of showcase 200, and controller 212 which freshness keeping device 210 described later includes is mounted on base portion 203. Power converter 211b which freshness keeping device 210 includes is accommodated in the inside of base portion 203.

Freshness keeping device 210 includes power plug 211, power converter 211b, controller 212, and light emitter 213.

Power plug 211 as one example of a power receiving portion has a metal-made terminal which is inserted into an electric outlet, and receives AC power from the terminal.

Power converter 211b converts AC power which power plug 211 receives into DC power, and supplies DC power to controller 212 and light emitter 213. Specifically, power converter 211b is an AC-DC converter circuit. In showcase 200, power converter 211b is incorporated in base portion 203.

Controller 212 is one example of the control part, and controls light emitter 213 based on an operation by a user. Controller 212 is constituted with, for example, a timer circuit which controls intensity of far-infrared light which light emitter 213 emits, and an irradiation time of far-infrared light which light emitter 213 emits. Controller 212 may be constituted with a processor, a microcomputer, or the like.

Controller 212 controls, for example, turning on and off of irradiation of far-infrared light from light emitter 213 and turning on and off of irradiation of white light from light emitter 213. Controller 212 may be configured to control intensity of white light which light emitter 213 emits.

Light emitter 213 is disposed above each of shelves 202, and irradiates crops 30 displayed on shelves 202 with far-infrared light and white light based on a control by controller 212. In the fourth exemplary embodiment, the description is made by using light emitter 213 having substantially the same configuration as a light emitter obtained by integrally forming first light emitter 13 and second light emitter 14 of the third exemplary embodiment.

As shown in FIG. 4, light emitter 213 includes base 213e, light emitting module 213c which is a printed circuit board 213a on which LEDs 213b are mounted, and diffusion cover 213d.

Base 213e is a mounting base and a heat sink for mounting light emitting module 213c, and functions also as a member for mounting light emitter 213 on shelves 202. Base 213e is made of metal such as aluminum die-cast, for example.

Diffusion cover 213d diffuses light emitted from light emitting module 213c and allows the light to pass therethrough, and irradiates crops 30 with the light.

Light emitting module 213c is printed circuit board 213a on which LEDs 213b are mounted. Hereinafter, the structure of light emitting module 213c is described in detail with reference to FIG. 6.

As shown in FIG. 6, to be more specific, light emitting module 213c includes printed circuit board 213a, a plurality of LEDs 213b which are mounted on printed circuit board 213a in a row, wiring 223, connector 224, and connector 225.

Printed circuit board 213a is a printed circuit board having an elongated rectangular shape. Printed circuit board 213a is a CEM-3 printed circuit board using a resin as a base material. However, printed circuit board 213a may be other resin-made printed circuit board, and may be a metal-base printed circuit board or a ceramic printed circuit board. As another resin-made printed circuit board, an FR-4 printed circuit board is exemplified. As the ceramic printed circuit board, an alumina printed circuit board made of aluminum oxide (alumina), an aluminum nitride printed circuit board made of aluminum nitride and the like can be exemplified. As the metal base printed circuit board, an aluminum alloy printed circuit board, an iron alloy printed circuit board, a copper alloy printed circuit board, and the like can be exemplified.

LED 213b is one example of a light emitting element, and is a bare chip which emits mono-color visible light. As LEDs 213b, far-infrared light LEDs for emitting far-infrared light, and LEDs for emitting white light are used. LEDs 213b are each mounted on printed circuit board 213a by die bonding using a die attach material (die bonding material), for example.

To emit white light, light emitter 213 is configured to include three kinds of LEDs, for example, a blue LED, a green LED, and a red LED, as LEDs 213b. Alternatively, light emitter 213 may be configured such that light emitter 213 includes the blue LED as LED 213b, and the blue LED and yellow phosphor particles are combined together for emitting the white light.

It is preferable that these LEDs 213b including the far-infrared light LEDs, the blue LEDs, and the green LEDs be disposed on printed circuit board 213a such that LEDs 213b of the same kind are not disposed adjacently to each other. With such a configuration, deviation in color depending on an emitted place of light can be reduced thus acquiring uniform light.

Wiring 223 is a metal wiring made of tungsten (W), copper (Cu), or the like. Wiring 223 is formed into a predetermined shape by patterning such that the plurality of LEDs 213b are electrically connected to each other, and at the same time, LEDs 213b, connector 224, and connector 225 are electrically connected to each other.

In FIG. 6, wiring 223 connects LEDs 213b arranged in a row in series. However, the configuration of wiring 223 is not limited to such a configuration. For example, wiring 223 may be configured such that LED element arrays each of which includes a predetermined number of LEDs 213b aligned in row are connected in parallel.

Further, it is preferable that wiring 223 be the LED element arrays formed by connecting LEDs 213b of the same kind out of the far-infrared light LEDs, the blue LEDs, and the green LEDs, and the LED element arrays be connected in parallel. With such a configuration, light emitting intensity of LEDs 213b of the respective kinds can be individually controlled, and from viewpoints of freshness keeping and visibility of crops 30, light emitted from LEDs 213b can be adjusted to be proper light.

Alternatively, wiring 223 may be configured to connect the far-infrared light LEDs which mainly contribute to freshness keeping of crops 30 and other kinds of LEDs in parallel. With such a configuration, intensity and an irradiation time of far-infrared light which mainly contributes to freshness keeping of crops 30 can be adjusted so that it is possible to keep freshness of crops 30 more properly.

Connector 224 and connector 225 are connectors for supplying power to light emitting module 213c. DC power is supplied to connector 224 or connector 225 from controller 212. Due to the supply of DC power, light emitting module 213c emits light.

### [Effects and Other Benefits]

Here, essential points of showcase 200 according to the fourth exemplary embodiment are described again.

Showcase 200 according to the fourth exemplary embodiment includes freshness keeping device 210, and shelves 202 on which crops 30 are displayed.

By using showcase 200 having the above-mentioned configuration, it is possible to keep freshness of crops 30 properly in a state where harvested crops 30 are displayed on shelves 202, and visibility of crops 30 can be enhanced.

### Supplemental Description of Exemplary Embodiment

First, crops are supplementarily described. In the above-mentioned exemplary embodiment, “crops” means all crops capable of being harvested by an agricultural technique. Although crops are not particularly limited, crops include vegetables, fruits, and flowers and ornamental plants in the usually-performed classification corresponding to usage part (referred to as horticultural classification or artificial classification), for example.

Vegetables include fruits vegetables, leaves and stems, root vegetables, mushrooms, and the like.

Here, fruit vegetables include: grains such as corn; and beans such as azuki bean, common bean, pea, green soybean, cowpea, winged bean, broad bean, soybean, sword bean, peanut, lentil and sesame besides eggplant, pepino, tomato, mini tomato, tamarillo, gamblea innovans, hot pepper, sweet green pepper, Habanero chilli, green pepper, bell pepper, colored bell pepper, pumpkin, zucchini, cucumber, horned melon, melon cucumber, bitter melon, winter melon, chayote, luffa, bottle gourd, okra, garden strawberry, water melon, melon, and Korean melon.

Further, leaves and stems include: leaf vegetables such as ice plant, angelica keiskei, mustard greens, cabbage, watercress, kale, Japanese mustard spinach, salad lettuce, red leaf lettuce, Asiasari radix, Sang-chu lettuce, non-heading Chinese cabbage “santosai”, perilla, crown daisy, water shield, water shield, water dropwort, celery, tatsoi, Japanese radish leaf, leaf mustard, lettuce, Green bok choy, Brassica campestris, rape blossoms, Nozawana, heading Chinese cabbage, parsley, spinach mustard, Swiss chard, spinach, Lamium amplexicaule, leaf green “mizuna”, greater chickweed, common chickweed, giant chickweed, leaf green “mibuna”, Japanese hornwort, Brussels sprouts, Nalta jute, green leaf lettuce, rocket salad, lettuce, wasabi greens; stem vegetables such as Welsh onion, green onion, chive, Chinese chive, asparagus, Japanese spikenard, kohlrabi, zha cai, bamboo shoot, garlic, water convolvulus, green onion “wakegi”, onion;

flower vegetables such as globe artichoke, broccoli, cauliflower, chrysanthemum, Brassica flower, butterbur scape, Japanese ginger; and sprout vegetables such as sprout, bean sprout, and radish sprout.

Further, root vegetables include potatoes such as sweet potato, taro, potato, Chinese yam, Japanese yam, in addition to turnip, Japanese radish, Western little radish, wasabi, horseradish, edible burdock, Chinese artichoke, ginger, carrot, Japanese scallion, and lotus root.

Further, mushrooms include: winter mushroom, king oyster mushroom, Jew's ear, Dictyophora indusiata, “shiitake” mushroom, “shimeji” mushroom, white jelly fungus, golden oyster mushroom, Lactarius volemus, Pholiota microspora, Armillaria mellea, Lyophyllum decastes, oyster mushroom, beech mushroom, bunapi, porcini, Lyophyllum shimeji, Tricholoma flavovirens, Grifola frondosa, Agaricus campestris, Tricholoma matsutake, bearded tooth mushroom, Rhizopogon, truffle, and the like.

Further, fruits include: various kinds of citrus fruits including orange, apple, peach, sand pear, European pear, banana, grape, cherry, oleaster, blueberry, raspberry, black berry, mulberry, loquat, fig, Japanese persimmon, akebi, mango, avocado, jujube, pomgranate, passion fruit, pineapple, papaya, apricot, Prunus mume, plum, kiwifruit, Chinese quince, myrica, chestnut, miracle fruit, guava, star fruit, acerola, and the like.

Further, as flowers, for example, hollyhock, bouvardia, godetia, evening primrose, garden stock, Brassica oleracea, lunaria, acidanthera, iris, gladiolus, California poppy, peperomia, calceolaria, snapdragon, torenia, primrose, cyclamen, Lampranthus spectabilis, anthurium, calla lily, caladium, calamus, symgonium, peace lily, dieffenbachia, philodendron, cactuses, Ajuga, false dragonhead, scarlet sage, begonia, curcuma, water lily, portulaca, violet, Queen Anne's lace, Setcreasea, boatlily, spiderwort, Impatiens balsamina, Solanum mammosum, petunia, Japanese lantern plant, carnation, pink, China pink, gypsophila, Gypsophila paniculata, catchfly, Guzmania, bird of paradise flower, moss pink, phlox, garden phlox, Filipendula purpurea, Amacrinum, amaryllis, chrysanthemum, marguerite, Kaffir lily, Ifafa lily, narcissus, snowflake, Zephyranthes candida, nerine, crinum, Amazon lily, licorice, agave, cockscomb, globe amaranth, morning glory, Evolvulus, cleome, geranium, kalanchoe, pincushion flower, sweet pea, lupine, Lurigio, forget-me-not, astilbe, saxifrage, agapanthus, Solomon's seal, aloe, star-of-Bethlehem, Japanese rhodea, Chlorophytum comosum, plantain lily, Fritillaria camtschatcensis, gloriosa, colchicum, sansevieria, Sandersonia, Ophiopogon japonicus, tulip, society garlic, lily of the valley, dracaena, triteleia, Polygonatum falcatum, New Zealand flax, fritillary, hyacinth, Japanese toad lily, Hemerocallis fulva ‘kwanso’, liriope, lily, alstroemeria, Ruscus, Large-flowered Cypripedium, Calanthe, oncidium, cattleya, Colmanara, urn orchid, cymbidium, coelogyne, dendrobium, Doritaenopsis, Phalaenopsis japonica, Paphiopedilum, vanda, birusutekera, Phalaenopsis, braunau, miltonia, Exacum, Texas bluebell, Japanese gentian, lantana, rose, cherry tree, African daisy, and the like can be named, and further, Japanese cleyera, cycad, fern, dracaena, aspidistra, Monstera, pothos, Compacta, Polyscias, anthurium crassinervium, Stemona japonica, Indian basket grass, Pittosporum, and the like for appreciating leaves are included.

Although some crops are exemplified heretofore, the freshness keeping method according to the above-mentioned exemplary embodiments is also applicable to crops other than the exemplified crops.

Next, the description is made supplementarily with respect to freshness keeping. In the above-mentioned exemplary embodiments, “freshness keeping” means to keep freshness of crops as long as possible. Freshness keeping effect necessary for a crop differs depending on a kind, a merchandise value, and the like of the crop.

For example, with respect to vegetables (leaf vegetables) where a leaf part or a stem part is mainly utilized such as lettuce and spinach, prevention of wilting (suppression of lowering of a moisture retention rate), prevention of discoloration (yellowing, browning, and the like), prevention of softening, prevention of generation of mold, and the like are important. Further, with respect to vegetables (fruit vegetables) where a pulp is mainly utilized such as strawberries and tomatoes or fruit trees such as apples, prevention of discoloration (yellowing, browning, and the like), prevention of softening, prevention of generation of mold, and the like are important. Further, with respect to flowers and ornamental plants, prevention of wilting (suppression of lowering of a moisture retention rate), prevention of discoloration (yellowing, browning, and the like), prevention of generation of mold, and the like are important.

Next, a situation where the freshness keeping method of the above-mentioned exemplary embodiments is utilized is described supplementarily. In the above-mentioned exemplary embodiments, in a case where crops on a backyard of a store is preserved or in a case where crops are displayed in a salesroom of the store, the freshness keeping method is utilized. However, the freshness keeping method may be utilized in other cases.

Harvested crops are transported to the city by a refrigerator truck through a farm, an agricultural cooperative, a dedicated facility where precooling of crops is performed, for example. Further, harvested crops are bought by the supplier in the market, are then preserved in the backyard of the supermarket and the like, and are displayed in the salesroom.

In the above-mentioned path, the freshness keeping method can be utilized in the dedicated facility, the refrigerator truck, the backyard and the saleroom of the supermarket and the like, and other places.

Further, harvested crops are transported to a second home delivery business office by a deliver car through the farm and a first home delivery business office, for example. Thereafter, there may be a case where harvested crops are transported to the purchaser (personal house) by a delivery car.

In the above-mentioned path, the freshness keeping method can be utilized in the first home delivery business office, the delivery car, the refrigerator truck, the second home delivery business office, and the like.

Further, for example, the freshness keeping method of the above-mentioned exemplary embodiments may be utilized for crops before harvested other than in harvested crops.

Further, far-infrared light passes through a general material (for example, polyethylene and the like) which is used as a storage container of crops. Accordingly, the freshness keeping method of the above-mentioned exemplary embodiments can be used for both crops in a usual boxed state and crops in a packed state.

Further, there may be a case where the far-infrared light passes through the crops, and hence the freshness keeping method of the above-mentioned exemplary embodiments can be utilized for crops overlapped on other crops.

The freshness keeping method of the above-mentioned exemplary embodiments may be utilized in a dark environment (darkness environment) or may be utilized under an environment which is artificially irradiated by white LEDs and the like. The freshness keeping method of the above-mentioned exemplary embodiments may be utilized under a sunlight environment.

Further, crops after being irradiated by the far-infrared light may be preserved under a completely dark environment (darkness environment), may be preserved under an environment which is artificially irradiated by white LEDs and the like, and may be preserved under a sunlight environment.

### Other Exemplary Embodiments

The freshness keeping method, the freshness keeping device, the storage compartment, and the showcase according to the present disclosure have been described with reference to the third and fourth exemplary embodiments heretofore. However, the present disclosure is not limited to the freshness keeping method, the freshness keeping device, the storage compartment, and the showcase according to the third and fourth exemplary embodiments.

For example, in the third and fourth exemplary embodiments, the description is made with respect to a case where the LEDs are used as the light source. However, the light emitting element is not limited only to the LED. Examples of the light source include a fluorescent tube, a metal hydride lamp, a sodium lamp, a halogen lamp, a xenon lamp, a neon tube, an inorganic electroluminescence, an organic electroluminescence, a chemiluminescence (chemical light emitting), and a laser.

In a case where, as the light source, a light source which can emit light also in a wavelength range other than the necessary wavelength range such as a fluorescent tube is used, the light source can be utilized as light having only the necessary wavelength range by combining the light source with a spectrum filter and the like.

An emission mode of the far-infrared light is not particularly limited. For example, the far-infrared light may be emitted instantaneously with an extremely large light amount such as stroboscopic light emission. Alternatively, the far-infrared light may be emitted for a long period at a low light amount. Alternatively, the far-infrared light may be emitted continuously or may be emitted intermittently.

Further, the freshness keeping device, the storage compartment, and the showcase according to the present disclosure may include an illuminance sensor. By using the irradiation sensor, the freshness keeping device, the storage compartment, and the showcase according to the present disclosure can adjust irradiation illuminance of the far-infrared light and the white light corresponding to the surrounding environment and the like.

In the above-mentioned exemplary embodiments, all of or a part of the respective constitutional elements (for example, controller) may be constituted with dedicated hardware, or may be implemented by executing a software program suitable for the respective constitutional elements. The respective constitutional elements may be implemented such that a program executing part such as a CPU or a processor reads out a software program stored in a storage medium such as a hard disc or a semiconductor memory and executes the software program.

The exemplary embodiments described above are given simply for the purpose of illustration of the exemplary embodiments of the present disclosure, and numeric values, raw materials, shapes, constituent elements, operations, and the like are also given only for illustrating preferable modes. Therefore, the present disclosure is not limited only to these exemplary embodiments. Further, out of the constitutional elements in the above-mentioned exemplary embodiments, the constitutional elements which are not described in independent claims describing an uppermost concept are described as arbitrary constitutional elements. The configuration may be modified as appropriate without departing from a range of a technical thought of the present disclosure.

### EXAMPLES

Hereinafter, the present exemplary embodiment is described in more detail with reference to examples and comparison examples.

In the description made hereinafter, “irradiation illuminance ratio” means a ratio between irradiation illuminance of far-infrared light and irradiation illuminance of white light, blue light or green light. In test 1 which uses the far-infrared light and the white light, assuming the irradiation illuminance of the far-infrared light as r, and the irradiation emission of the white light as w, the irradiation illuminance ratio is a value expressed by r/w. In test 2 which uses the far-infrared light and the blue light, assuming the irradiation illuminance of the far-infrared light as r, and the irradiation illuminance of the blue light as b, the irradiation illuminance ratio is a value expressed by r/b. In test 3 which uses the far-infrared light and the green light, assuming the irradiation illuminance of the far-infrared light as r, and the irradiation illuminance of the green light as g, the irradiation illuminance ratio is a value expressed by r/g.

Further, “total irradiation illuminance” means a total value of the irradiation illuminance of the far-infrared light and the irradiation illuminance of the white light, the blue light, or the green light. In test 1 which uses the far-infrared light and the white light, assuming the irradiation illuminance of the far-infrared light as r, and the irradiation illuminance of the white light as w, the total irradiation illuminance is a sum of values r and w. In test 2 which uses the far-infrared light and the blue light, assuming the irradiation illuminance of the far-infrared light as r, and the irradiation illuminance of the blue light as b, the total irradiation illuminance is a sum of values r and b. In test 3 which uses the far-infrared light and the green light, assuming the irradiation illuminance of the far-infrared light as r, and the irradiation illuminance of the green light as g, the total irradiation illuminance is a sum of values r and g. The unit of the total emission illuminance is W/m².

Further, an “integrated light amount ratio” means a ratio between an integrated light amount of the far-infrared light in a day and an integrated light amount of a white light, a blue light or a green light in a day. In test 1 which uses the far-infrared light and the white light, assuming the integrated light amount of the far-infrared light in a day as R, and the integrated light amount of the white light in a day as W, the integrated light amount ratio is a value expressed by R/W. In test 2 which uses the far-infrared light and the blue light, assuming the integrated light amount of the far-infrared light in a day as R, and the integrated light amount of the blue light in a day as B, the integrated light amount ratio is a value expressed by R/B. In test 3 which uses the far-infrared light and the green light, assuming the integrated light amount of the far-infrared light in a day as R, and the integrated light amount of the green light in a day as G, the integrated light amount ratio is a value expressed by R/G.

Further, a “total integrated light amount” means a sum of the integrated light amount of the far-infrared light in a day and the integrated light amount of the white light, the blue light, or the green light in a day. In test 1 which uses the far-infrared light and the white light, assuming the integrated light amount of the far-infrared light in a day as R, and the integrated light amount of the white light in a day as W, the total integrated light amount is a sum of values R and W. In test 2 which uses the far infrared light and the blue light, assuming the integrated light amount of the far-infrared light in a day as R, and the integrated light amount of the blue light in a day as B, the total integrated light amount is a sum of values R and B. In test 3 which uses the far-infrared light and the green light, assuming the integrated light amount of the far-infrared light in a day as R, and the integrated light amount of the green light in a day as G, the total integrated light amount is a sum of values R and G. The unit of the total integrated light amount is kJ/m².

Further, a “freshness keeping period magnification ratio” is a numerical value which indicates how many times a period where a moisture amount of a crop is maintained at 95% or more of an initial moisture amount of the crop is longer than a period where a moisture amount of a crop is maintained at 95% or more of an initial moisture amount of the crop in a case where the far-infrared light is not irradiated. Here, a moisture amount of a crop is calculated while assuming a change amount of the crop from an initial value of a weight of the crop as a weight of moisture evaporated from the crop.

The following results are results showing an average of similar tests using five samples.

### (Test 1)

The freshness keeping test was performed such that a bundle of spinach or a piece of lettuce which is a vegetable belonging to leaves and stems is put into an acrylic container having a rectangular parallelepiped shape of 280 mm×600 mm×220 mm. The tests were performed under a condition that a temperature during the tests is set to 5° C., and humidity is set to 80% to 85%. As a light source of the far-infrared light, far-infrared light LEDs each having a peak at a wavelength of 735 nm were disposed on two surfaces out of side surfaces and a ceiling surface of the above-mentioned acrylic container. Further, as a light source of the white light, a white LED having a color temperature of 4000 K was disposed on the ceiling surface of the above-mentioned acrylic container, and during the test, the white LED emitted light constantly.

Further, the sample (spinach or lettuce) was disposed at a position 200 mm away from the light source disposed on the ceiling surface, and the light source irradiated the sample with light for 72 hours. The test was performed such that an illuminance sensor (manufactured by DeltaOHM, HD2102.21) is disposed on a center portion of a floor surface of the above-mentioned acrylic container, and adjustment is performed such that irradiation illuminance of the far-infrared light or the like takes a predetermined value based on a measurement value of the illumination sensor.

### [About Influence of Irradiation Illuminance Ratio]

Test conditions and freshness keeping period magnification ratios of examples 1 to 6 and comparison examples 1 to 4 where the test is performed by changing an irradiation illuminance ratio under the above-mentioned test condition are shown in Table 14. Here, comparison example 1 is a test where the spinach is used as the crop and comparison example 3 is a test where the lettuce is used as the crop, and in both tests, far-infrared light was not emitted to the crop. Accordingly, a freshness keeping period magnification ratio of the test where the spinach is used as the crop indicates how many times a time at which a moisture amount of the crop becomes 95% or less of an initial moisture amount of the crop is longer than the time of comparison example 1. Further, a freshness keeping period magnification ratio of the test result where the lettuce is used as the crop indicates how many times a time at which a moisture amount of the crop becomes 95% or less of an initial moisture amount of the crop is longer than the time of comparison example 3.

TABLE 14

| | | | FRESHNESS |
|---|---|---|---|
| | | | KEEPING |
| | | IRRADIATION | PERIOD |
| | | ILLUMINANCE | MAGNIFICATION |
| | CROP | RATIO | RATIO |
| EXAMPLE 1 | SPINACH | 0.2 | 1.49 |
| EXAMPLE 2 | SPINACH | 0.16 | 1.8 |
| EXAMPLE 3 | SPINACH | 0.02 | 1.54 |
| EXAMPLE 4 | LETTUCE | 0.2 | 1.55 |
| EXAMPLE 5 | LETTUCE | 0.16 | 1.9 |
| EXAMPLE 6 | LETTUCE | 0.2 | 1.49 |
| COMPARISON | SPINACH | 0 | 1 |
| EXAMPLE 1 | | | |
| COMPARISON | SPINACH | 0.01 | 0.99 |
| EXAMPLE 2 | | | |
| COMPARISON | LETTUCE | 0 | 1 |
| EXAMPLE 3 | | | |
| COMPARISON | LETTUCE | 0.01 | 0.92 |
| EXAMPLE 4 | | | |

As shown in Table 14, in both of the case where the spinach is used as the crop and the case where the lettuce is used as the crop, in examples 1 to 6 where the irradiation illuminance ratio is 0.02 or more and 0.2 or less, a freshness keeping period magnification ratio is approximately 1.5 or more. On the other hand, in both of the case where the spinach is used as the crop and the case where the lettuce is used as the crop, in comparison examples 2 and 4 where the irradiation illuminance ratio falls outside a range of from 0.02 or more and 0.2 or less, a freshness keeping period magnification ratio is approximately 1 or less. Accordingly, from a viewpoint of freshness keeping of the crop, it is preferable that irradiation illuminance of the far-infrared light be set to 0.02 times or more and 0.2 times or less as large as the irradiation illuminance of the white light.

### [About Influence of Total Irradiation Illuminance]

Test conditions and freshness keeping period magnification ratios of examples 7 to 12 and comparison examples 5 to 8 where the test was performed by changing a total irradiation illuminance under the above-mentioned test condition are shown in Table 15. Here, a test where the spinach is used as the crop and a test where the lettuce is used as the crop respectively correspond to the above-mentioned comparison examples 1 and 3, and in both tests, the far-infrared light was not emitted to the crop. Accordingly, a freshness keeping period magnification ratio of the test where the spinach is used as the crop indicates how many times a time at which a moisture amount of the crop becomes 95% or less of an initial moisture amount of the crop is longer than the time of comparison example 1. Further, a freshness keeping period magnification ratio of the test result where the lettuce is used as the crop indicates how many times a time at which a moisture amount of the crop becomes 95% or less of an initial moisture amount of the crop is longer than the time of comparison example 3.

TABLE 15

| | | TOTAL | FRESHNESS |
|---|---|---|---|
| | | IRRADIATION | KEEPING PERIOD |
| | | ILLUMINANCE | MAGNIFICATION |
| | CROP | (W/m²) | RATIO |
| EXAMPLE 7 | SPINACH | 0.4 | 1.55 |
| EXAMPLE 8 | SPINACH | 7.1 | 1.8 |
| EXAMPLE 9 | SPINACH | 48 | 1.5 |
| EXAMPLE 10 | LETTUCE | 0.4 | 1.56 |
| EXAMPLE 11 | LETTUCE | 7.1 | 1.9 |
| EXAMPLE 12 | LETTUCE | 48 | 1.52 |
| COMPARISON | SPINACH | 0.39 | 1.3 |
| EXAMPLE 5 | | | |
| COMPARISON | SPINACH | 49 | 0.99 |
| EXAMPLE 6 | | | |
| COMPARISON | LETTUCE | 0.39 | 1.32 |
| EXAMPLE 7 | | | |
| COMPARISON | LETTUCE | 49 | 0.95 |
| EXAMPLE 8 | | | |

As shown in Table 15, in both of the case where the spinach is used as the crop and the case where the lettuce is used as the crop, in examples 7 to 12 where the total irradiation illuminance is 0.4 W/m² or more and 48 W/m² or less, a freshness keeping period magnification ratio is 1.5 or more. On the other hand, in both of the case where the spinach is used as the crop and the case where the lettuce is used as the crop, in comparison examples 5 to 8 where the total irradiation illuminance falls outside a range of from 0.4 W/m² or more to 48 W/m² or less, a freshness keeping period magnification ratio is approximately 1.3 or less. Accordingly, from a viewpoint of freshness keeping of the crop, it is preferable that total irradiation illuminance of the red light and the white light be 0.4 W/m² or more and 48W/m² or less.

### [About Influence of Integrated Light Amount Ratio]

Test conditions and freshness keeping period magnification ratios of examples 13 to 18 and comparison examples 9 and 10 where the test was performed by changing an integrated light amount ratio under the above-mentioned test condition are shown in Table 16. Here, a test where the spinach is used as the crop and a test where the lettuce is used as the crop respectively correspond to the above-mentioned comparison examples 1 and 3, and in both tests, the far-infrared light was not emitted to the crop. Accordingly, a freshness keeping period magnification ratio of the test where the spinach is used as the crop indicates how many times a time at which a moisture amount of the crop becomes 95% or less of an initial moisture amount of the crop is longer than the time of comparison example 1. Further, a freshness keeping period magnification ratio of the test result where the lettuce is used as the crop indicates how many times a time at which a moisture amount of the crop becomes 95% or less of an initial moisture amount of the crop is longer than the time of comparison example 3.

TABLE 16

| | | INTEGRATED | FRESHNESS |
|---|---|---|---|
| | | LIGHT | KEEPING PERIOD |
| | | AMOUNT | MAGNIFICATION |
| | CROP | RATIO | RATIO |
| EXAMPLE 13 | SPINACH | 0.001 | 1.3 |
| EXAMPLE 14 | SPINACH | 0.1 | 1.54 |
| EXAMPLE 15 | SPINACH | 1 | 1.6 |
| EXAMPLE 16 | LETTUCE | 0.01 | 1.32 |
| EXAMPLE 17 | LETTUCE | 0.1 | 1.55 |
| EXAMPLE 18 | LETTUCE | 1 | 1.69 |
| COMPARISON | SPINACH | 0.0009 | 0.99 |
| EXAMPLE 9 | | | |
| COMPARISON | LETTUCE | 0.0009 | 0.95 |
| EXAMPLE 10 | | | |

As shown in Table 16, in both of the case where the spinach is used as the crop and the case where the lettuce is used as the crop, in examples 13 to 18 where the integrated light amount ratio is 0.001 or more, a freshness keeping period magnification ratio is 1.3 or more. On the other hand, in both of the case where the spinach is used as the crop and the case where the lettuce is used as the crop, in comparison examples 9 and 10 where the integrated light amount ratio is 0.001 or less, a freshness keeping period magnification ratio is 1 or less. Accordingly, from a viewpoint of freshness keeping of the crop, it is preferable that an integrated light amount of the far-infrared light in a day be 0.001 times or more as large as an integrated light amount of the white light in a day.

### [About Influence of Total Integrated Light Amount]

Test conditions and freshness keeping period magnification ratios of examples 19 to 24 and comparison examples 11 and 12 where the test was performed by changing a total integrated light amount under the above-mentioned test condition are shown in Table 17. Here, a test where the spinach is used as the crop and a test where the lettuce is used as the crop respectively correspond to the above-mentioned comparison examples 1 and 3, and in both tests, a far-infrared light was not emitted to the crop. Accordingly, a freshness keeping period magnification ratio of the test where the spinach is used as the crop indicates how many times a time at which a moisture amount of the crop becomes 95% or less of an initial moisture amount of the crop is longer than the time of comparison example 1. Further, a freshness keeping period magnification ratio of the test result where the lettuce is used as the crop indicates how many times a time at which a moisture amount of the crop becomes 95% or less of an initial moisture amount of the crop is longer than the time of comparison example 3.

TABLE 17

| | | TOTAL | |
|---|---|---|---|
| | | INTEGRATED | FRESHNESS |
| | | LIGHT | KEEPING PERIOD |
| | | AMOUNT | MAGNIFICATION |
| | CROP | (kJ/m²) | RATIOS |
| EXAMPLE 19 | SPINACH | 100 | 1.55 |
| EXAMPLE 20 | SPINACH | 1000 | 1.54 |
| EXAMPLE 21 | SPINACH | 2058 | 1.5 |
| EXAMPLE 22 | LETTUCE | 100 | 1.6 |
| EXAMPLE 23 | LETTUCE | 1000 | 1.55 |
| EXAMPLE 24 | LETTUCE | 2058 | 1.5 |
| COMPARISON | SPINACH | 2059 | 0.99 |
| EXAMPLE 11 | | | |
| COMPARISON | LETTUCE | 2059 | 0.95 |
| EXAMPLE 12 | | | |

As shown in Table 17, in both of the case where the spinach is used as the crop and the case where the lettuce is used as the crop, in examples 19 to 24 where the total integrated light amount is 2058 kJ/m² or less, a freshness keeping period magnification ratio is 1.5 or more. On the other hand, in both of the case where the spinach is used as the crop and the case where the lettuce is used as the crop, in comparison examples 11 and 12 where the total integrated light amount is 2058 kJ/m² or more, a freshness keeping period magnification ratio is 1 or less. Accordingly, from a viewpoint of freshness keeping of a crop, it is preferable that a total integrated light amount of the far-infrared light and the white light in a day be 2058 kJ/m² or less.

### (Test 2)

The freshness keeping test was performed such that a bundle of spinach or a piece of lettuce which is a vegetable belonging to leaves and stems is put into an acrylic container having a rectangular parallelepiped shape of 280 mm×600 mm×220 mm. The tests were performed under a condition that a temperature during the tests is set to 5° C., and humidity is set to 80% to 85%. As a light source of the far-infrared light, far-infrared light LEDs each having a peak at a wavelength of 735 nm were disposed on two surfaces out of side surfaces and a ceiling surface of the above-mentioned acrylic container. Further, as a light source of the blue light, a blue LED having a peak at a wavelength 460 nm was disposed on the ceiling surface of the above-mentioned acrylic container, and during the test, the blue LED emitted light constantly.

Further, the sample (spinach or lettuce) was disposed at a position 200 mm away from the light source disposed on the ceiling surface, and the light source irradiated the sample with light for 72 hours. The test was performed such that an illuminance sensor (manufactured by DeltaOHM, HD2102.21) is disposed on a center portion of a floor surface of the above-mentioned acrylic container, and adjustment is performed such that irradiation illuminance of the far-infrared light or the like takes a predetermined value based on a measurement value of the illumination sensor.

### [About Influence of Irradiation Illuminance Ratio]

Test conditions and freshness keeping period magnification ratios of examples 25 to 30 and comparison examples 13 to 18 where the test was performed by changing an irradiation illuminance ratio under the above-mentioned test condition are shown in Table 18. Here, a test where the spinach is used as the crop and a test where the lettuce is used as the crop respectively correspond to the comparison examples 13 and 16, and in both tests, the far-infrared light was not emitted to the crop. Accordingly, a freshness keeping period magnification ratio of the test where the spinach is used as the crop indicates how many times a time at which a moisture amount of the crop becomes 95% or less of an initial moisture amount of the crop is longer than the time of comparison example 13. Further, a freshness keeping period magnification ratio of the test result where the lettuce is used as the crop indicates how many times a time at which a moisture amount of the crop becomes 95% or less of an initial moisture amount of the crop is longer than the time of comparison example 16.

TABLE 18

| | | | FRESHNESS |
|---|---|---|---|
| | | IRRADIATION | KEEPING PERIOD |
| | | ILLUMINANCE | MAGNIFICATION |
| | CROP | RATIO | RATIO |
| EXAMPLE 25 | SPINACH | 0.09 | 1.54 |
| EXAMPLE 26 | SPINACH | 0.61 | 1.8 |
| EXAMPLE 27 | SPINACH | 1.6 | 1.5 |
| EXAMPLE 28 | LETTUCE | 0.09 | 1.52 |
| EXAMPLE 29 | LETTUCE | 0.61 | 1.9 |
| EXAMPLE 30 | LETTUCE | 1.6 | 1.55 |
| COMPARISON | SPINACH | 0 | 1 |
| EXAMPLE 13 | | | |
| COMPARISON | SPINACH | 0.08 | 0.99 |
| EXAMPLE 14 | | | |
| COMPARISON | SPINACH | 1.7 | 1.3 |
| EXAMPLE 15 | | | |
| COMPARISON | LETTUCE | 0 | 1 |
| EXAMPLE 16 | | | |
| COMPARISON | LETTUCE | 0.08 | 0.92 |
| EXAMPLE 17 | | | |
| COMPARISON | LETTUCE | 1.7 | 1.32 |
| EXAMPLE 18 | | | |

As shown in Table 18, in both of the case where the spinach is used as the crop and the case where the lettuce is used as the crop, in examples 25 to 30 where the irradiation illuminance ratio is 0.09 or more and 1.6 or less, a freshness keeping period magnification ratio is approximately 1.5 or more. On the other hand, in both of the case where the spinach is used as the crop and the case where the lettuce is used as the crop, in comparison examples 14, 15, 17, and 18 where the irradiation illuminance ratio falls outside a range of from 0.09 or more and 1.6 or less, a freshness keeping period magnification ratio is approximately 1.3 or less. Accordingly, from a viewpoint of freshness keeping of the crop, it is preferable that irradiation illuminance of the far-infrared light be set to 0.09 times or more and 1.6 times or less as large as the irradiation illuminance of the blue light.

### [About Influence of Total Irradiation Illuminance]

Test conditions and freshness keeping period magnification ratios of examples 31 to 36 and comparison examples 19 to 22 where the test was performed by changing total irradiation illuminance under the above-mentioned test condition are shown in Table 19. Here, a test where the spinach is used as the crop and a test where the lettuce is used as the crop respectively correspond to the above-mentioned comparison examples 13 and 16, and in both tests, the far-infrared light was not emitted to the crop. Accordingly, a freshness keeping period magnification ratio of the test where the spinach is used as the crop indicates how many times a time at which a moisture amount of the crop becomes 95% or less of an initial moisture amount of the crop is longer than the time of comparison example 13. Further, a freshness keeping period magnification ratio of the test result where the lettuce is used as the crop indicates how many times a time at which a moisture amount of the crop becomes 95% or less of an initial moisture amount of the crop is longer than the time of comparison example 16.

TABLE 19

| | | TOTAL | FRESHNESS |
|---|---|---|---|
| | | IRRADIATION | KEEPING PERIOD |
| | | ILLUMINANCE | MAGNIFICATION |
| | CROP | (W/m²) | RATIO |
| EXAMPLE 31 | SPINACH | 0.4 | 1.55 |
| EXAMPLE 32 | SPINACH | 2.6 | 1.8 |
| EXAMPLE 33 | SPINACH | 11 | 1.5 |
| EXAMPLE 34 | LETTUCE | 0.4 | 1.56 |
| EXAMPLE 35 | LETTUCE | 2.6 | 1.9 |
| EXAMPLE 36 | LETTUCE | 11 | 1.6 |
| COMPARISON | SPINACH | 12 | 0.99 |
| EXAMPLE 19 | | | |
| COMPARISON | SPINACH | 0.39 | 1.3 |
| EXAMPLE 20 | | | |
| COMPARISON | LETTUCE | 12 | 0.95 |
| EXAMPLE 21 | | | |
| COMPARISON | LETTUCE | 0.39 | 1.32 |
| EXAMPLE 22 | | | |

As shown in Table 19, in both of the case where the spinach is used as the crop and the case where the lettuce is used as the crop, in examples 31 to 36 where the total irradiation illuminance is 0.4 W/m² or more and 11 W/m² or less, a freshness keeping period magnification ratio is 1.5 or more. On the other hand, in both of the case where the spinach is used as the crop and the case where the lettuce is used as the crop, in comparison examples 19 to 22 where the total irradiation illuminance falls outside a range of from 0.4 W/m² or more to 11W/m² or less, a freshness keeping period magnification ratio is approximately 1.3 or less. Accordingly, from a viewpoint of freshness keeping of the crop, it is preferable that the total irradiation illuminance of the far-infrared light and the blue light component be 0.4 W/m² or more and 11W/m² or less.

### [About Influence of Integrated Light Amount Ratio]

Test conditions and freshness keeping period magnification ratios of examples 37 to 42 and comparison examples 23 to 26 where the test was performed by changing an integrated light amount ratio under the above-mentioned test condition are shown in Table 20. Here, a test where the spinach is used as the crop and a test where the lettuce is used as the crop respectively correspond to the above-mentioned comparison examples 13 and 16, and in both tests, a far-infrared light was not emitted to the crop. Accordingly, a freshness keeping period magnification ratio of the test where the spinach is used as the crop indicates how many times a time at which a moisture amount of the crop becomes 95% or less of an initial moisture amount of the crop is longer than the time of comparison example 13. Further, a freshness keeping period magnification ratio of the test result where the lettuce is used as the crop indicates how many times a time at which a moisture amount of the crop becomes 95% or less of an initial moisture amount of the crop is longer than the time of comparison example 16.

TABLE 20

| | | INTEGRATED | FRESHNESS |
|---|---|---|---|
| | | LIGHT | KEEPING PERIOD |
| | | AMOUNT | MAGNIFICATION |
| | CROP | RATIO | RATIO |
| EXAMPLE 37 | SPINACH | 0.003 | 1.55 |
| EXAMPLE 38 | SPINACH | 0.08 | 1.8 |
| EXAMPLE 39 | SPINACH | 1.6 | 1.5 |
| EXAMPLE 40 | LETTUCE | 0.003 | 1.56 |
| EXAMPLE 41 | LETTUCE | 0.08 | 1.9 |
| EXAMPLE 42 | LETTUCE | 1.6 | 1.55 |
| COMPARISON | SPINACH | 0.002 | 0.99 |
| EXAMPLE 23 | | | |
| COMPARISON | SPINACH | 1.61 | 1.3 |
| EXAMPLE 24 | | | |
| COMPARISON | LETTUCE | 0.002 | 0.95 |
| EXAMPLE 25 | | | |
| COMPARISON | LETTUCE | 1.61 | 1.32 |
| EXAMPLE 26 | | | |

As shown in Table 20, in both of the case where the spinach is used as the crop and the case where the lettuce is used as the crop, in examples 37 to 42 where the integrated light amount ratio is 0.003 or more and 1.6 or less, a freshness keeping period magnification ratio is 1.5 or more. On the other hand, in both of the case where the spinach is used as the crop and the case where the lettuce is used as the crop, in comparison examples 23 to 26 where the integrated light amount ratio falls outside a range of from 0.003 or more and 1.6 or less, a freshness keeping period magnification ratio is approximately 1.3 or less. Accordingly, from a viewpoint of freshness keeping of the crop, it is preferable that an integrated light amount of the far-infrared light in a day be 0.003 times or more and 1.6 times or less as large as an integrated light amount of the blue light component in a day.

### [About Influence of Total Integrated Light Amount]

Test conditions and freshness keeping period magnification ratios of examples 43 to 48 and comparison examples 27 and 28 where the test was performed by changing a total integrated light amount under the above-mentioned test condition are shown in Table 21. Here, a test where the spinach is used as the crop and a test where the lettuce is used as the crop respectively correspond to the above-mentioned comparison examples 13 and 16, and in both tests, the far-infrared light was not emitted to the crop. Accordingly, a freshness keeping period magnification ratio of the test where the spinach is used as the crop indicates how many times a time at which a moisture amount of the crop becomes 95% or less of an initial moisture amount of the crop is longer than the time of comparison example 13. Further, a freshness keeping period magnification ratio of the test result where the lettuce is used as the crop indicates how many times a time at which a moisture amount of the crop becomes 95% or less of an initial moisture amount of the crop is longer than the time of comparison example 16.

TABLE 21

| | | TOTAL | |
|---|---|---|---|
| | | INTEGRATED | FRESHNESS |
| | | LIGHT | KEEPING PERIOD |
| | | AMOUNT | MAGNIFICATION |
| | CROP | (kJ/m²) | RATIO |
| EXAMPLE 43 | SPINACH | 100 | 1.55 |
| EXAMPLE 44 | SPINACH | 600 | 1.8 |
| EXAMPLE 45 | SPINACH | 930 | 1.5 |
| EXAMPLE 46 | LETTUCE | 100 | 1.6 |
| EXAMPLE 47 | LETTUCE | 600 | 1.55 |
| EXAMPLE 48 | LETTUCE | 930 | 1.5 |
| COMPARISON | SPINACH | 931 | 0.99 |
| EXAMPLE 27 | | | |
| COMPARISON | LETTUCE | 931 | 0.95 |
| EXAMPLE 28 | | | |

As shown in Table 21, in both of the case where the spinach is used as the crop and the case where the lettuce is used as the crop, in examples 43 to 48 where the total integrated light amount is 930 kJ/m² or less, the freshness keeping period magnification ratio is 1.5 or more. On the other hand, in both of the case where the spinach is used as the crop and the case where the lettuce is used as the crop, in comparison examples 27 and 28 where the total integrated light amount is 930 kJ/m² or more, the freshness keeping period magnification ratio is 1 or less. Accordingly, from a viewpoint of freshness keeping of a crop, it is preferable that the total integrated light amount of the far-infrared light and the blue light component in a day be 930kJ/m² or less.

### (Test 3)

The freshness keeping test was performed such that a bundle of spinach or a piece of lettuce which is a vegetable belonging to leaves and stems is put into an acrylic container having a rectangular parallelepiped shape of 280 mm×600 mm×220 mm. The tests were performed under a condition that a temperature during the tests is set to 5° C., and humidity is set to 80% to 85%. As a light source of the far-infrared light, far-infrared light LEDs each having a peak at a wavelength of 735 nm were disposed on two surfaces out of side surfaces and a ceiling surface of the above-mentioned acrylic container. Further, as a light source of the green light, a green LED having a peak at a wavelength 545 nm was disposed on the ceiling surface of the above-mentioned acrylic container, and during the test, the green LED emitted light constantly.

Further, the sample (spinach or lettuce) was disposed at a position 200 mm away from the light source disposed on the ceiling surface, and the light source irradiated the sample with light for 72 hours. The test was performed such that an illuminance sensor (manufactured by DeltaOHM, HD2102.21) is disposed on a center portion of a floor surface of the above-mentioned acrylic container, and adjustment is performed such that irradiation illuminance of the far-infrared light or the like takes a predetermined value based on a measurement value of the illumination sensor.

### [About Influence of Irradiation Illuminance Ratio]

Test conditions and freshness keeping period magnification ratios of examples 49 to 54 and comparison examples 29 to 34 where the test was performed by changing an irradiation illuminance ratio under the above-mentioned test condition are shown in Table 22. Here, a test where the spinach is used as the crop and a test where the lettuce is used as the crop respectively correspond to the comparison examples 29 and 32, and in both tests, the far-infrared light was not emitted to the crop. Accordingly, a freshness keeping period magnification ratio of the test where the spinach is used as the crop indicates how many times a time at which a moisture amount of the crop becomes 95% or less of an initial moisture amount of the crop is longer than the time of comparison example 29. Further, a freshness keeping period magnification ratio of the test result where the lettuce is used as the crop indicates how many times a time at which a moisture amount of the crop becomes 95% or less of an initial moisture amount of the crop is longer than the time of comparison example 32.

TABLE 22

| | | | FRESHNESS |
|---|---|---|---|
| | | IRRADIATION | KEEPING PERIOD |
| | | ILLUMINANCE | MAGNIFICATION |
| | CROP | RATIO | RATIO |
| EXAMPLE 49 | SPINACH | 0.04 | 1.54 |
| EXAMPLE 50 | SPINACH | 0.46 | 1.8 |
| EXAMPLE 51 | SPINACH | 1.1 | 1.5 |
| EXAMPLE 52 | LETTUCE | 0.04 | 1.52 |
| EXAMPLE 53 | LETTUCE | 0.46 | 1.9 |
| EXAMPLE 54 | LETTUCE | 1.1 | 1.55 |
| COMPARISON | SPINACH | 0 | 1 |
| EXAMPLE 29 | | | |
| COMPARISON | SPINACH | 0.03 | 0.99 |
| EXAMPLE 30 | | | |
| COMPARISON | SPINACH | 1.2 | 1.3 |
| EXAMPLE 31 | | | |
| COMPARISON | LETTUCE | 0 | 1 |
| EXAMPLE 32 | | | |
| COMPARISON | LETTUCE | 0.03 | 0.92 |
| EXAMPLE 33 | | | |
| COMPARISON | LETTUCE | 1.2 | 1.32 |
| EXAMPLE 34 | | | |

As shown in Table 22, in both of the case where the spinach is used as the crop and the case where the lettuce is used as the crop, in examples 49 to 54 where the irradiation illuminance ratio is 0.04 or more and 1.1 or less, the freshness keeping period magnification ratio is approximately 1.5 or more. On the other hand, in both of the case where the spinach is used as the crop and the case where the lettuce is used as the crop, in comparison examples 30, 31, 33, and 34 where the irradiation illuminance ratio falls outside a range of from 0.04 or more and 1.1 or less, a freshness keeping period magnification ratio is approximately 1.3 or less. Accordingly, from a viewpoint of freshness keeping of the crop, it is preferable that irradiation illuminance of the far-infrared light be set to 0.04 times or more and 1.1 times or less as large as the irradiation illuminance of the green light.

### [About Influence of Total Irradiation Illuminance]

Test conditions and freshness keeping period magnification ratios of examples 55 to 60 and comparison examples 35 to 38 where the test was performed by changing total irradiation illuminance under the above-mentioned test condition are shown in Table 23. Here, a test where the spinach is used as the crop and a test where the lettuce is used as the crop respectively correspond to the above-mentioned comparison examples 29 and 32, and in both tests, a far-infrared light was not emitted to the crop. Accordingly, a freshness keeping period magnification ratio of the test where the spinach is used as the crop indicates how many times a time at which a moisture amount of the crop becomes 95% or less of an initial moisture amount of the crop is longer than the time of comparison example 29. Further, a freshness keeping period magnification ratio of the test result where the lettuce is used as the crop indicates how many times a time at which a moisture amount of the crop becomes 95% or less of an initial moisture amount of the crop is longer than the time of comparison example 32.

TABLE 23

| | | TOTAL | FRESHNESS |
|---|---|---|---|
| | | IRRADIATION | KEEPING PERIOD |
| | | ILLUMINANCE | MAGNIFICATION |
| | CROP | (W/m²) | RATIO |
| EXAMPLE 55 | SPINACH | 0.4 | 1.67 |
| EXAMPLE 56 | SPINACH | 3.2 | 1.86 |
| EXAMPLE 57 | SPINACH | 22 | 1.52 |
| EXAMPLE 58 | LETTUCE | 0.4 | 1.53 |
| EXAMPLE 59 | LETTUCE | 3.2 | 1.89 |
| EXAMPLE 60 | LETTUCE | 22 | 1.66 |
| COMPARISON | SPINACH | 23 | 0.99 |
| EXAMPLE 35 | | | |
| COMPARISON | SPINACH | 0.39 | 1.32 |
| EXAMPLE 36 | | | |
| COMPARISON | LETTUCE | 23 | 0.92 |
| EXAMPLE 37 | | | |
| COMPARISON | LETTUCE | 0.39 | 1.33 |
| EXAMPLE 38 | | | |

As shown in Table 23, in both of the case where the spinach is used as the crop and the case where the lettuce is used as the crop, in examples 55 to 60 where the total irradiation illuminance is 0.4 W/m² or more and 22 W/m² or less, the freshness keeping period magnification ratio is 1.5 or more. On the other hand, in both of the case where the spinach is used as the crop and the case where the lettuce is used as the crop, in comparison examples 35 to 38 where the total irradiation illuminance falls outside a range of from 0.4 W/m² or more and 22 W/m² or less, the freshness keeping period magnification ratio is approximately 1.3 or less. Accordingly, from a viewpoint of freshness keeping of the crop, it is preferable that a total irradiation illuminance of the far-infrared light and the green light be 0.4 W/m² or more and 22 W/m² or less.

### [About Influence of Integrated Light Amount Ratio]

Test conditions and freshness keeping period magnification ratios of examples 61 to 66 and comparison examples 39 to 42 where the test was performed by changing an integrated light amount ratio under the above-mentioned test condition are shown in Table 24. Here, a test where the spinach is used as the crop and a test where the lettuce is used as the crop respectively correspond to the above-mentioned comparison examples 29 and 32, and in both tests, a far-infrared light was not emitted to the crop. Accordingly, a freshness keeping period magnification ratio of the test where the spinach is used as the crop indicates how many times a time at which a moisture amount of the crop becomes 95% or less of an initial moisture amount of the crop is longer than the time of comparison example 29. Further, a freshness keeping period magnification ratio of the test result where the lettuce is used as the crop indicates how many times a time at which a moisture amount of the crop becomes 95% or less of an initial moisture amount of the crop is longer than the time of comparison example 32.

TABLE 24

| | | INTEGRATED | FRESHNESS |
|---|---|---|---|
| | | LIGHT | KEEPING PERIOD |
| | | AMOUNT | MAGNIFICATION |
| | CROP | RATIO | RATIO |
| EXAMPLE 61 | SPINACH | 0.002 | 1.55 |
| EXAMPLE 62 | SPINACH | 0.05 | 1.82 |
| EXAMPLE 63 | SPINACH | 1.1 | 1.53 |
| EXAMPLE 64 | LETTUCE | 0.002 | 1.56 |
| EXAMPLE 65 | LETTUCE | 0.05 | 1.9 |
| EXAMPLE 66 | LETTUCE | 1.1 | 1.55 |
| COMPARISON | SPINACH | 0.0019 | 0.98 |
| EXAMPLE 39 | | | |
| COMPARISON | SPINACH | 1.11 | 1.34 |
| EXAMPLE 40 | | | |
| COMPARISON | LETTUCE | 0.0019 | 0.95 |
| EXAMPLE 41 | | | |
| COMPARISON | LETTUCE | 1.11 | 1.4 |
| EXAMPLE 42 | | | |

As shown in Table 24, in both of the case where the spinach is used as the crop and the case where the lettuce is used as the crop, in examples 61 to 66 where the integrated light amount ratio is 0.002 or more and 1.1 or less, the freshness keeping period magnification ratio is 1.5 or more. On the other hand, in both of the case where the spinach is used as the crop and the case where the lettuce is used as the crop, in comparison examples 39 to 42 where the integrated light amount ratio falls outside a range of from 0.002 or more and 1.1 or less, a freshness keeping period magnification ratio is approximately 1.3 or less. Accordingly, from a viewpoint of freshness keeping of the crop, it is preferable that an integrated light amount of the far-infrared light in a day be 0.002 times or more and 1.1 times or less as large as an integrated light amount of the green light component in a day.

### [About Influence of Total Integrated Light Amount]

Test conditions and freshness keeping period magnification ratios of examples 67 to 72 and comparison examples 43 and 44 where the test was performed by changing a total integrated light amount under the above-mentioned test condition are shown in Table 25. Here, a test where the spinach is used as the crop and a test where the lettuce is used as the crop respectively correspond to the above-mentioned comparison examples 29 and 32, and in both tests, the far-infrared light was not emitted to the crop. Accordingly, a freshness keeping period magnification ratio of the test where the spinach is used as the crop indicates how many times a time at which a moisture amount of the crop becomes 95% or less of an initial moisture amount of the crop is longer than the time of comparison example 29. Further, a freshness keeping period magnification ratio of the test result where the lettuce is used as the crop indicates how many times a time at which a moisture amount of the crop becomes 95% or less of an initial moisture amount of the crop is longer than the time of comparison example 32.

TABLE 25

| | | TOTAL | |
|---|---|---|---|
| | | INTEGRATED | FRESHNESS |
| | | LIGHT | KEEPING PERIOD |
| | | AMOUNT | MAGNIFICATION |
| | CROP | (kJ/m²) | RATIO |
| EXAMPLE 67 | SPINACH | 100 | 1.55 |
| EXAMPLE 68 | SPINACH | 1000 | 1.54 |
| EXAMPLE 69 | SPINACH | 1900 | 1.5 |
| EXAMPLE 70 | LETTUCE | 100 | 1.6 |
| EXAMPLE 71 | LETTUCE | 1000 | 1.55 |
| EXAMPLE 72 | LETTUCE | 1900 | 1.5 |
| COMPARISON | SPINACH | 1901 | 0.99 |
| EXAMPLE 43 | | | |
| COMPARISON | LETTUCE | 1901 | 0.95 |
| EXAMPLE 44 | | | |

As shown in Table 25, in both of the case where the spinach is used as the crop and the case where the lettuce is used as the crop, in examples 67 to 72 where the total integrated light amount is 1900 kJ/m² or less, the freshness keeping period magnification ratio is 1.5 or more. On the other hand, in both of the case where the spinach is used as the crop and the case where the lettuce is used as the crop, in comparison examples 43 and 44 where the total integrated light amount is 1900 kJ/m² or more, a freshness keeping period magnification ratio is 1 or less. Accordingly, it is preferable that a total integrated light amount of the far-infrared light and the green light component in a day be 1900 kJ/m² or less.

Although the content of the exemplary embodiments of the present disclosure is described with reference to examples, the present exemplary embodiments are not limited to the above-mentioned configurations, and it is apparent for those who are skilled in the art that various modifications and improvements are conceivable.

### Fifth Exemplary Embodiment

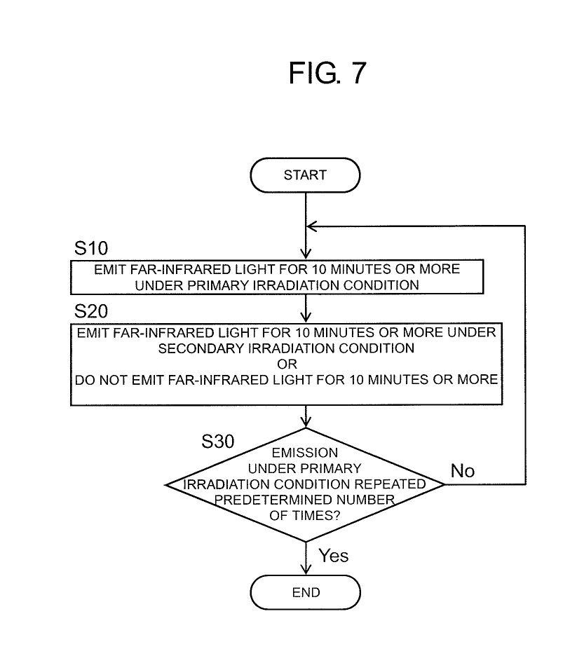

Hereinafter, the description is made with respect to freshness keeping device 10 and storage compartment 100 according to a fifth exemplary embodiment with reference to FIG. 1, FIG. 2, and FIG. 7. FIG. 1 is a schematic perspective view of an external appearance of storage compartment 100 according to the fifth exemplary embodiment. FIG. 2 is a block diagram showing one example of a functional constitution of freshness keeping device 10 which storage compartment 100 according to the fifth exemplary embodiment includes. FIG. 7 is a flowchart showing one example of an operation of the freshness keeping device which storage compartment 10 according to the fifth exemplary embodiment includes.

### [Configuration]

Storage compartment 100 shown in FIG. 1 is a storage compartment for storing (preserving) crops 30 after being accommodated and, for example, is installed on a backyard of a store which sells crops 30. Storage compartment 100 includes casing 20, door 22, and freshness keeping device 10.

Casing 20 is an approximately rectangular parallelepiped outer shape, and crops 30 are put into and taken out from storage part 21 (storing space) having a rectangular parallelepiped shape which forms an internal space of casing 20 from a front side. Casing 20 is made of metal such as aluminum, but may be made of a resin. A shape of casing 20, a material of casing 20 and the like are merely examples, and are not particularly limited.

Openable door 22 (cover) is disposed on a front side of storage part 21. When door 22 is closed and first light emitter 13 and second light emitter 14 are turned off, the inside of storage part 21 becomes a darkroom (an environment of 0 lux).

Freshness keeping device 10 is a device for keeping freshness of harvested crops 30. As shown in FIG. 1 and FIG. 2, freshness keeping device 10 includes power plug 11, controller 12, first light emitter 13, and second light emitter 14.

Power plug 11 is one example of a power receiving portion, and includes terminal portion 11a, and power converter 11b. Power plug 11 is a so-called AC adapter.

Terminal portion 11a is a metal-made terminal inserted into an electric outlet. A shape, a material, and the like of terminal portion 11a are not particularly limited.

Power converter 11b converts AC power which terminal portion 11a receives into DC power, and supplies DC power to controller 12, first light emitter 13, and second light emitter 14. Specifically, power converter 11b is an AC-DC converter circuit. In storage compartment 100, although power converter 11b is disposed outside casing 20, power conversion portion 11b may be incorporated in casing 20.

First light emitter 13 is an irradiation device which is disposed above storage part 21, and irradiates crops 30 stored in storage part 21 with irradiation light based on control by controller 12. Here, the irradiation light is light having a wavelength peak within a wavelength range from 700 nm to 1000 nm inclusive. As the irradiation light, for example, far-infrared light having a wavelength peak within a wavelength range from 700 nm and 800 nm inclusive can be used. As the irradiation light, light may be used where the light has a wavelength peak within a wavelength range from 700 nm to 1000 nm inclusive, and an emission spectrum of the light falls within a range from 400 nm to 1200 nm inclusive as a whole, for example.

For example, first light emitter 13 is configured as a light emitting module which includes a printed circuit board, and a plurality of far-infrared light LEDs mounted on the printed circuit board. However, first light emitter 13 may have any configuration provided that first light emitter 13 can irradiate light having a wavelength peak within a wavelength range from 700 nm to 1000 nm inclusive. For example, first light emitter 13 may be configured to irradiate light only within a wavelength range from 700 nm to 1000 nm inclusive by combining a light emitting element which emits light having a light emission peak also within a range other than the wavelength range from 700 nm and 1000 nm inclusive and a spectral filter together.

In FIG. 1, although a bulb-type first light emitter 13 is shown, such bulb-type first light emitter 13 is merely shown schematically, and a shape of first light emitter 13 is not limited to such a bulb-type light emitter. For example, first light emitter 13 may be configured to make surface emission using a light guide plate or the like. Alternatively, first light emitter 13 may have a shape of a pendant light or a shape of a down light.

Here, it is preferable that first light emitter 13 uniformly irradiate crops 30 with irradiation light. Since it is considerable that the irradiation light mainly influences keeping of freshness, by uniformly irradiating crop 30 with the irradiation light, it is possible to keep freshness of crop 30 efficiently. Examples of a method of uniformly irradiating crop 30 with the irradiation light include a method which uses a surface emission using a light guide plate, a milky white plate or the like, a method where light sources of first light emitter 13 are arranged in a matrix array, and the like. As the milky white plate, a plate, or the like, obtained by combining a reflection sheet, an acrylic plate, and a diffusion plate can be used.

Here, the irradiation light which first light emitter 13 emits (emission spectrum of irradiation light) typically has one peak. However, the irradiation light may have two or more peaks which differ from each other in wavelength. For example, in the fifth exemplary embodiment, first light emitter 13 emits far-infrared light having a peak wavelength of 720 nm, far-infrared light having a peak wavelength of 735 nm, or the like. However, first light emitter 13 may be configured to emit far-infrared light having peaks on both a wavelength 720 nm and a wavelength 735 nm. In this case, for example, first light emitter 13 can be configured such that an LED which emits far-infrared light having a peak wavelength of 720 nm and an LED which emits far-infrared light having a peak wavelength of 735 nm are mounted on a printed circuit board.

Second light emitter 14 is disposed above storage part 21, and irradiates crop 30 stored in storage part 21 with white light based on control by controller 12. As the white light, it is sufficient to use light which is visually recognized as the white light by human eyes, and for example, light where an entire emission spectrum is included in a wavelength range from 380 nm and 780 nm inclusive, light where an entire emission spectrum is included in a range from 350 nm and 800 nm inclusive, and the like may be used.

Second light emitter 14 is a light emitting module having the COB structure constituted of a printed circuit board, a plurality of blue LEDs directly mounted on the printed circuit board, and a sealing member containing yellow phosphor particles. The sealing member seals the blue LEDs. As the yellow phosphor particles, for example, an yttrium-aluminum-garnet (YAG)-based phosphor can be used. Second light emitter 14 may be an SMD type light emitting module or may be a remote-phosphor-type light emitting module.

Further, second light emitter 14 may be configured to emit white light by combining a blue LED, a green LED, and a red LED together. Alternatively, second light emitter 14 may be configured to emit white light by combining an ultraviolet light LED, a blue phosphor, a green phosphor, and a red phosphor together.

In FIG. 1, although bulb-type second light emitter 14 is shown, such bulb-type second light emitter 14 is merely shown schematically, and a shape of second light emitter 14 is not limited to such a bulb-type light emitter. For example, second light emitter 14 may be configured to make surface emission using a light guide plate or the like. Alternatively, second light emitter 14 may have a shape of a pendant light or a shape of a down light.

Here, first light emitter 13 and second light emitter 14 may be configured as one light emitter. For example, when such a light emitter is configured by the COB structure, the light emitter can be configured such that a far-infrared light LED and a blue LED mounted on a printed circuit board are sealed by a sealing member containing yellow phosphor particles. Alternatively, the light emitter may be configured by combining a far-infrared light LED, a blue LED, and a yellow LED or a green LED together.

Here, mounting positions of first light emitter 13 and second light emitter 14 are not limited to positions above storage part 21. For example, a configuration may be adopted where first light emitter 13 and second light emitter 14 are mounted on a side surface or a bottom surface of storage part 21. Further, first light emitter 13 may be mounted on a ceiling surface of storage part 21, and second light emitter 14 may be mounted on a side surface of storage part 21. Alternatively, first light emitter 13 and second light emitter 14 may be mounted at different positions such that first light emitter 13 is mounted on a side surface of storage part 21, and second light emitter 14 is mounted on a ceiling surface of storage part 21.

Controller 12 is one example of the control part, and is a controller which controls first light emitter 13 and second light emitter 14 based on an operation by a user. Controller 12 controls intensity of the irradiation light which first light emitter 13 emits, and an irradiation time of the irradiation light which first light emitter 13 emits. Controller 12 controls turning on and off of irradiation of light from first light emitter 13 and turning on and off of irradiation of light from second light emitter 14. Controller 12 may be configured to control intensity of white light which second light emitter 14 emits.

Specifically, controller 12 is constituted with a PWM control circuit (light control circuit) for controlling illuminance of first light emitter 13, a timer circuit which controls an irradiation time of first light emitter 13, and the like. Controller 12 may be constituted with a processor, a microcomputer, or the like. In storage compartment 100, although controller 12 is disposed outside casing 20, controller 12 may be partially or entirely incorporated in casing 20.

Although it is not always necessary for freshness keeping device 10 to include controller 12, it is preferable that freshness keeping device 10 include controller 12. Further, a controller for controlling intensity of the irradiation light and a controller for controlling an irradiation time of the irradiation light may be provided separately. Controller 12 may be integrally formed with first light emitter 13 and second light emitter 14. Specific configuration of controller 12 is not particularly limited, and a conventionally known controller may be used as controller 12, for example.

Storage compartment 100 may include a cooling device for cooling the inside of storage part 21. As a matter of course, the cooling device is not essential.

In a case where storage compartment 100 includes large storage part 21, storage compartment 100 may include a belt conveyor for moving crops 30. In this case, due to the movement of the belt conveyor, crops 30 which move to an area below first light emitter 13 are sequentially irradiated by irradiation light.

### [Operation of Freshness Keeping Device]

Next, freshness keeping operation (freshness keeping method) of freshness keeping device 10 is described with reference to a flowchart shown in FIG. 7.

In a state where harvested crop 30 is stored in storage part 21, second light emitter 14 irradiates crop 30 stored in storage part 21 with white light based on control by controller 12. In other words, controller 12 of freshness keeping device 10 allows second light emitter 14 to emit the white light.

When the freshness keeping operation is started, first, the white light is emitted from second light emitter 14. Next, first light emitter 13 irradiates crops 30 stored in storage part 21 with irradiation light for a predetermined time under a main irradiation condition based on control by controller 12 (step S10). The predetermined time during which irradiation light is emitted under the main irradiation condition is 10 minutes or more. The predetermined time is assumed as a primary irradiation period.

Subsequently, first light emitter 13 irradiates crops 30 stored in storage part 21 with irradiation light for a predetermined time under a secondary irradiation condition based on control by controller 12, in a state where second irradiation part 14 irradiates crops 30 with the white light (step S20). Alternatively, in step S20, first irradiation part 13 does not emit the irradiation light for a predetermined time. The predetermined time during which the irradiation light is emitted under the secondary irradiation condition or the predetermined time during which the irradiation light is not emitted is a time of 10 minutes or more. The predetermined time is assumed as the secondary irradiation period. The secondary irradiation period may be equal to or different from the primary irradiation period.

Freshness keeping device 10 repeats emission of the irradiation light under the primary irradiation condition plural times. After a lapse of the secondary irradiation period, when a number of times of emission of the irradiation light under the primary irradiation condition does not reach a predetermined number of times (No in step S30), first light emitter 13 irradiates crops 30 with the irradiation light again during the primary irradiation period under the primary irradiation condition (step S10).

On the other hand, after a lapse of the secondary irradiation period, when the number of times of emission of the irradiation light under the primary irradiation condition reaches the predetermined number of times (Yes in step S30), freshness keeping device 10 finishes the freshness keeping operation.

Here, the primary irradiation condition and the secondary irradiation condition mean the relationship where irradiation illuminance of the irradiation light under the secondary irradiation condition becomes 50% or less of irradiation illuminance of the irradiation light under the primary irradiation condition. During the secondary irradiation period, first light emitter 13 emits the irradiation light at the irradiation illuminance which is 50% or less of the irradiation illuminance of the irradiation light during the primary irradiation period; or does not emit the irradiation light.

The primary irradiation period is 0.16 hours or more and 12 hours or less. The secondary irradiation period is a time more than or equal to the primary irradiation period. Further, a number of times that the primary irradiation period is repeated in a day is 1 time or more and 72 times or less. That is, in a case where the primary irradiation period is X hours, the secondary irradiation period is Y hours, and the number of times that the primary irradiation period is repeated in a day is Z times, a relationship of 0.16≤X≤12, a relationship of X≤Y, and a relationship of 1≤Z≤72 are satisfied.

Here, the number of times of repetition is 1 time means that the primary irradiation period is only one time of first primary irradiation period. In the same manner, the number of times of repetition is 2 times means that the number of times of the primary irradiation period is 2 times, and the number of times of repetition is 3 times means that the number of times of the primary irradiation period is 3 times. That is, the number of times of repetition is n means that the number of times of the primary irradiation period is n times.

By irradiating crops 30 with the irradiation light under the above-mentioned condition, it is possible to keep freshness of crops 30 efficiently.

Here, from a viewpoint of freshness keeping of crops 30, it is preferable that the irradiation illuminance of the irradiation light emitted from first light emitter 13 during the primary irradiation period be set to 0.05 W/m² or more. Further, it is preferable that an integrated value of the irradiation time of the irradiation light in a day and the irradiation illuminance in a day be set to 90 J/m² or more.

Further, from a viewpoint of freshness keeping of crops 30, it is preferable that the secondary irradiation period be gradually shortened each time emission of the irradiation light is repeated. Further, it is preferable that the primary irradiation period be gradually prolonged each time emission of the irradiation light is repeated. Further, it is preferable that the irradiation illuminance of the irradiation light be gradually increased each time the primary irradiation period is repeated. Further, it is preferable that, during one time of primary irradiation period, the irradiation illuminance of the irradiation light be gradually increased.

As described above, by emitting the irradiation light while changing irradiation illuminance and an irradiation time, it is possible to keep freshness of crops 30 more effectively. As a reason for that, it is estimated that such an operation can suppress a phenomenon that crop 30 is adapted to stimulation of the irradiation light.

### [Effects and Other Benefits]

Here, essential points of freshness keeping device 10 and storage compartment 100 according to the fifth exemplary embodiment are described again. Further, the present disclosure also has an aspect of a freshness keeping method and hence, the freshness keeping method according to the exemplary embodiment is also described hereinafter.

The freshness keeping method according to the exemplary embodiment is a freshness keeping method which irradiates harvested crops 30 with irradiation light, wherein irradiation light having a peak within a wavelength range from 700 nm to 1000 nm inclusive is emitted under a condition that a white light is present. Further, the primary irradiation period of 10 minutes or more during which the irradiation light is irradiated, and the secondary irradiation period of 10 minutes or more during which the irradiation light is irradiated with irradiation illuminance which is 50% or less of average irradiation illuminance during the primary irradiation period immediately before the secondary irradiation period or during which the irradiation light is not irradiated are set. In a case where the primary irradiation period is X hours, the secondary irradiation period is Y hours, and the number of times that the primary irradiation period is repeated in a day is Z times, a relationship of 0.16≤X≤12, a relationship of X≤Y, and a relationship of 1≤Z≤72 are satisfied.

By using the freshness keeping method having the above-mentioned configuration, it is possible to keep freshness of harvested crops 30 properly, and visibility of crops 30 can be enhanced.

In the freshness keeping method according to the exemplary embodiment, it is preferable that the irradiation illuminance of the irradiation light in the primary irradiation period be 0.05 W/m² or more.

Due to the above-mentioned configuration, visibility of crops 30 can be particularly enhanced, and at the same time, it is possible to keep freshness of harvested crops 30 more efficiently.

Further, in the freshness keeping method according to the exemplary embodiment, it is preferable that the integrated value of the irradiation time of the irradiation light in a day and the irradiation illuminance in a day be set to 90 J/m² or more.

Due to the above-mentioned configuration, visibility of crops 30 can be particularly enhanced, and at the same time, it is possible to keep freshness of harvested crops 30 more efficiently.

Further, in the freshness keeping method according to the exemplary embodiment, it is preferable that the secondary irradiation period be gradually shortened each time emission of the irradiation light is repeated.

Due to the above-mentioned configuration, visibility of crops 30 can be particularly enhanced, and at the same time, it is possible to keep freshness of harvested crops 30 more efficiently.

Further, in the freshness keeping method according to the exemplary embodiment, it is preferable that the primary irradiation period be gradually prolonged each time emission of the irradiation light is repeated.

Due to the above-mentioned configuration, visibility of crops 30 can be particularly enhanced, and at the same time, it is possible to keep freshness of harvested crops 30 more efficiently.

Further, in the freshness keeping method according to the exemplary embodiment, it is preferable that the irradiation illuminance of the irradiation light be gradually increased each time emission of the irradiation light is repeated.

Due to the above-mentioned configuration, visibility of crops 30 can be particularly enhanced, and at the same time, it is possible to keep freshness of harvested crops 30 more efficiently.

Further, in the freshness keeping method according to the exemplary embodiment, it is preferable that, during one time of primary irradiation period, the irradiation illuminance of the irradiation light be gradually increased.

Due to the above-mentioned configuration, visibility of crops 30 can be particularly enhanced, and at the same time, it is possible to keep freshness of harvested crops 30 more efficiently.

Freshness keeping device 10 according to the fifth exemplary embodiment is a freshness keeping device which irradiates harvested crops 30 with irradiation light, wherein freshness keeping device 10 includes the first light source which emits the white light and the second light source which emits the irradiation light having a peak within a wavelength range from 700 nm to 1000 nm inclusive. Further, the primary irradiation period of 10 minutes or more during which the irradiation light is emitted, and the secondary irradiation period of 10 minutes or more during which the irradiation light is emitted with the irradiation illuminance which is 50% or less of average irradiation illuminance during the primary irradiation period immediately before the secondary irradiation period or during which the irradiation light is not emitted are set. In a case where the primary irradiation period is X hours, the secondary irradiation period is Y hours, and the number of times that the primary irradiation period is repeated in a day is Z times, a relationship of 0.16≤X≤12, a relationship of X≤Y, and a relationship of 1≤Z≤72 are satisfied.

By using freshness keeping device 10 having the above-mentioned configuration, it is possible to keep freshness of harvested crop 30 properly, and visibility of crop 30 can be enhanced.

In freshness keeping device 10 according to the fifth exemplary embodiment, it is preferable that the irradiation illuminance of the irradiation light in the primary irradiation period be 0.05 W/m² or more.

Due to the above-mentioned configuration, visibility of crops 30 can be particularly enhanced, and at the same time, it is possible to keep freshness of harvested crops 30 more efficiently.

Storage compartment 100 according to the fifth exemplary embodiment includes freshness keeping device 10, and casing 20 which accommodates crop 30.

By using storage compartment 100 having the above-mentioned configuration, it is possible to keep freshness of crop 30 properly while accommodating harvested crop 30, and visibility of crop 30 can be enhanced.

### Sixth Exemplary Embodiment

Hereinafter, with reference to FIGS. 3 to 6, sixth exemplary embodiment of the present disclosure is described. FIG. 3 is a schematic perspective view of an external appearance of showcase 200 according to the sixth exemplary embodiment. FIG. 4 is a schematic cross-sectional view of showcase 200 according to the sixth exemplary embodiment in a side view. FIG. 5 is a block diagram showing one example of a functional constitution of freshness keeping device 210 which showcase 200 according to the sixth exemplary embodiment includes. FIG. 6 is a schematic perspective view showing a configuration of one example of a light emitting module.

In the description made hereinafter, the description of a portion overlapping with the description of the fifth exemplary embodiment is omitted or simplified. Further, constitutional elements substantially equal to the corresponding constitutional elements of the fifth exemplary embodiment are described by giving the same symbols.

### [Configuration]

Showcase 200 is a showcase having a plurality of shelves 202 on which harvested crops 30 are displayed (placed), and for example, is installed in a salesroom of a store which sells crops 30. Showcase 200 includes body portion 201, shelves 202, base portion 203, and freshness keeping device 210.

Body portion 201 forms a space for accommodating crops 30. Body portion 201 is formed of side plates, a ceiling plate, a back plate, and frames for holding the side plates, the ceiling plate, and the back plate, and a front side of body portion 201 is opened. Specifically, body portion 201 is made of metal such as aluminum or iron, or a resin.

Shelves 202 are plate-like members for partitioning a space defined by body portion 201 in a vertical direction, and harvested crops 30 are displayed on upper surfaces of shelves 202. Body portion 201 may include three shelves 202, or may include not more than two or not less than four shelves 202. Specifically, shelves 202 are made of metal such as aluminum or iron, however, shelves 202 may be made of a resin.

Base portion 203 is a portion forming a base of showcase 200, and controller 212 which freshness keeping device 210 described later includes is mounted on base portion 203. Power converter 211b which freshness keeping device 210 includes is accommodated in the inside of base portion 203.

Freshness keeping device 210 includes power plug 211, power converter 211b, controller 212, and light emitter 213.

Power plug 211 as one example of a power receiving portion has a metal-made terminal which is inserted into an electric outlet, and receives AC power from the terminal.

Power converter 211b converts AC power which power plug 211 receives into DC power, and supplies DC power to controller 212 and light emitter 213. Specifically, power converter 211b is an AC-DC converter circuit. In showcase 200, power converter 211b is incorporated in base portion 203.

Controller 212 is one example of the control part, and controls light emitter 213 based on an operation by a user. Controller 212 is constituted with, for example, a timer circuit which controls intensity of far-infrared light which light emitter 213 emits, and an irradiation time of far-infrared light which light emitter 213 emits. Controller 212 may be constituted with a processor, a microcomputer, or the like.

Controller 212 controls turning on and off of irradiation of irradiation light from light emitter 213 and turning on and off of irradiation of white light from light emitter 213. Controller 212 may be configured to control intensity of the white light which light emitter 213 emits.

Light emitter 213 is disposed above each of shelves 202, and irradiates crops 30 displayed on shelves 202 with the irradiation light and the white light based on control by controller 212. In the sixth exemplary embodiment, the description is made by using light emitter 213 having substantially the same configuration as a light emitter obtained by integrally forming first light emitter 13 and second light emitter 14 of the fifth exemplary embodiment.

As shown in FIG. 4, light emitter 213 includes base 213e, light emitting module 213c which is a printed circuit board 213a on which LEDs 213b are mounted, and diffusion cover 213d.

Base 213e is a mounting base and a heat sink for mounting light emitting module 213c, and functions also as a member for mounting light emitter 213 on shelves 202. Base 213e is made of metal such as aluminum die-cast, for example.

Diffusion cover 213d diffuses light emitted from light emitting module 213c and allows the light to pass therethrough, and irradiates crops 30 with the light.

Light emitting module 213c is printed circuit board 213a on which LEDs 213b are mounted. Hereinafter, the structure of light emitting module 213c is described in detail with reference to FIG. 6.

As shown in FIG. 6, to be more specific, light emitting module 213c includes printed circuit board 213a, a plurality of LEDs 213b which are mounted on printed circuit board 213a in a row, wiring 223, connector 224, and connector 225.

Printed circuit board 213a is a printed circuit board having an elongated rectangular shape. Printed circuit board 213a is a CEM-3 printed circuit board using a resin as a base material. However, printed circuit board 213a may be other resin-made printed circuit board, and may be a metal-base printed circuit board or a ceramic printed circuit board. As another resin-made printed circuit board, an FR-4 printed circuit board is exemplified. As the ceramic printed circuit board, an alumina printed circuit board made of aluminum oxide (alumina), an aluminum nitride printed circuit board made of aluminum nitride and the like can be exemplified. As the metal base printed circuit board, an aluminum alloy printed circuit board, an iron alloy printed circuit board, a copper alloy printed circuit board, and the like can be exemplified.

LED 213b is one example of a light emitting element, and is a bare chip which emits mono-color visible light. As LEDs 213b, LEDs for emitting light having a peak within a wavelength range from 700 nm to 1000 nm inclusive, and LEDs for emitting white light are used. LEDs 213b are each mounted on printed circuit board 213a by die bonding using a die attach material (die bonding material), for example.

As the LEDs for irradiating a light having a peak within a wavelength range from 700 nm to 1000 nm inclusive, for example, a far-infrared light LED which emits far-infrared light can be used.

To emit white light, light emitter 213 is configured to include three kinds of LEDs, for example, a blue LED, a green LED, and a red LED, as LEDs 213b. Alternatively, light emitter 213 may be configured such that light emitter 213 includes the blue LED as LED 213b, and the blue LED and yellow phosphor particles are combined together for emitting the white light.

It is preferable that these LEDs 213b including the far-infrared light LEDs, the blue LEDs, and the green LEDs be disposed on printed circuit board 213a such that LEDs 213b of the same kind are not disposed adjacent to each other. With such a configuration, deviation in color depending on an emitted place of light can be reduced thus acquiring uniform light.

Wiring 223 is a metal wiring made of tungsten (W), copper (Cu), or the like. Wiring 223 is formed into a predetermined shape by patterning such that the plurality of LEDs 213b are electrically connected to each other, and at the same time, LEDs 213b, connector 224, and connector 225 are electrically connected to each other.

In FIG. 6, wiring 223 connects LEDs 213b arranged in a row in series. However, the configuration of wiring 223 is not limited to such a configuration. For example, wiring 223 may be configured such that LED element arrays each of which includes a predetermined number of LEDs 213b aligned in row are connected in parallel.

Further, with respect to wiring 223, it is preferable that the LED element arrays formed by connecting LEDs 213b of the same kind out of LEDs 213b including the far-infrared light LEDs, the blue LEDs, and the green LEDs in series are provided, and the LED element arrays be connected in parallel. With such a configuration, light emitting intensity of LEDs 213b of the respective kinds can be individually controlled, and from viewpoints of freshness keeping and visibility of crops 30, light emitted from LEDs 213b can be adjusted to be proper light.

Alternatively, wiring 223 may be configured to connect the LEDs which mainly contribute to freshness keeping of crops 30 and irradiate light having a peak within a wavelength range from 700 nm to 1000 nm inclusive and other kinds of LEDs in parallel. With such a configuration, intensity and an irradiation time of irradiation light which mainly contributes to freshness keeping of crops 30 can be adjusted so that it is possible to keep freshness of crops 30 more properly.

Connector 224 and connector 225 are connectors for supplying power to light emitting module 213c. DC power is supplied to connector 224 or connector 225 from controller 212. Due to the supply of DC power, light emitting module 213c emits light.

### [Effects and Other Benefits]

Here, essential points of showcase 200 according to the sixth exemplary embodiment are described again.

Showcase 200 according to the sixth exemplary embodiment includes freshness keeping device 210, and shelves 202 on which crops 30 are displayed.

By using showcase 200 having the above-mentioned configuration, it is possible to keep freshness of crops 30 properly in a state where harvested crops 30 are displayed on shelves 202, and visibility of crops 30 can be enhanced.

### Supplemental Description of Exemplary Embodiment

First, crops are supplementarily described. In the above-mentioned exemplary embodiment, “crops” means all crops capable of being harvested by an agricultural technique. Although crops are not particularly limited, crops include vegetables, fruits, and flowers and ornamental plants in the usually-performed classification corresponding to usage part (referred to as horticultural classification or artificial classification), for example.

Vegetables include fruits vegetables, leaves and stems, root vegetables, mushrooms, and the like.

Here, fruit vegetables include: grains such as corn; and beans such as azuki bean, common bean, pea, green soybean, cowpea, winged bean, broad bean, soybean, sword bean, peanut, lentil and sesame besides eggplant, pepino, tomato, mini tomato, tamarillo, gamblea innovans, hot pepper, sweet green pepper, Habanero chilli, green pepper, bell pepper, colored bell pepper, pumpkin, zucchini, cucumber, horned melon, melon cucumber, bitter melon, winter melon, chayote, luffa, bottle gourd, okra, garden strawberry, water melon, melon, and Korean melon.

Further, leaves and stems include: leaf vegetables such as ice plant, angelica keiskei, mustard greens, cabbage, watercress, kale, Japanese mustard spinach, salad lettuce, red leaf lettuce, Asiasari radix, Sang-chu lettuce, non-heading Chinese cabbage “santosai”, perilla, crown daisy, water shield, water shield, water dropwort, celery, tatsoi, Japanese radish leaf, leaf mustard, lettuce, Green bok choy, Brassica campestris, rape blossoms, Nozawana, heading Chinese cabbage, parsley, spinach mustard, Swiss chard, spinach, Lamium amplexicaule, leaf green “mizuna”, greater chickweed, common chickweed, giant chickweed, leaf green “mibuna”, Japanese hornwort, Brussels sprouts, Nalta jute, green leaf lettuce, rocket salad, lettuce, wasabi greens; stem vegetables such as Welsh onion, green onion, chive, Chinese chive, asparagus, Japanese spikenard, kohlrabi, zha cai, bamboo shoot, garlic, water convolvulus, green onion “wakegi”, onion; flower vegetables such as globe artichoke, broccoli, cauliflower, chrysanthemum, Brassica flower, butterbur scape, Japanese ginger; and sprout vegetables such as sprout, bean sprout, and radish sprout.

Further, root vegetables include potatoes such as sweet potato, taro, potato, Chinese yam, Japanese yam, in addition to turnip, Japanese radish, Western little radish, wasabi, horseradish, edible burdock, Chinese artichoke, ginger, carrot, Japanese scallion, and lotus root.

Further, mushrooms include: winter mushroom, king oyster mushroom,

Jew's ear, Dictyophora indusiata, “shiitake” mushroom, “shimeji” mushroom, white jelly fungus, golden oyster mushroom, Lactarius volemus, Pholiota microspora, Armillaria mellea, Lyophyllum decastes, oyster mushroom, beech mushroom, bunapi, porcini, Lyophyllum shimeji, Tricholoma flavovirens, Grifola frondosa, Agaricus campestris, Tricholoma matsutake, bearded tooth mushroom, Rhizopogon, truffle, and the like.

Further, fruits include: various kinds of citrus fruits including orange, apple, peach, sand pear, European pear, banana, grape, cherry, oleaster, blueberry, raspberry, black berry, mulberry, loquat, fig, Japanese persimmon, akebi, mango, avocado, jujube, pomgranate, passion fruit, pineapple, papaya, apricot, Prunus mume, plum, kiwifruit, Chinese quince, myrica, chestnut, miracle fruit, guava, star fruit, acerola, and the like.

Further, as flowers, for example, hollyhock, bouvardia, godetia, evening primrose, garden stock, Brassica oleracea, lunaria, acidanthera, iris, gladiolus, California poppy, peperomia, calceolaria, snapdragon, torenia, primrose, cyclamen, Lampranthus spectabilis, anthurium, calla lily, caladium, calamus, symgonium, peace lily, dieffenbachia, philodendron, cactuses, Ajuga, false dragonhead, scarlet sage, begonia, curcuma, water lily, portulaca, violet, Queen Anne's lace, Setcreasea, boatlily, spiderwort, Impatiens balsamina, Solanum mammosum, petunia, Japanese lantern plant, carnation, pink, China pink, gypsophila, Gypsophila paniculata, catchfly, Guzmania, bird of paradise flower, moss pink, phlox, garden phlox, Filipendula purpurea, Amacrinum, amaryllis, chrysanthemum, marguerite, Kaffir lily, Ifafa lily, narcissus, snowflake, Zephyranthes candida, nerine, crinum, Amazon lily, licorice, agave, cockscomb, globe amaranth, morning glory, Evolvulus, cleome, geranium, kalanchoe, pincushion flower, sweet pea, lupine, Lurigio, forget-me-not, astilbe, saxifrage, agapanthus, Solomon's seal, aloe, star-of-Bethlehem, Japanese rhodea, Chlorophytum comosum, plantain lily, Fritillaria camtschatcensis, gloriosa, colchicum, sansevieria, Sandersonia, Ophiopogon japonicus, tulip, society garlic, lily of the valley, dracaena, triteleia, Polygonatum falcatum, New Zealand flax, fritillary, hyacinth, Japanese toad lily, Hemerocallis fulva ‘kwanso’, liriope, lily, alstroemeria, Ruscus, Large-flowered Cypripedium, Calanthe, oncidium, cattleya, Colmanara, urn orchid, cymbidium, coelogyne, dendrobium, Doritaenopsis, Phalaenopsis japonica, Paphiopedilum, vanda, birusutekera, Phalaenopsis, braunau, miltonia, Exacum, Texas bluebell, Japanese gentian, lantana, rose, cherry tree, African daisy, and the like can be named, and further, Japanese cleyera, cycad, fern, dracaena, aspidistra, Monstera, pothos, Compacta, Polyscias, anthurium crassinervium, Stemona japonica, Indian basket grass, Pittosporum, and the like for appreciating leaves are included.

Although some crops are exemplified heretofore, the freshness keeping method according to the above-mentioned exemplary embodiments is also applicable to crops other than the exemplified crops.

Next, the description is made supplementarily with respect to freshness keeping. In the above-mentioned exemplary embodiments, “freshness keeping” means to keep freshness of crops as long as possible. Freshness keeping effect necessary for a crop differs depending on a kind, a merchandise value, and the like of the crop.

For example, with respect to. vegetables (leaf vegetables) where a leaf part or a stem part is mainly utilized such as lettuce and spinach, prevention of wilting (suppression of lowering of a moisture retention rate), prevention of discoloration (yellowing, browning, and the like), prevention of softening, prevention of generation of mold, and the like are important. Further, with respect to vegetables (fruit vegetables) where a pulp is mainly utilized such as strawberries and tomatoes or fruit trees such as apples, prevention of discoloration (yellowing, browning, and the like), prevention of softening, prevention of generation of mold, and the like are important. Further, with respect to flowers and ornamental plants, prevention of wilting (suppression of lowering of a moisture retention rate), prevention of discoloration (yellowing, browning, and the like), prevention of generation of mold, and the like are important.

Next, a situation where the freshness keeping method of the above-mentioned exemplary embodiments is utilized is described supplementarily. In the above-mentioned exemplary embodiments, in a case where crops on a backyard of a store is preserved or in a case where crops are displayed in a salesroom of the store, the freshness keeping method is utilized. However, the freshness keeping method may be utilized in other cases.

Harvested crops are transported to the city by a refrigerator truck through a farm, an agricultural cooperative, a dedicated facility where precooling of crops is performed, for example. Further, harvested crops are bought by the supplier in the market, are then preserved in the backyard of the supermarket and the like, and are displayed in the salesroom.

In the above-mentioned path, the freshness keeping method can be utilized in the dedicated facility, the refrigerator truck, the backyard and the saleroom of the supermarket and the like, and other places.

Further, harvested crops are transported to a second home delivery business office by a deliver car through the farm and a first home delivery business office, for example. Thereafter, there may be a case where harvested crops are transported to the purchaser (personal house) by a delivery car.

In the above-mentioned path, the freshness keeping method can be utilized in the first home delivery business office, the delivery car, the refrigerator truck, the second home delivery business office, and the like.

Further, for example, the freshness keeping method of the above-mentioned exemplary embodiments may be utilized for crops before harvested other than in harvested crops.

Further, irradiation light having a peak within a wavelength range from 700 nm to 1000 nm inclusive passes through a general material (for example, polyethylene) which is used as a storage container of crops. Accordingly, the freshness keeping method of the above-mentioned exemplary embodiments can be used for both crops in a usual boxed state and crops in a packed state.

Further, there exists a possibility that the irradiation light having a peak within a wavelength range from 700 nm to 1000 nm inclusive passes through the crops, and hence, the freshness keeping method of the above-mentioned exemplary embodiments can be utilized for crops overlapped on other crops.

The freshness keeping method of the above-mentioned exemplary embodiments may be utilized in a dark environment (darkness environment) or may be utilized under an environment which is artificially irradiated by white LEDs and the like. The freshness keeping method of the above-mentioned exemplary embodiments may be utilized under a sunlight environment.

Further, crops after being irradiated by the irradiation light having a peak within a wavelength range from 700 nm to 1000 nm inclusive may be preserved under a completely dark environment (darkness environment), may be preserved under an environment which is artificially irradiated by white LEDs and the like, and may be preserved under a sunlight environment.

### Other Exemplary Embodiments

The freshness keeping method, the freshness keeping device, the storage compartment, and the showcase according to the present disclosure have been described with reference to the fifth and sixth exemplary embodiments heretofore. However, the present disclosure is not limited to the freshness keeping method, the freshness keeping device, the storage compartment, and the showcase according to the fifth and sixth exemplary embodiments.

For example, in the fifth and sixth exemplary embodiments, the description is made with respect to a case where the LEDs are used as the light source. However, the light emitting element is not limited only to the LED. Examples of the light source include a fluorescent tube, a metal hydride lamp, a sodium lamp, a halogen lamp, a xenon lamp, a neon tube, an inorganic electroluminescence, an organic electroluminescence, a chemiluminescence (chemical light emitting), and a laser.

In a case where, as the light source, a light source which can emit light also in a wavelength range other than the necessary wavelength range such as a fluorescent tube is used, the light source can be utilized as light having only the necessary wavelength range by combining the light source with a spectrum filter and the like.

An irradiation mode of the irradiation light is not particularly limited. For example, irradiation light may be emitted instantaneously with an extremely large light amount such as stroboscopic light emission.

Further, the freshness keeping device, the storage compartment, and the showcase according to the present disclosure may include an illuminance sensor. By using the irradiation sensor, the freshness keeping device, the storage compartment, and the showcase according to the present disclosure can adjust irradiation illuminance of the irradiation light and the white light corresponding to the surrounding environment and the like.

In the above-mentioned exemplary embodiments, all of or a part of the respective constitutional elements (for example, controller) may be constituted with dedicated hardware, or may be implemented by executing a software program suitable for the respective constitutional elements. The respective constitutional elements may be implemented such that a program executing part such as a CPU or a processor reads out a software program stored in a storage medium such as a hard disc or a semiconductor memory and executes the software program.

The exemplary embodiments described above are given simply for the purpose of illustration of the exemplary embodiments of the present disclosure, and numeric values, raw materials, shapes, constituent elements, operations, and the like are also given only for illustrating preferable modes. Therefore, the present disclosure is not limited only to these exemplary embodiments. Further, out of the constitutional elements in the above-mentioned exemplary embodiments, the constitutional elements which are not described in independent claims describing an uppermost concept are described as arbitrary constitutional elements. The configuration may be modified as appropriate without departing from a range of a technical thought of the present disclosure.

### EXAMPLES

Hereinafter, the present exemplary embodiment is described in more detail with reference to examples and comparison examples.

In the description made hereinafter, “irradiation illuminance” means irradiation illuminance of irradiation light having a peak within a wavelength range from 700 nm to 1000 nm inclusive, and when simply referred to as “irradiation illuminance”, this expression means irradiation illuminance of irradiation light during the primary irradiation period. The unit of the irradiation illuminance is W/m².

Further, an “integrated light amount” means an integrated light amount of the irradiation light having a peak within a wavelength range from 700 nm to 1000 nm inclusive in a day. The unit of the integrated light amount is J/m². The integrated light amount can be obtained by a product of an irradiation time of the irradiation light in a day and the irradiation illuminance of the irradiation light in a day.

Further, an “irradiation illuminance rate” is a value indicating a rate of the irradiation illuminance of the irradiation light having a peak within a wavelength range from 700 nm to 1000 nm inclusive during the secondary irradiation period with respect to the irradiation illuminance of the irradiation light during the primary irradiation period, by percentage.

Further, “the number of times of irradiation” means the number of times of the primary irradiation period during which irradiation light having a peak within a wavelength range from 700 nm to 1000 nm inclusive is emitted.

Further, a “freshness keeping period magnification ratio” is a numerical value which indicates how many times a period where a moisture amount of a crop is maintained at 95% or more of an initial moisture amount of the crop is longer than a period where a moisture amount of a crop is maintained at 95% or more of an initial moisture amount of the crop in a case where the irradiation light is not emitted. Here, a moisture amount of a crop is calculated while assuming a change amount of the crop from an initial value of a weight of the crop as a weight of moisture evaporated from the crop.

The following results are results showing an average of similar tests using five samples.

### (Test 1)

The freshness keeping test was performed such that a bundle of spinach which is a vegetable belonging to leaves and stems is put into an acrylic container having a rectangular parallelepiped shape of 280 mm×600 mm×220 mm. The tests were performed under a condition that a temperature during the tests is set to 5° C., and humidity is set to 80% to 85%.

As a light source of the irradiation light having a peak within wavelength range from 700 nm to 1000 nm inclusive, a far-infrared light LED having a peak at a wavelength of 735 nm was disposed on the ceiling surface of the above-mentioned acrylic container. Further, as a light source of the white light, a white LED having a color temperature of 4000 K was disposed on the ceiling surface of the above-mentioned acrylic container, and during the tests, emission of light from the white LED was constantly performed with illuminance of 2500 lx. The spinach was disposed at a position 200 mm away from the light source disposed on the ceiling surface, and the light source irradiated the sample with light for 72 hours.

### [About Influence of Irradiation Time and Number of Times of Irradiation]

Tests were performed under the above-mentioned condition. In the tests, the irradiation illuminance of the irradiation light was set to 1.0 W/m², and the primary irradiation period, the secondary irradiation period, and a number of times of irradiation were changed in accordance with the conditions of examples 1 to 6 and comparison examples 1 to 6. Here, during the secondary irradiation period, the irradiation light was not emitted. Test conditions and freshness keeping period magnification ratios of examples 1 to 6 and comparison examples 1 to 6 are shown in Table 26. Here, comparison example 1 is a test example where the irradiation light was not emitted. Accordingly, the freshness keeping period magnification ratio indicates how many times a time at which a moisture amount of the crop becomes 95% or less of an initial moisture amount of the crop is longer than the time of comparison example 1.

TABLE 26

| | | | NUMBER OF | FRESHNESS |
|---|---|---|---|---|
| | PRIMARY | SECONDARY | TIMES OF | KEEPING PERIOD |
| | IRRADIATION | IRRADIATION | IRRADIATION | MAGNIFICATION |
| | PERIOD (h) | PERIOD (h) | (times) | RATIO |
| EXAMPLE 1 | 0.16 | 7 | 3 | 1.5 |
| EXAMPLE 2 | 0.5 | 7 | 3 | 1.8 |
| EXAMPLE 3 | 1 | 7 | 3 | 1.9 |
| EXAMPLE 4 | 0.5 | 0.5 | 10 | 1.52 |
| EXAMPLE 5 | 0.16 | 0.16 | 72 | 1.5 |
| EXAMPLE 6 | 12 | 12 | 1 | 1.5 |
| COMPARISON | 0 | 72 | 0 | 1 |
| EXAMPLE 1 | | | | |
| COMPARISON | 0.1 | 7 | 3 | 0.94 |
| EXAMPLE 2 | | | | |
| COMPARISON | 1 | 0.1 | 3 | 0.88 |
| EXAMPLE 3 | | | | |
| COMPARISON | 72 | 0 | 1 | 1.3 |
| EXAMPLE 4 | | | | |
| COMPARISON | 13 | 13 | 1 | 1.4 |
| EXAMPLE 5 | | | | |
| COMPARISON | 1 | 0.8 | 12 | 1.4 |
| EXAMPLE 6 | | | | |

As shown in Table 26, in examples 1 to 6 where the primary irradiation time is 0.16 hours or more and 12 hours or less, the secondary irradiation period is longer than the primary irradiation period, and a number of times of repetition of the primary irradiation period in a day is once or more to 72 times or less, freshness keeping period magnification ratios take values of 1.5 or more. On the other hand, in comparison examples 2 to 6 where the above-mentioned conditions are not satisfied, freshness keeping period magnification ratios take values of 1.4 or less.

For example, in comparison example 2 where the main irradiation time is less than 0.16 hours, the freshness keeping period magnification ratio is 0.94. Further, in comparison examples 4 and 5 where the main irradiation time is longer than 12 hours, the freshness keeping period magnification ratios are 1.3 and 1.4 respectively. Further, in comparison examples 3 and 6 where the sub irradiation time is longer than the main irradiation time, the freshness keeping period magnification ratios are 0.88 and 1.4 respectively.

That is, assuming that the primary irradiation period is X hours, the secondary irradiation period is Y hours, and the number of times that the primary irradiation period is repeated in a day is Z times, when a relationship of 0.16≤X≤12, a relationship of X≤Y, and a relationship of 1≤Z≤72 are satisfied, it is possible to keep freshness of crops effectively.

### [About Influence of Irradiation Illuminance]

Tests were performed under the above-mentioned test conditions, and in the tests, the irradiation illuminance of the irradiation light is changed in accordance with conditions of examples 7 to 12 and comparison examples 7 and 8. Here, during the secondary irradiation period, the irradiation light was not emitted. Test conditions and freshness keeping period magnification ratios of examples 7 to 12 and comparison examples 7 and 8 are shown in Table 27. Here, comparison example 1 described above is a test example where the irradiation light was not emitted. Accordingly, the freshness keeping period magnification ratio indicates how many times a time at which a moisture amount of the crop becomes 95% or less of an initial moisture amount of the crop is longer than the time of comparison example 1.

TABLE 27

| | | | | | FRESHNESS |
|---|---|---|---|---|---|
| | | | NUMBER OF | | KEEPING |
| | PRIMARY | SECONDARY | TIMES OF | IRRADIATION | PERIOD |
| | IRRADIATION | IRRADIATION | IRRADIATION | ILLUMINANCE | MAGNIFICATION |
| | PERIOD (h) | PERIOD (h) | (times) | (W/m²) | RATIO |
| EXAMPLE 7 | 1 | 7 | 3 | 0.05 | 1.33 |
| EXAMPLE 8 | 1 | 7 | 3 | 1 | 1.9 |
| EXAMPLE 9 | 1 | 7 | 3 | 5 | 1.55 |
| EXAMPLE 10 | 2 | 4 | 4 | 0.05 | 1.36 |
| EXAMPLE 11 | 2 | 4 | 4 | 1 | 1.82 |
| EXAMPLE 12 | 2 | 4 | 4 | 5 | 1.72 |
| COMPARISON | 1 | 7 | 3 | 0.04 | 0.99 |
| EXAMPLE 7 | | | | | |
| COMPARISON | 2 | 4 | 4 | 0.04 | 1.02 |
| EXAMPLE 8 | | | | | |

As shown in Table 27, in examples 7 to 12 where conditions that are X=1, Y=7, and Z=3 are satisfied or conditions that are X=2, Y=4, and Z=4 are satisfied, and the irradiation illuminance is 0.05 W/m² or more, the freshness keeping period magnification ratios are 1.3 or more. On the other hand, in comparison examples 7 and 8 where the irradiation illuminance is 0.04 W/m², the freshness keeping period magnification ratios are 0.99 and 1.02 respectively. The freshness keeping periods of comparison examples 7 and 8 are substantially equal to the freshness keeping period in a case where the irradiation light is not emitted. That is, from a viewpoint of freshness keeping, it is preferable that the irradiation illuminance of the irradiation light in the primary irradiation period be 0.05 W/m² or more.

### [About Influence of Integrated Light Amount]

Tests were performed under the above-mentioned test conditions, and in the tests, an integrated light amount is changed in accordance with conditions of examples 13 to 15 and comparison example 9. Here, during the secondary irradiation period, the irradiation light was not emitted. Test conditions and freshness keeping period magnification ratios of examples 13 to 15 and comparison example 9 are shown in Table 28. Here, comparison example 1 described above is a test example where the irradiation light was not emitted. Accordingly, the freshness keeping period magnification ratio indicates how many times a time at which a moisture amount of the crop becomes 95% or less of an initial moisture amount of the crop is longer than the time of comparison example 1.

TABLE 28

| | | | | | | FRESHNESS |
|---|---|---|---|---|---|---|
| | | | NUMBER OF | | INTEGRATED | KEEPING |
| | PRIMARY | SECONDARY | TIMES OF | IRRADIATION | LIGHT | PERIOD |
| | IRRADIATION | IRRADIATION | IRRADIATION | ILLUMINANCE | AMOUNT | MAGNIFICATION |
| | PERIOD (h) | PERIOD (h) | (times) | (W/m²) | (J/m²) | RATIO |
| EXAMPLE 13 | 0.5 | 11.5 | 1 | 0.05 | 90 | 1.4 |
| EXAMPLE 14 | 2 | 6 | 3 | 0.1 | 2160 | 1.76 |
| EXAMPLE 15 | 1 | 7 | 3 | 1 | 10800 | 1.82 |
| COMPARISON | 0.49 | 11.5 | 1 | 0.05 | 88 | 1.09 |
| EXAMPLE 9 | | | | | | |

As shown in Table 28, in examples 13 to 15 where an integrated amount is 90 J/m² or more, freshness keeping period magnification ratios are 1.4 or more. On the other hand, in comparison example 9 where an integrated light amount is 88 J/m² or more, the freshness keeping period magnification ratio is 1.09. The freshness keeping period of comparison example 9 is substantially equal to the freshness keeping period in a case where the irradiation light is not emitted. That is, from a viewpoint of freshness keeping, it is preferable that an integrated light amount that is an integrated value of the irradiation time of the irradiation light in a day and the irradiation illuminance of the irradiation light in a day be set to 90 J/m² or more.

### [About Influence of Irradiation Illuminance Rate]

Tests were performed under the above-mentioned condition, and in the tests, a condition is adopted where the primary irradiation time is set to 1 hour, the secondary irradiation time is set to 7 hours, and the number of times of irradiation is set to three times, and the irradiation illuminance rate is changed in accordance with conditions of examples 16 to 18 and comparison examples 10 and 11. Test conditions and freshness keeping period magnification ratios of examples 16 to 18 and comparison examples 10 and 11 are shown in Table 29. Here, comparison example 1 described above is a test example where the irradiation light was not emitted. Accordingly, the freshness keeping period magnification ratio indicates how many times a time at which a moisture amount of the crop becomes 95% or less of an initial moisture amount of the crop is longer than the time of comparison example 1.

TABLE 29

| | | FRESHNESS |
|---|---|---|
| | IRRADIATION | KEEPING PERIOD |
| | ILLUMINANCE | MAGNIFICATION |
| | RATE (%) | RATIO |
| EXAMPLE 16 | 50 | 1.52 |
| EXAMPLE 17 | 20 | 1.8 |
| EXAMPLE 18 | 0 | 1.9 |
| COMPARISON | 80 | 1.34 |
| EXAMPLE 10 | | |
| COMPARISON | 60 | 1.32 |
| EXAMPLE 11 | | |

As shown in Table 29, in examples 16 to 18 where the irradiation illuminance rate is 50% or less, freshness keeping period magnification ratios are 1.5 or more. On the other hand, in comparison examples 10 and 11 where the irradiation illuminance rate is more than 50%, the freshness keeping period magnification ratios are approximately 1.3. That is, from a viewpoint of freshness keeping, during the secondary irradiation period, it is preferable that irradiation light be emitted at the irradiation illuminance which is 50% or less of the average irradiation illuminance during the primary irradiation period immediately before the secondary irradiation period, or the irradiation light be not emitted.

### (Test 2)

The freshness keeping test was performed such that a bundle of spinach which is a vegetable belonging to leaves and stems, a piece of lettuce which is a vegetable belonging to leaves and stems, one peach belonging to fruits, or one strawberry belonging to fruit vegetables is put into an acrylic container having a rectangular parallelepiped shape of 280 mm×600 mm×220 mm. The tests were performed under a condition that a temperature during the tests is set to 10° C., and humidity is set to 80% to 85%.

As a light source of the irradiation light having a peak within wavelength range from 700 nm to 1000 nm inclusive, a far-infrared light LED having a peak at a wavelength of 735 nm was disposed on the ceiling surface of the above-mentioned acrylic container. Further, as a light source of the white light, a white LED having a color temperature of 4000 K was disposed on the ceiling surface of the above-mentioned acrylic container, and during the tests, emission of light from the white LED was constantly performed with illuminance of 2500 lx. The spinach was disposed at a position 200 mm away from the light sources disposed on the ceiling surface.

Emission of light to the sample was performed for 72 hours with respect to the spinach and the lettuce, and the emission of light to the sample is performed for 240 hours with respect to the peach and the strawberry. Further, in test 2, during the secondary irradiation period, the irradiation light was not emitted.

Here, the freshness keeping period means a period during which a moisture amount of a crop is maintained at 95% or more of an initial moisture amount of the crop, and the unit of the freshness keeping period is a day. In the case of the spinach and lettuce, the freshness keeping period magnification ratio indicates how many times the freshness keeping period under each condition is longer than the freshness keeping period of a sample to which the irradiation light is not emitted and only the white light is continuously emitted for 72 hours. In the case of the peach and strawberry, the freshness keeping period magnification ratio indicates how many times the freshness keeping period under each condition is longer than the freshness keeping period of a sample to which the irradiation light is not emitted and only the white light is continuously emitted for 240 hours.

The freshness keeping period of the sample where the irradiation light was not emitted to the spinach and only the white light was continuously emitted to the spinach for 72 hours was 1.3 hours. Further, the freshness keeping period of the sample where the irradiation light was not emitted to the lettuce and only the white light was continuously emitted to the lettuce for 72 hours was 1.5 hours. Further, the freshness keeping period of the sample where the irradiation light was not emitted to the peach and only the white light was continuously emitted to the peach for 240 hours was 5.5 days. Further, the freshness keeping period of the sample where the irradiation light was not emitted to the strawberry and only the white light was continuously emitted to the strawberry for 240 hours was 6.2 days.

The freshness keeping periods and freshness keeping period magnification ratios of examples 19 to 50 and comparison examples 12 to 15 described hereinafter are shown in Table 30.

### Examples 19 to 22

In examples 19 and 21, the spinach was used as a sample, and in examples 20 and 22, the lettuce was used as a sample. The primary irradiation period was fixed to 3 hours, and the primary irradiation period was repeated 5 times while decreasing the secondary irradiation period in a stepwise manner from 18 hours so as to be 14 hours, 10 hours, 9 hours, . . . each time the primary irradiation period is repeated. In examples 19 and 20, the irradiation illuminance of the irradiation light during the primary irradiation period was 1 W/m², and in examples 21 and 22, the irradiation illuminance of the irradiation light during the primary irradiation period was 3 W/m².

### Examples 23 to 26

In examples23 and 25, the peach was used as a sample, and in examples 24 and 26, the strawberry was used as a sample. The primary irradiation period was fixed to 3 hours, and the primary irradiation period was repeated 15 times while the secondary irradiation period was shortened by 1 hour in a stepwise manner, that is, 20 hours, 19 hours, 18 hours, . . . each time the primary irradiation period was repeated. In examples 23 and 24, the irradiation illuminance of the irradiation light during the primary irradiation period was 1 W/m², and in examples 25 and 26, the irradiation illuminance of the irradiation light during the primary irradiation period was 3 W/m².

### Examples 27 to 30

In examples 27 and 29, the spinach was used as a sample, and in examples 28 and 30, the lettuce was used as a sample. The primary irradiation period was prolonged by 1.5 hours in a stepwise manner from 1.5 hours so as to be 1.5 hours, 3 hours, 4.5 hours, . . . each time the primary irradiation period is repeated, the secondary irradiation time was fixed to 10.5 hours, and the primary irradiation period was repeated 5 times. In examples 27 and 28, the irradiation illuminance of the irradiation light during the primary irradiation period was 1 W/m², and in examples 29 and 30, the irradiation illuminance of the irradiation light during the primary irradiation period was 3 W/m².

### Examples 31 to 34

In examples 31 and 33, the peach was used as a sample, and in examples 32 and 34, the strawberry was used as a sample. The primary irradiation period was prolonged by 1 hour, that is, 1 hour, 2 hours, 3 hours . . . each time the primary irradiation period was repeated, the secondary irradiation period was fixed to 12 hours, and the primary irradiation period was repeated 15 times. In examples 31 and 32, the irradiation illuminance of the irradiation light during the primary irradiation period was 1 W/m², and in examples 33 and 34, the irradiation illuminance of the irradiation light during the primary irradiation period was 3 W/m².

### Examples 35 and 36

In example 35, the spinach was used as a sample, and in example 36, the lettuce was used as a sample. The primary irradiation period was fixed to 4.5 hours, the secondary irradiation period was fixed to 10.5 hours, and the primary irradiation period was repeated 5 times. The irradiation illuminance of the irradiation light during the primary irradiation period was increased by 2 W/m² from 1 W/m² so as to be 3 W/m², 5 W/m², . . . each time the primary irradiation period was repeated.

### Examples 37 and 38

In example 37, the spinach was used as a sample, and in example 38, the lettuce was used as a sample. The primary irradiation period and the secondary irradiation period were respectively prolonged by 2.25 hours in a stepwise manner, that is, 2.25 hours, 4.5 hours, 6.75 hours, . . . each time the primary irradiation period was repeated, and the primary irradiation period was repeated 5 times. The irradiation illuminance of the irradiation light during the primary irradiation period was increased by 1 W/m², that is, 1 W/m², 2 W/m², 3 W/m², . . . each time the primary irradiation period was repeated.

### Examples 39 and 40

In example 39, the peach was used as a sample, and in example 40, the strawberry was used as a sample. The primary irradiation period was fixed to 1 hour, the secondary irradiation period was fixed to 7 hours, and the primary irradiation period was repeated 30 times. The irradiation illuminance of the irradiation light during the primary irradiation period was increased by 0.2 W/m², that is, 0.1 W/m², 0.3 W/m², 0.5 W/m², . . . each time the primary irradiation period was repeated.

### Examples 41 and 42

In example 41, the peach was used as a sample, and in example 42, the strawberry was used as a sample. The primary irradiation period is fixed to 1 hour, the secondary irradiation period is fixed to 7 hours, and the primary irradiation period is repeated 30 times. The irradiation illuminance of the irradiation light during the primary irradiation period was increased doubly so as to be 0.1 W/m², 0.2 W/m², 0.4 W/m², . . . each time the primary irradiation period was repeated 4 times.

### Examples 43 and 44

In example 43, the spinach was used as a sample, and in example 44, the lettuce was used as a sample. The primary irradiation period was fixed to 3 hours, the secondary irradiation period was fixed to 10.5 hours, and the primary irradiation period was repeated 5 times. The irradiation illuminance of the irradiation light immediately after starting of the primary irradiation period was increased by 0.5 W/m², that is, 0.5 W/m², 1 W/m², 1.5 W/m², . . . each time the primary irradiation period was repeated. Further, also during one main irradiation period, the irradiation illuminance of the irradiation light was linearly increased by 0.5 W/m² from 0.5 W/m² to 1W/m2 or from 1 W/m² to 1.5 W/m², for example.

### Examples 45 and 46

In example 45, the spinach was used as a sample, and in example 46, the lettuce was used as a sample. The primary irradiation period was fixed to 6 hours, the secondary irradiation period was fixed to 10.5 hours, and the primary irradiation period was repeated 5 times. The irradiation illuminance of the irradiation light immediately after starting of the primary irradiation period was increased by 0.5 W/m², that is, 1 W/m², 1.5 W/m², 2 W/m², . . . each time the primary irradiation period was repeated. Further, also during one primary irradiation period, the irradiation illuminance of the irradiation light immediately after starting of the primary irradiation period was maintained during 3 hours that is the first half of 6 hours, and then, during 3 hours that is the latter half of 6 hours, the irradiation illuminance was linearly increased by 0.5 W/m² from 1 W/m² to 1.5 W/m² or from 1.5 W/m² to 2 W/m², for example.

### Examples 47 and 48

In example 47, the peach was used as a sample, and in example 48, the strawberry was used as a sample. The primary irradiation period was fixed to 5 hours, the secondary irradiation period was fixed to 24 hours, and the primary irradiation period was repeated 9 times. The irradiation illuminance of the irradiation light immediately after starting of the primary irradiation period is increased by 0.5W/m², that is, 0.5 W/m², 1 W/m², 1.5 W/m², each time the primary irradiation period is repeated. Further, also during one primary irradiation period, the irradiation illuminance of the irradiation light is linearly increased by 0.5 W/m² from 0.5 W/m² to 1 W/m² or from 1 W/m² to 1.5 W/m², for example.

### Examples 49 and 50

In example 49, the peach was used as a sample, and in example 50, the strawberry was used as a sample. The primary irradiation period was fixed to 24 hours, the secondary irradiation period was fixed to 24 hours, and the primary irradiation period was repeated 5 times. The irradiation illuminance of the irradiation light immediately after starting of the primary irradiation period was increased by 0.5 W/m², that is, 1 W/m², 1.5 W/m², 2 W/m², . . . each time the primary irradiation period was repeated. Further, also during one primary irradiation period, the irradiation illuminance of the irradiation light immediately after starting of the primary irradiation period was maintained during initial 12 hours, and in remaining 12 hours, the irradiation illuminance was linearly increased by 0.5 W/m² from 1 W/m² to 1.5 W/m² or from 1.5 W/m² to 2 W/m², for example.

### Comparison Examples 12 and 13

In comparison example 12, the spinach was used as a sample, and in example 13, the lettuce was used as a sample. The primary irradiation period was fixed to 1 hour, the secondary irradiation period was fixed to 7 hours, and the primary irradiation period was repeated 9 times. The irradiation illuminance of the irradiation light during the primary irradiation was 1 W/m².

### Comparison Examples 14 and 15

In example 14, the peach was used as a sample, and in example 15, the strawberry was used as a sample. The primary irradiation period is fixed to 1 hour, the secondary irradiation period is fixed to 7 hours, and the primary irradiation period is repeated 30 times. The irradiation illuminance of the irradiation light during the primary irradiation was 1 W/m².

TABLE 30

| | | | FRESHNESS |
|---|---|---|---|
| | | | KEEPING |
| | | | PERIOD |
| | | FRESHNESS | MAGNI- |
| | | KEEPING | FICATION |
| | CROP | PERIOD (day) | RATIO |
| EXAMPLE 19 | SPINACH | 2.15 | 1.65 |
| EXAMPLE 20 | LETTUCE | 2.4 | 1.6 |
| EXAMPLE 21 | SPINACH | 2 | 1.54 |
| EXAMPLE 22 | LETTUCE | 2.25 | 1.5 |
| EXAMPLE 23 | PEACH | 8.25 | 1.5 |
| EXAMPLE 24 | STRAWBERRY | 9.3 | 1.5 |
| EXAMPLE 25 | PEACH | 9.9 | 1.8 |
| EXAMPLE 26 | STRAWBERRY | 9.92 | 1.6 |
| EXAMPLE 27 | SPINACH | 2.17 | 1.67 |
| EXAMPLE 28 | LETTUCE | 2.48 | 1.65 |
| EXAMPLE 29 | SPINACH | 2.04 | 1.57 |
| EXAMPLE 30 | LETTUCE | 2.3 | 1.53 |
| EXAMPLE 31 | PEACH | 8.53 | 1.55 |
| EXAMPLE 32 | STRAWBERRY | 9.92 | 1.6 |
| EXAMPLE 33 | PEACH | 9.63 | 1.75 |
| EXAMPLE 34 | STRAWBERRY | 10.54 | 1.7 |
| EXAMPLE 35 | SPINACH | 1.99 | 1.53 |
| EXAMPLE 36 | LETTUCE | 2.33 | 1.55 |
| EXAMPLE 37 | SPINACH | 1.95 | 1.5 |
| EXAMPLE 38 | LETTUCE | 2.34 | 1.56 |
| EXAMPLE 39 | PEACH | 8.25 | 1.5 |
| EXAMPLE 40 | STRAWBERRY | 9.92 | 1.6 |
| EXAMPLE 41 | PEACH | 9.35 | 1.7 |
| EXAMPLE 42 | STRAWBERRY | 10.42 | 1.68 |
| EXAMPLE 43 | SPINACH | 1.95 | 1.5 |
| EXAMPLE 44 | LETTUCE | 2.33 | 1.55 |
| EXAMPLE 45 | SPINACH | 2.03 | 1.56 |
| EXAMPLE 46 | LETTUCE | 2.34 | 1.56 |
| EXAMPLE 47 | PEACH | 8.8 | 1.6 |
| EXAMPLE 48 | STRAWBERRY | 9.92 | 1.6 |
| EXAMPLE 49 | PEACH | 8.25 | 1.5 |
| EXAMPLE 50 | STRAWBERRY | 9.61 | 1.55 |
| COMPARISON | SPINACH | 1.69 | 1.3 |
| EXAMPLE 12 | | | |
| COMPARISON | LETTUCE | 2.03 | 1.35 |
| EXAMPLE 13 | | | |
| COMPARISON | PEACH | 7.92 | 1.44 |
| EXAMPLE 14 | | | |
| COMPARISON | STRAWBERRY | 8.68 | 1.4 |
| EXAMPLE 15 | | | |

### [About Influence Brought About by Changing Irradiation Conditions in Stepwise Manner]

As shown in Table 30, in examples 19 to 50 where the irradiation light was emitted to crops (spinach, lettuce, peach, or strawberry) while changing an irradiation condition, the freshness keeping period magnification ratios were 1.5 or more. On the other hand, in comparison examples 12 to 15 where the irradiation light was emitted to crops (spinach, lettuce, peach, or strawberry) without changing the irradiation condition, the freshness keeping period magnification ratios were 1.3 to 1.45.

That is, freshness keeping effect can be acquired even by emitting the irradiation light to the crops without changing the irradiation condition. However, by emitting the irradiation light to the crops while changing the irradiation condition, it is possible to keep freshness of the crops more effectively.

To be more specific, even when any one of spinach, lettuce, peach, and strawberry is used as a sample, examples 19 to 26 where the secondary irradiation period was shortened in a stepwise manner each time the primary irradiation period was repeated take the larger numerical values in freshness keeping period magnification ratio than comparison examples 12 to 15 where the irradiation light was emitted without changing the irradiation condition. That is, from a viewpoint of freshness keeping, it is preferable that the secondary irradiation period be gradually shortened each time emission of the irradiation light is repeated.

Further, even when any one of spinach, lettuce, peach, and strawberry is used as a sample, examples 27 to 34 where the primary irradiation period was prolonged in a stepwise manner each time the primary irradiation period was repeated take the larger numerical values in freshness keeping period magnification ratio than comparison examples 12 to 15 where the irradiation light was emitted without changing the irradiation condition. That is, from a viewpoint of freshness keeping, it is preferable that the primary irradiation period be gradually prolonged each time emission of the irradiation light is repeated.

Further, even when any one of spinach, lettuce, peach, and strawberry is used as a sample, examples 35 to 42 where the irradiation illuminance during the primary irradiation period was increased each time the primary irradiation period was repeated take the larger numerical values in freshness keeping period magnification ratio than comparison examples 12 to 15 where the irradiation light was emitted without changing the irradiation condition. That is, from a viewpoint of freshness keeping, it is preferable that the irradiation illuminance of the irradiation light be gradually increased each time emission of the irradiation light is repeated.

Further, even when any one of spinach, lettuce, peach, and strawberry is used as a sample, examples 43 to 50 where the irradiation illuminance of the irradiation light during one primary irradiation period was increased take the larger numerical values in freshness keeping period magnification ratio than comparison examples 12 to 15 where the irradiation light was emitted without changing the irradiation condition. That is, from a viewpoint of freshness keeping, it is preferable that, during one primary irradiation period, the irradiation illuminance of the irradiation light be gradually increased.

Although the content of the exemplary embodiments of the present disclosure is described with reference to examples, the present exemplary embodiments are not limited to the above-mentioned configurations, and it is apparent for those who are skilled in the art that various modifications and improvements are conceivable.

1. A method, comprising:
irradiating, with irradiation light, a crop after harvesting, wherein
the irradiation light includes a first peak wavelength within a wavelength range from 400 nm to 480 nm inclusive, a second peak wavelength within a wavelength range from 500 nm to 650 nm inclusive, and a third peak wavelength within a wavelength range from 700 nm to 750 nm inclusive, and
an intensity of the irradiation light at the third peak wavelength is 5% or more of an intensity of the irradiation light at the first peak wavelength.

2. The method according to claim 1, wherein
the second peak wavelength is within a wavelength range from 500 nm to 550 nm inclusive, and
the irradiation light further includes a fourth peak wavelength in a wavelength range from 600 nm or more and less than 700 nm.

3. The method according to claim 1, wherein a color temperature of the irradiation light is 5600 K or more and 7000 K or less.

4. The method according to claim 1, wherein
a color temperature of the irradiation light is 4000 K or more and less than 5600 K, and
the intensity of the irradiation light at the third peak wavelength is 8% or more of the intensity of the irradiation light at the first peak wavelength.

5. The method according to claim 1, wherein
a color temperature of the irradiation light is 2000 K or more and less than 4000 K, and
the intensity of the irradiation light at the third peak wavelength is 10% or more of the intensity of the irradiation light at the first peak wavelength.

6. The method according to claim 1, wherein, with respect to the irradiation light, light including the third peak wavelength is emitted for 5 minutes or more in a day.

7. The method according to claim 1, wherein, with respect to the irradiation light, light including the third peak wavelength is repeatedly emitted more than once in a day.

8. The method according to claim 7, wherein, with respect to the irradiation light, an irradiation interval time of the light including the third peak wavelength is longer than an irradiation time of the light including the third peak wavelength.

9. The method according to claim 1, wherein a light integrated amount of the irradiation light within the wavelength range from 700 nm to 750 nm inclusive is set to 30 J/m² or more in a day.

10. A device for irradiating, with irradiation light, a crop after harvesting, the device comprising:
a light emitter that emits the irradiation light including a first peak wavelength within a wavelength range from 400 nm to 480 nm inclusive, a second peak wavelength within a wavelength range from 500 nm to 650 nm inclusive, and a third peak wavelength within a wavelength range from 700 nm to 750 nm inclusive, wherein
an intensity of the irradiation light at the third peak wavelength is 5% or more of an intensity of the irradiation light at the first peak wavelength.

11. The device according to claim 10, wherein
the second peak wavelength is within a wavelength range from 500 nm to 550 nm inclusive, and
the irradiation light further includes a fourth peak wavelength in a wavelength range from 600 nm or more and less than 700 nm.

12. A storage compartment, comprising:
the device according to claim 10; and
a casing configured to store the crop.

13. A showcase, comprising:
the device according to claim 10; and
a shelf configured to display the crop.

14.-40. (canceled)
